(19) United States
(12) Patent Application Publication
(10) Pub. No.: US 2025/0061878 A1
(43) Pub. Date: Feb. 20, 2025

(54) ACTIVE NOISE CONTROL SYSTEM

(71) Applicants: NITTO DENKO CORPORATION, Ibaraki-shi, Osaka (JP); THE SCHOOL CORPORATION KANSAI UNIVERSITY, Suita-shi, Osaka (JP)

(72) Inventors: Kohei OTO, Osaka (JP); Yoshinobu KAJIKAWA, Osaka (JP); Ryosuke OKAJIMA, Osaka (JP)

(21) Appl. No.: 18/721,549

(22) PCT Filed: Feb. 14, 2023
(86) PCT No.: PCT/JP2023/005067

§ 371 Date: Jun. 18, 2024

(30) Foreign Application Priority Data
Feb. 15, 2022 (JP) 2022-021293

(51) Int. Cl. G10K 11/178; H04R 17/00

(52) U.S. Cl. CPC G10K 11/17823; G10K 11/17873; H04R 17/00; H04R 2400/01

(57) ABSTRACT

An active noise control system (500) includes a structure (80), a first piezoelectric speaker (10A), and a second piezoelectric speaker (10B). The structure (80) has a front surface (80a) and a back surface (80b). The first piezoelectric speaker (10A) is disposed on the front surface (80a). The first piezoelectric speaker (10A) is configured to radiate a sound wave for sound reduction. The second piezoelectric speaker (10B) is disposed on the back surface (80b). The second piezoelectric speaker (10B) is configured to radiate a sound wave for sound reduction.

### TECHNICAL FIELD

The present invention relates to an active noise control system.

### BACKGROUND ART

An active noise control system (hereinafter also referred to as an ANC system) is known. In the ANC system, noise is reduced by opposite-phase sound. Patent Literature 1 describes an example of the ANC system. In the ANC system of Patent Literature 1, a speaker is attached to a structure.

### CITATION LIST

### Patent Literature

Patent Literature 1: JP 2004-264590 A
Patent Literature 2: JP 2016-122187 A

### SUMMARY OF THE INVENTION

### Technical Problem

The present invention provides an ANC system having a configuration suitable for causing attenuation of sound derived from a speaker attached to a structure to occur behind the structure as viewed from the speaker.

### Solution to Problem

The present invention provides an active noise control system including:
a structure having a front surface and a back surface;
a first piezoelectric speaker disposed on the front surface and configured to radiate a sound wave for sound reduction; and
a second piezoelectric speaker disposed on the back surface and configured to radiate a sound wave for sound reduction.

### Advantageous Effects of Invention

The ANC system according to the present invention is suitable for causing attenuation of sound derived from a speaker attached to a structure to occur behind the structure as viewed from the speaker.

### BRIEF DESCRIPTION OF THE DRAWINGS

FIG. 1 is a top view of an ANC system according to a first embodiment.

FIG. 2 is a side view of the ANC system according to the first embodiment.

FIG. 3 is a detailed perspective view showing a structure to which a first piezoelectric speaker and a second piezoelectric speaker are attached.

FIG. 4A is an enlarged view for illustrating the position of a first radiation surface of the first piezoelectric speaker.

FIG. 4B is an enlarged view for illustrating the position of a second radiation surface of the second piezoelectric speaker.

FIG. 5A is an enlarged view for illustrating another example of the orientation of the first radiation surface of the first piezoelectric speaker.

FIG. 5B is an enlarged view for illustrating another example of the orientation of the second radiation surface of the second piezoelectric speaker.

FIG. 6A is an enlarged view for illustrating another example of the shape of the first radiation surface of the first piezoelectric speaker.

FIG. 6B is an enlarged view for illustrating another example of the shape of the second radiation surface of the second piezoelectric speaker.

FIG. 7A is an enlarged view for illustrating the regions of the first radiation surface of the first piezoelectric speaker.

FIG. 7B is an enlarged view for illustrating the regions of the second radiation surface of the second piezoelectric speaker.

FIG. 8A is a top view for illustrating diffracted waves that have come from a first noise source and then undergone diffraction.

FIG. 8B is a side view for illustrating the diffracted waves, which have come from the first noise source and then undergone diffraction.

FIG. 8C is a perspective view for illustrating the diffracted waves, which have come from the first noise source and then undergone diffraction.

FIG. 8D is a top view for illustrating wave fronts formed by the first piezoelectric speaker.

FIG. 8E is a side view for illustrating the wave fronts formed by the first piezoelectric speaker.

FIG. 8F is a perspective view for illustrating the wave fronts formed by the first piezoelectric speaker.

FIG. 9A is a top view for illustrating diffracted waves that have come from a second noise source and then undergone diffraction.

FIG. 9B is a side view for illustrating the diffracted waves, which have come from the second noise source and then undergone diffraction.

FIG. 9C is a perspective view for illustrating the diffracted waves, which have come from the second noise source and then undergone diffraction.

FIG. 9D is a top view for illustrating wave fronts formed by the second piezoelectric speaker.

FIG. 9E is a side view for illustrating the wave fronts formed by the second piezoelectric speaker.

FIG. 9F is a perspective view for illustrating the wave fronts formed by the second piezoelectric speaker.

FIG. 10 is a diagram illustrating a wave front formed by a conventional dynamic speaker.

FIG. 11 is a diagram illustrating a wave front formed by a conventional plane speaker.

FIG. 12 is a diagram illustrating the vibration of the radiation surface of the piezoelectric speaker.

FIG. 13 is a diagram illustrating a supporting structure for a piezoelectric film.

FIG. 14 is a diagram illustrating the ANC system according to the first embodiment.

FIG. 15 is a top view of an ANC system according to a second embodiment.

FIG. 16 is a side view of the ANC system according to the second embodiment.

FIG. 17 is a diagram illustrating the ANC system according to the second embodiment.

FIG. 18 is a schematic view showing an ANC system configured by attaching the conventional dynamic speaker to the structure.

FIG. 19 is a schematic view showing the ANC system according to the second embodiment configured by attaching the first piezoelectric speaker to the structure.

FIG. 20 is a schematic top view showing a phase distribution that can be formed with respect to the rear of the back surface of the structure in the ANC system according to the second embodiment.

FIG. 21 is a cross-sectional view taken along a section parallel to the thickness direction of the piezoelectric speaker.

FIG. 22 is a top view of the piezoelectric speaker as viewed from the opposite side to the fixing surface.

FIG. 23 shows a piezoelectric speaker according to another structure example.

FIG. 24 is a view for illustrating the structure of a produced sample.

FIG. 25 is a view for illustrating a sample measurement structure.

FIG. 26 is a view for illustrating a sample measurement structure.

FIG. 27 is a block diagram of an output system.

FIG. 28 is a block diagram of an evaluation system.

FIG. 29A is a table showing evaluation results for samples.

FIG. 29B is a table showing evaluation results for samples.

FIG. 30 is a graph showing the relationship between the holding degree of an interposed layer and the frequency at which emission of sound starts.

FIG. 31 is a graph showing the frequency characteristics of Sample E1 in terms of sound pressure level.

FIG. 32 is a graph showing the frequency characteristics of Sample E2 in terms of sound pressure level.

FIG. 33 is a graph showing the frequency characteristics of Sample R1 in terms of sound pressure level.

FIG. 34 is a graph showing the frequency characteristics of background noise in terms of sound pressure level.

FIG. 35 is a configuration diagram of a reference ANC evaluation system.

FIG. 36 is a diagram showing a sound pressure distribution at a speaker OFF time.

FIG. 37 is a diagram showing propagation of a wave front at the speaker OFF times.

FIG. 38 is a diagram showing a sound pressure distribution at a speaker OFF time.

FIG. 39 is a diagram showing propagation of a wave front at the speaker OFF times.

FIG. 40 is a diagram showing a sound pressure distribution derived from the piezoelectric speaker.

FIG. 41 is a diagram showing propagation of a wave front derived from the piezoelectric speaker.

FIG. 42 is a diagram showing a sound pressure distribution derived from the piezoelectric speaker.

FIG. 43 is a diagram showing propagation of a wave front derived from the piezoelectric speaker.

FIG. 44 is a diagram showing a sound pressure distribution derived from the dynamic speaker.

FIG. 45 is a diagram showing propagation of a wave front derived from the dynamic speaker.

FIG. 46 is a diagram showing a sound pressure distribution derived from the dynamic speaker.

FIG. 47 is a diagram showing propagation of a wave front derived from the dynamic speaker.

FIG. 48 is a diagram showing a sound pressure distribution derived from the plane speaker.

FIG. 49 is a diagram showing propagation of a wave front derived from the plane speaker.

FIG. 50 is a diagram showing a sound pressure distribution derived from the plane speaker.

FIG. 51 is a diagram showing propagation of a wave front derived from the plane speaker.

FIG. 52A is a diagram illustrating a sound reducing effect.

FIG. 52B is a diagram illustrating the sound reducing effect.

FIG. 52C is a diagram illustrating the sound reducing effect.

FIG. 53A is a diagram illustrating the sound reducing effect.

FIG. 53B is a diagram illustrating the sound reducing effect.

FIG. 53C is a diagram illustrating the sound reducing effect.

FIG. 54 is a perspective view for illustrating a measurement horizontal cross section and a measurement sagittal cross section.

FIG. 55 is a configuration diagram of an ANC evaluation system according to Example 1.

FIG. 56 is a perspective view showing a partition to which the first piezoelectric speaker according to Example 1 is attached.

FIG. 57 is an enlarged view for illustrating the position of the first radiation surface of the first piezoelectric speaker according to Example 1.

FIG. 58 is a contour map showing the sound pressure distribution with respect to the measurement horizontal cross section in Example 1.

FIG. 59 is a configuration diagram of an ANC evaluation system according to Example 2.

FIG. 60 is a contour map showing the sound pressure distribution with respect to the measurement sagittal cross section in Example 2.

FIG. 61 is a contour map showing the sound pressure distribution with respect to the measurement horizontal cross section in Example 3.

FIG. 62 is a contour map showing the sound pressure distribution with respect to the measurement sagittal cross section in Example 4.

FIG. 63A is a color map showing the phase distribution with respect to the measurement horizontal cross section in Example 5.

FIG. 63B is a contour map showing the phase distribution with respect to the measurement horizontal cross section in Example 5.

FIG. 64 is a perspective view showing the partition to which a dynamic speaker according to Comparative Example 1 is attached.

FIG. 65 is a contour map showing the sound pressure distribution with respect to the measurement horizontal cross section in Comparative Example 1.

FIG. 66 is a contour map showing the sound pressure distribution with respect to the measurement sagittal cross section in Comparative Example 2.

FIG. 67 is a contour map showing the sound pressure distribution with respect to the measurement horizontal cross section in Comparative Example 3.

FIG. 68 is a contour map showing the sound pressure distribution with respect to the measurement sagittal cross section in Comparative Example 4.

FIG. 69A is a color map showing the phase distribution with respect to the measurement horizontal cross section in Comparative Example 5.

FIG. 69B is a contour map showing the phase distribution with respect to the measurement horizontal cross section in Comparative Example 5.

FIG. 70 is a top view for illustrating the configuration of an ANC evaluation system according to Example 6.

FIG. 71 is a side view for illustrating the configuration of the ANC evaluation system according to Example 6.

FIG. 72 is an enlarged view for illustrating the position of the second radiation surface of the second piezoelectric speaker according to Example 6.

FIG. 73 is a graph showing the measurement results of the sound reducing effect for Example 6.

FIG. 74 is a graph showing the measurement results of the sound reducing effect for Example 7.

FIG. 75 is a graph showing the measurement results of the sound reducing effect for Reference Example 5.

FIG. 76 is a graph showing the measurement results of the sound reducing effect for Comparative Example 6.

FIG. 77 is a graph showing the measurement results of the sound reducing effect for Comparative Example 7.

FIG. 78 is a graph showing the measurement results of the sound reducing effect for Reference Example 6.

FIG. 79 is a top view for illustrating techniques and effects that can be derived from the present invention.

FIG. 80 is a side view for illustrating the techniques and effects that can be derived from the present invention.

### DESCRIPTION OF EMBODIMENTS

Embodiments of the present invention will be described below with reference to the accompanying drawings. The following description is only illustrative of the embodiments of the present invention and has no intention to limit the present invention. In the following description, the terms such as “up”, “down”, “left”, “right”, “height”, and the like are used to designate the positions of the elements relative to each other, and are not intended to limit the posture of these elements in use of the ANC system. Further, in the following description, the same or similar components are denoted by the same reference numerals, and the description thereof may be omitted.

### First Embodiment of Active Noise Control System

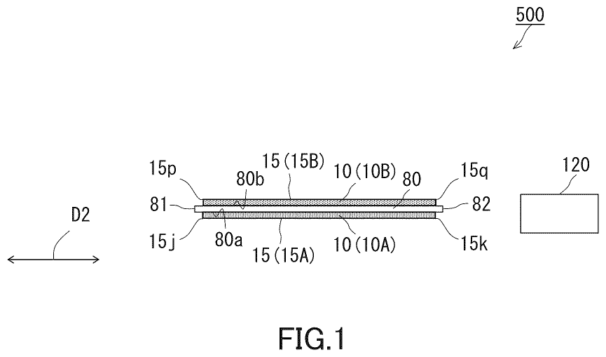

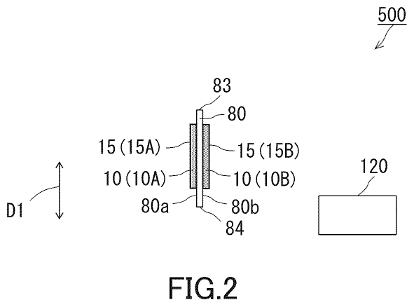

As shown in FIG. 1 to FIG. 7B, an active noise control system (ANC system) 500 includes a structure 80 and a plurality of piezoelectric speakers 10. The plurality of piezoelectric speakers 10 each have a radiation surface 15 and radiate a sound wave for sound reduction.

In the present embodiment, the plurality of piezoelectric speakers 10 include a first piezoelectric speaker 10A and a second piezoelectric speaker 10B. Specifically, the ANC system 500 is a dual ANC system using the first piezoelectric speaker 10A and the second piezoelectric speaker 10B. A dual ANC system can also be referred to as a bidirectional ANC system.

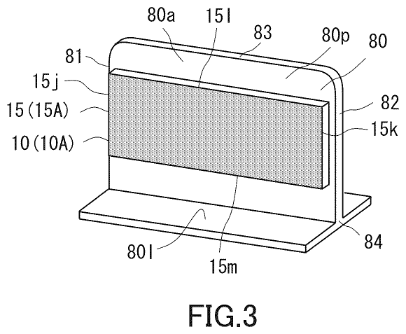

As shown in FIG. 3, the structure 80 has a plate 80p. In the illustrated example, the structure 80 further has a leg 801. The leg 801 supports the plate 80p in an upright state. In the other figures, the leg 801 is not shown.

The structure 80 has a front surface 80a and a back surface 80b. In the structure 80, the front surface 80a and the back surface 80b are surfaces opposite to each other. The first piezoelectric speaker 10A is disposed on the front surface 80a. The second piezoelectric speaker 10B is disposed on the back surface 80b. Specifically, the plate 80p has the front surface 80a and the back surface 80b.

In the present embodiment, the plate 80p of the structure 80 has, for example, a dimension of 20 cm or more and 400 cm or less (20 cm or more and 200 cm or less in a specific example) in the up-down direction, a dimension of 25 cm or more and 200 cm or less (50 cm or more and 120 cm or less in the specific example) in the left-right direction, and a dimension of 0.1 cm or more and 15 cm or less in the thickness direction. Here, the up-down direction, the left-right direction, and the thickness direction are orthogonal to each other. The dimension in the up-down direction and the dimension in the left-right direction may be equal to each other or may be different from each other. The dimension of the entire structure 80 in the up-down direction is, for example, 20 cm or more and 400 cm or less, and in the specific example, 20 cm or more and 200 cm or less.

In the present embodiment, the structure 80 is a partition. In an example, the structure 80 is a partition disposed in an office. In a specific example, the structure 80 is a partition partitioning a shared desk in an office.

The radiation surface 15 of the first piezoelectric speaker 10A is hereinafter referred to as a first radiation surface 15A. The first radiation surface 15A radiates a sound wave by vibrating. This sound wave reduces noise. In the present embodiment, the first radiation surface 15A is a continuous radiation surface.

The radiation surface 15 of the second piezoelectric speaker 10B is hereinafter referred to as a second radiation surface 15B. The second radiation surface 15B radiates a sound wave by vibrating. This sound wave reduces noise. In the present embodiment, the second radiation surface 15B is a continuous radiation surface.

The structure 80 has a left end portion 81, a right end portion 82, an upper end portion 83, and a lower end portion 84. The left end portion 81 and the right end portion 82 face each other in the left-right direction. The upper end portion 83 and the lower end portion 84 face each other in the up-down direction. In the illustrated example, the lower end portion 84 is an end portion in contact with the floor. Specifically, the plate 80p has the left end portion 81, the right end portion 82, and the upper end portion 83. The plate 80p and the leg 801 have the lower end portion 84.

“Left” and “right” refer to a positional relation as viewed along the direction from the front surface 80a of the structure 80 toward the back surface 80b of the structure 80. Accordingly, in plan view of the front surface 80a or the back surface 80b, a left end portion 15j of the first radiation surface 15A of the first piezoelectric speaker 10A and a left end portion 15p of the second radiation surface 15B of the second piezoelectric speaker 10B can overlap each other. Similarly, in plan view of the front surface 80a or the back surface 80b, a right end portion 15k of the first radiation surface 15A and a right end portion 15q of the second radiation surface 15B can overlap each other.

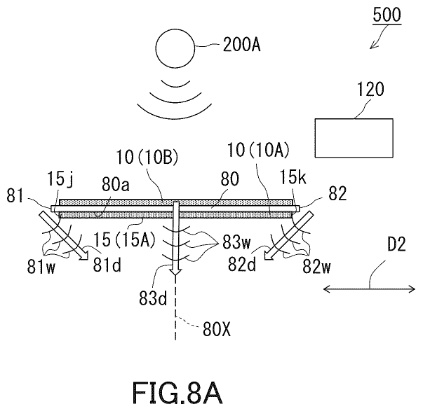

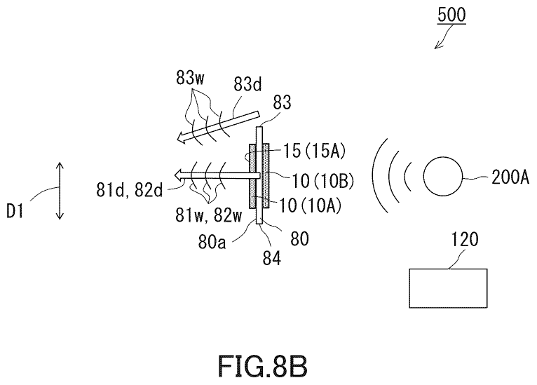

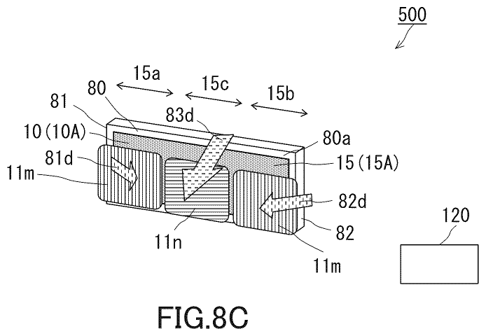

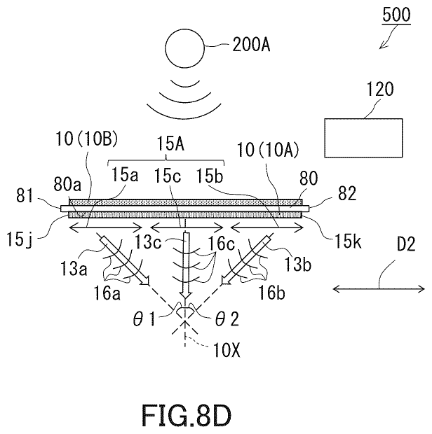

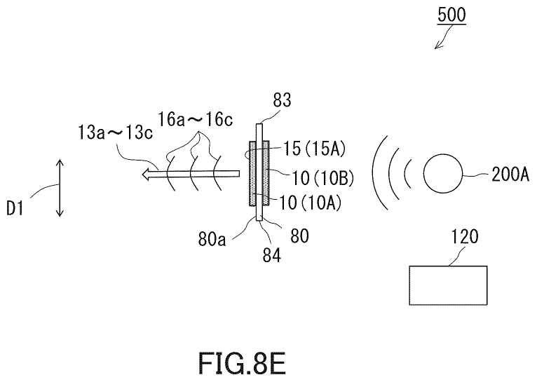

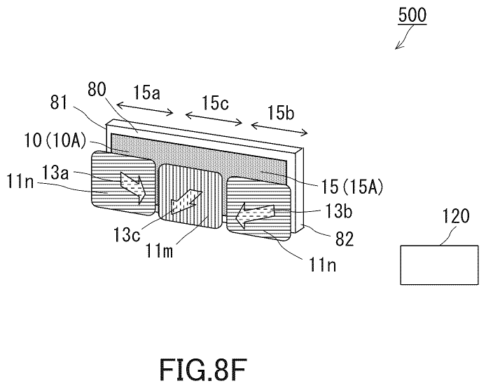

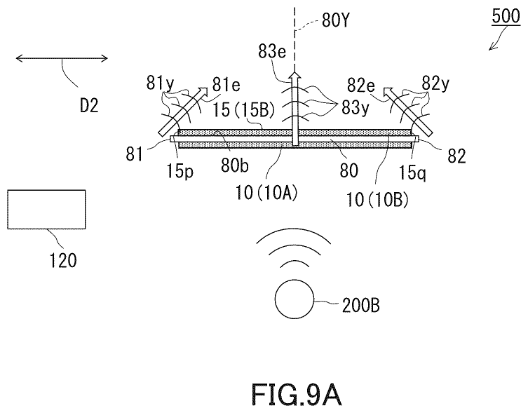

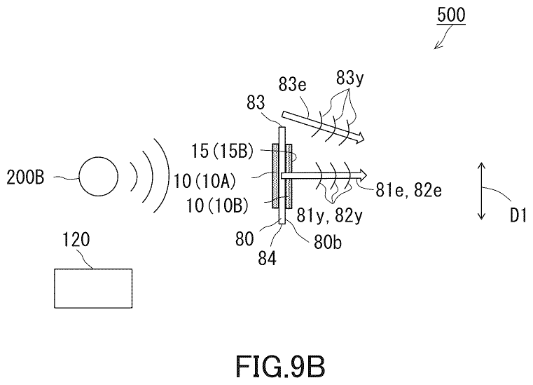

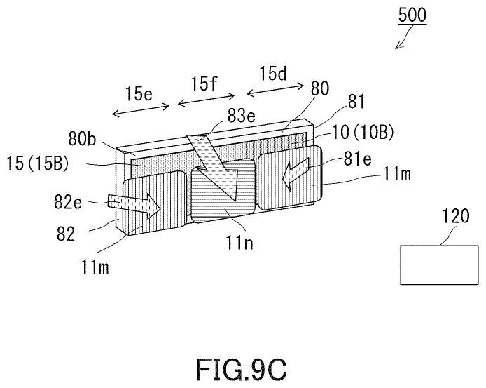

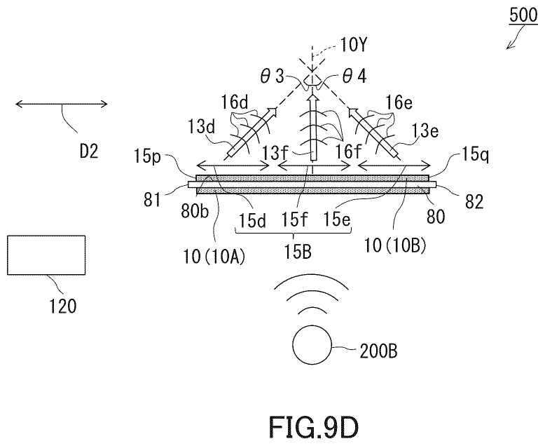

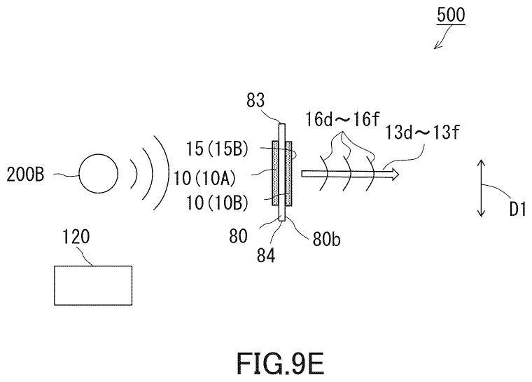

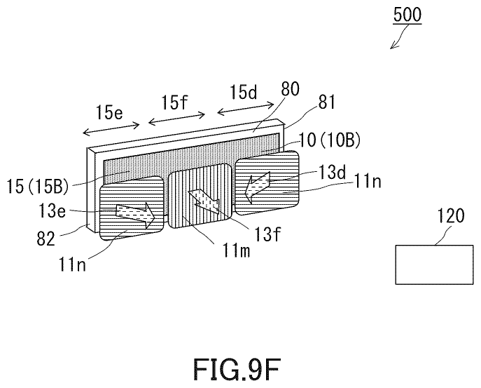

The ANC system 500 is suitable for reducing diffracted sound generated at the left end portion 81, the right end portion 82, and the upper end portion 83. This point will be described below with reference to FIG. 8A to FIG. 9F. It should be noted that a wave front in the following description refers to a surface that connects the points having the same phase of a wave. In FIG. 8A to FIG. 8F, a second noise source 200B and other components are not shown. In FIG. 9A to FIG. 9F, a first noise source 200A and other components are not shown.

In FIG. 8A and FIG. 8B, the distance between the first noise source 200A and the structure 80 is, for example, 0.3 m or more and 5 m or less. This distance is specifically the distance between the first noise source 200A and the plate 80p in the thickness direction of the plate 80p. Further, the first noise source 200A has a height of, for example, 0 m or more and 4 m or less. In this context, the height refers to the position in the up-down direction.

In FIG. 9A and FIG. 9B, the distance between the second noise source 200B and the structure 80 is, for example, 0.3 m or more and 5 m or less. This distance is specifically the distance between the second noise source 200B and the plate 80p in the thickness direction of the plate 80p. Further, the second noise source 200B has a height of, for example, 0 m or more and 4 m or less. In this context, the height refers to the position in the up-down direction.

Assume a case where noise from the first noise source 200A has propagated toward the structure 80 as shown in FIG. 8A and FIG. 8B. In this case, diffraction can occur at the left end portion 81 and the right end portion 82. The wave fronts generated by the diffraction at the left end portion 81 and the right end portion 82 propagate so as to travel around to the opposite side of the structure 80 as viewed from the first noise source 200A. The first piezoelectric speaker 10A is suitable for reducing diffracted sound thus generated at the left end portion 81 and the right end portion 82.

Assume a case where noise from the second noise source 200B has propagated toward the structure 80 as shown in FIG. 9A and FIG. 9B. In this case, diffraction can occur at the left end portion 81 and the right end portion 82. The wave fronts generated by the diffraction at the left end portion 81 and the right end portion 82 propagate so as to travel around to the opposite side of the structure 80 as viewed from the second noise source 200B. The second piezoelectric speaker 10B is suitable for reducing diffracted sound thus generated at the left end portion 81 and the right end portion 82.

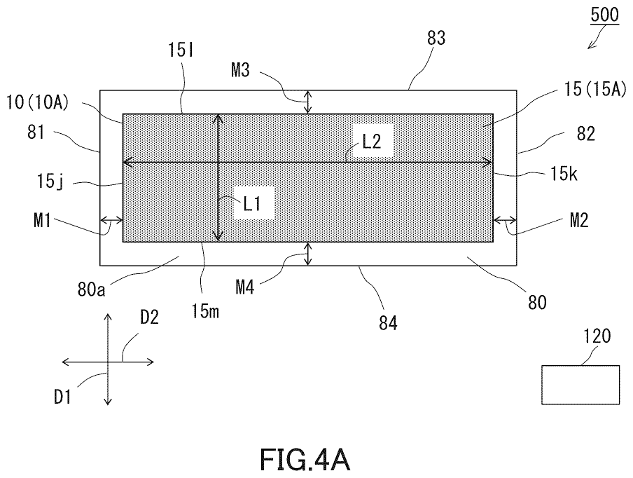

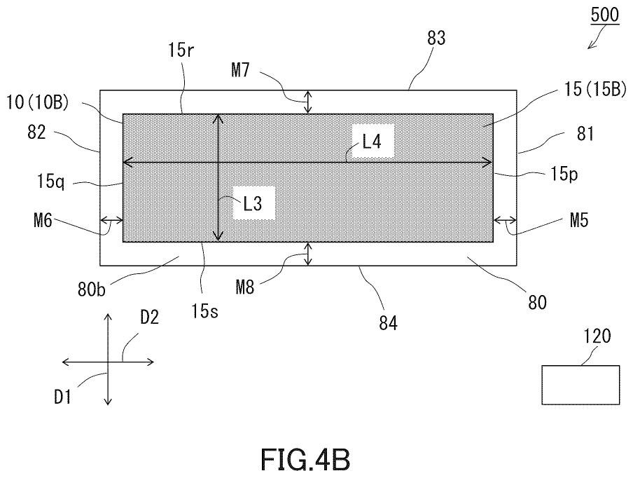

As shown in FIG. 4A, the first radiation surface 15A of the first piezoelectric speaker 10A extends along an up-down direction D1 and a left-right direction D2. In the example in FIG. 4A, the first radiation surface 15A has a short side and a long side. The first radiation surface 15A has a dimension L1 that is the dimension in the short direction. The first radiation surface 15A has a dimension L2 that is the dimension in the long direction.

In the example in FIG. 4A, the short direction of the first radiation surface 15A is the up-down direction D1, and the long direction of the first radiation surface 15A is the left-right direction D2.

The ratio of the dimension L2 to the dimension L1, a first aspect ratio L2/L1, is, for example, 1.2 or more. The first aspect ratio L2/L1 may be 1.2 or more and 6 or less and may be 1.5 or more and 4 or less.

The dimension L1 is, for example, 20 cm or more and 400 cm or less. The dimension L1 may be 20 cm or more and 200 cm or less.

The dimension L2 is, for example, 25 cm or more and 200 cm or less. The dimension L2 may be 50 cm or more and 120 cm or less.

It is also possible to adjust the dimension L1 to adjust the frequency of sound that can be reduced. In view of this, the upper limit for the dimension L1 may be set. The dimension L1 is, for example, 50 cm or less. This facilitates noise having a high frequency to be reduced. The dimension L1 may be 40 cm or less.

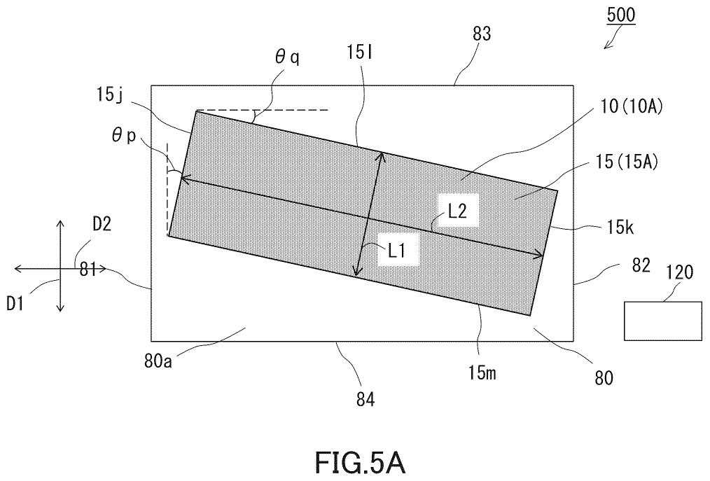

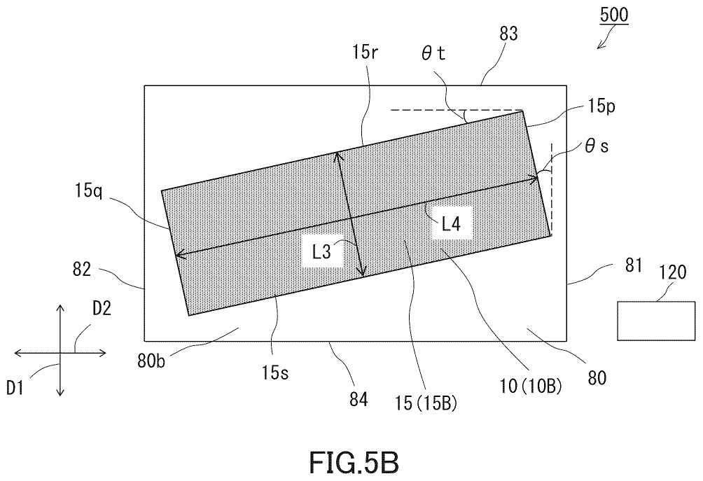

As shown in FIG. 5A, the short direction of the first radiation surface 15A may be deviated from the up-down direction D1. The long direction of the first radiation surface 15A may be deviated from the left-right direction D2. A deviation angle θp in the short direction of the first radiation surface 15A relative to the up-down direction D1 is, for example, 0° or more and 15° or less. The deviation angle θp may be, for example, 0° or more and 5° or less. Similarly, a deviation angle θq in the long direction of the first radiation surface 15A relative to the left-right direction D2 is, for example, 0° or more and 15° or less. The deviation angle θq may be, for example, 0° or more and 5° or less.

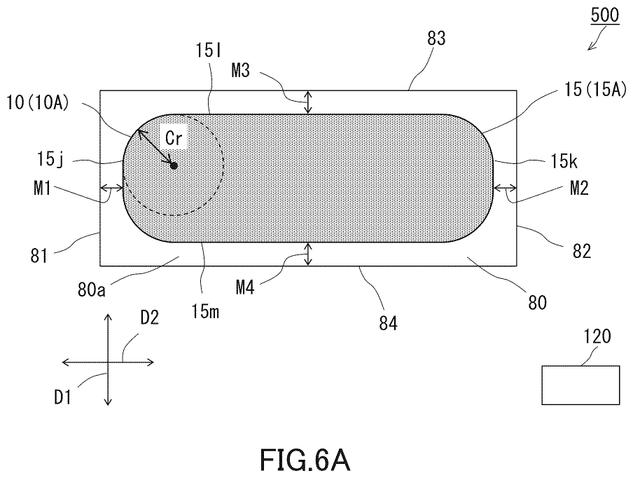

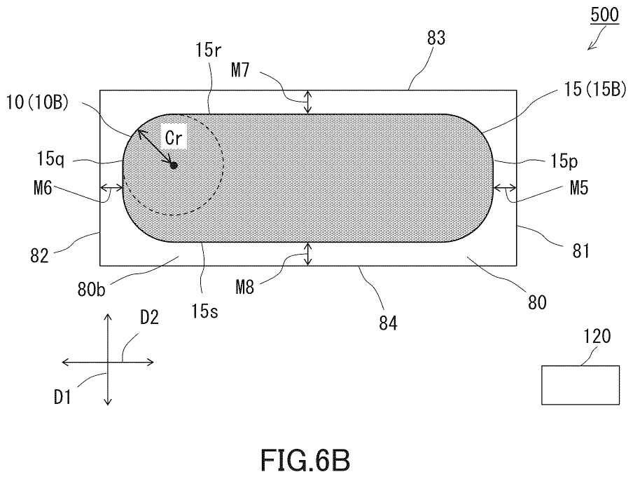

In the example in FIG. 4A, the first radiation surface 15A is in the shape of a quadrangle, specifically, a rectangle. However, the first radiation surface 15A is not limited to this shape. The first radiation surface 15A may be in the shape of, for example, a rounded rectangle as shown in FIG. 6A. A radius of curvature Cr of the corner portion of the rounded rectangle is, for example, more than 0 and half or less of the length in the short direction of the rounded rectangle.

The first radiation surface 15A may have neither the long side nor the short side. For example, the first radiation surface 15A may be in the shape of a square or may be in the shape of a circle.

As shown in FIG. 4B, the second radiation surface 15B of the second piezoelectric speaker 10B extends along the up-down direction D1 and the left-right direction D2. In the example in FIG. 4B, the second radiation surface 15B has a short side and a long side. The second radiation surface 15B has a dimension L3 that is the dimension in the short direction. The second radiation surface 15B has a dimension L4 that is the dimension in the long direction.

In the example in FIG. 4B, the short direction of the second radiation surface 15B is the up-down direction D1, and the long direction of the second radiation surface 15B is the left-right direction D2.

The ratio of the dimension L4 to the dimension L3, a second aspect ratio L4/L3, is, for example, 1.2 or more. The second aspect ratio L4/L3 may be 1.2 or more and 6 or less and may be 1.5 or more and 4 or less.

The dimension L3 is, for example, 20 cm or more and 400 cm or less. The dimension L3 may be 20 cm or more and 200 cm or less.

The dimension L4 is, for example, 25 cm or more and 200 cm or less. The dimension L4 may be 50 cm or more and 120 cm or less.

It is also possible to adjust the dimension L3 to adjust the frequency of sound that can be reduced. In view of this, the upper limit for the dimension L3 may be set. The dimension L3 is, for example, 50 cm or less. This facilitates noise having a high frequency to be reduced. The dimension L3 may be 40 cm or less.

As shown in FIG. 5B, the short direction of the second radiation surface 15B may be deviated from the up-down direction D1. The long direction of the second radiation surface 15B may be deviated from the left-right direction D2. A deviation angle θs in the short direction of the second radiation surface 15B relative to the up-down direction D1 is, for example, 0° or more and 15° or less. The deviation angle θs may be, for example, 0° or more and 5° or less. Similarly, a deviation angle θt in the long direction of the second radiation surface 15B relative to the left-right direction D2 is, for example, 0° or more and 15° or less. The deviation angle θt may be, for example, 0° or more and 5° or less.

In the example in FIG. 4B, the second radiation surface 15B is in the shape of a quadrangle, specifically, a rectangle. However, the second radiation surface 15B is not limited to this shape. The second radiation surface 15B may be in the shape of, for example, a rounded rectangle as shown in FIG. 6B. The radius of curvature Cr of the corner portion of the rounded rectangle is, for example, more than 0 and half or less of the length in the short direction of the rounded rectangle.

The second radiation surface 15B may have neither the long side nor the short side. For example, the second radiation surface 15B may be in the shape of a square or may be in the shape of a circle.

A further description will be given of the suitability of the ANC system 500 for diffracted sound reduction while mentioning the propagation direction and phase of the sound wave.

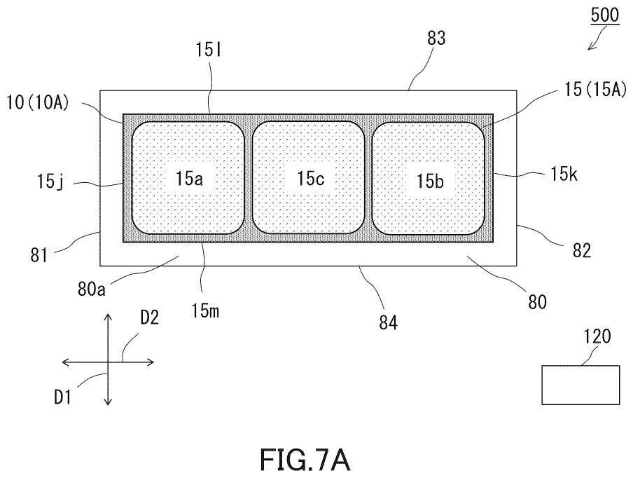

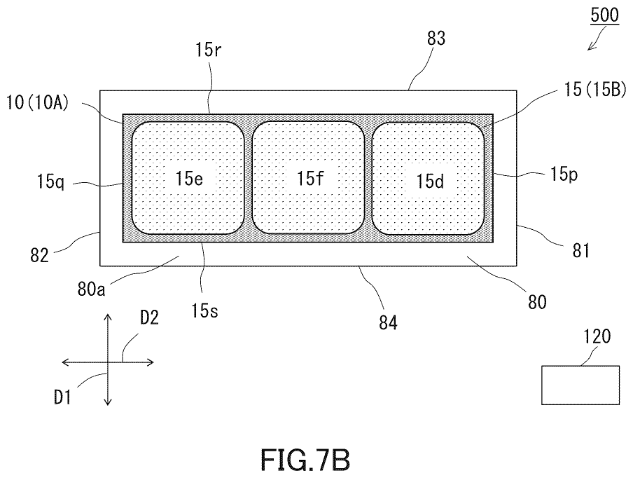

It is understood from FIG. 7A to FIG. 9F that the ANC system 500 can reduce diffracted sound generated by diffraction at the left end portion 81 and the right end portion 82.

In the example in FIG. 8A, noise from the first noise source 200A propagates toward the structure 80. A wave front 81w generated by diffraction at the left end portion 81 and a wave front 82w generated by diffraction at the right end portion 82 propagate so as to approach an axis 80X. In FIG. 8A, the propagation direction of the wave front 81w is represented by reference numeral 81d, and the propagation direction of the wave front 82w is represented by reference numeral 82d. The axis 80X is an axis passing between the left end portion 81 and the right end portion 82 and extending in a direction away from the structure 80. Specifically, in the example in FIG. 8A, the axis 80X is orthogonal to the front surface 80a of the structure 80 and passes through the center of the front surface 80a.

On the other hand, as shown in FIG. 7A, the first radiation surface 15A of the first piezoelectric speaker 10A has a first region 15a, a second region 15b, and a third region 15c. The third region 15c is positioned between the first region 15a and the second region 15b. Specifically, the first region 15a is positioned near the left end portion 81 as viewed from the third region 15c, and the second region 15b is positioned near the right end portion 82 as viewed from the third region 15c.

As shown in FIG. 8D, the first piezoelectric speaker 10A forms a first wave front 16a propagating from the first region 15a so as to approach a first reference axis 10X and a second wave front 16b propagating from the second region 15b so as to approach the first reference axis 10X. Specifically, in the present embodiment, the first wave front 16a and the second wave front 16b propagating in such a manner are formed by vibration of the first radiation surface 15A. In FIG. 8D, the propagation direction of the first wave front 16a is represented by reference numeral 13a, and the propagation direction of the second wave front 16b is represented by reference numeral 13b. The first reference axis 10X is an axis passing through the third region 15c and extending away from the first radiation surface 15A.

In a typical example, under the control of a controller 120, the first piezoelectric speaker 10A forms the first wave front 16a propagating from the first region 15a so as to approach the first reference axis 10X and the second wave front 16b propagating from the second region 15b so as to approach the first reference axis 10X. In a specific example, under the control of the controller 120, a state is maintained where the first piezoelectric speaker 10A forms the first wave front 16a and the second wave front 16b propagating in such a manner.

In the present embodiment, the first region 15a, the third region 15c, and the second region 15b are arranged in this order along the left-right direction D2. Accordingly, in the present embodiment, it can also be said that the wave front 81w derived from diffraction at the left end portion 81 and the wave front 82w derived from diffraction at the right end portion 82 propagate so as to approach the first reference axis 10X shown in FIG. 8D. Thus, the wave front 81w derived from diffraction at the left end portion 81 and the wave front 82w derived from diffraction at the right end portion 82 have common propagation directions with the first wave front 16a and the second wave front 16b derived from the ANC system 500. This is suitable for reducing diffracted sound generated by diffraction of noise at the left end portion 81 and the right end portion 82.

In the present embodiment, the first reference axis 10X is orthogonal to the third region 15c in a state where the third region 15c does not vibrate. A deviation angle θ1 of the first wave front 16a relative to the first reference axis 10X in the propagation direction is, for example, 5° or more and 85° or less, may be 15° or more and 75° or less, and may be 25° or more and 65° or less. A deviation angle θ2 of the second wave front 16b relative to the first reference axis 10X in the propagation direction is, for example, 5° or more and 85° or less, may be 15° or more and 75° or less, and may be 25° or more and 65° or less. The third region 15c may be plane in a state where the third region 15c does not vibrate. Further, the entire first radiation surface 15A may be plane in a state where the entire first radiation surface 15A does not vibrate. The first reference axis 10X may be an axis passing through the center of the first radiation surface 15A.

Further, in the example in FIG. 9A, noise from the second noise source 200B propagates toward the structure 80. A wave front 81y generated by diffraction at the left end portion 81 and a wave front 82y generated by diffraction at the right end portion 82 propagate so as to approach an axis 80Y In FIG. 9A, the propagation direction of the wave front 81y is represented by reference numeral 81e, and the propagation direction of the wave front 82y is represented by reference numeral 82e. The axis 80Y is an axis passing between the left end portion 81 and the right end portion 82 and extending in a direction away from the structure 80. Specifically, in the example in FIG. 9A, the axis 80Y is orthogonal to the back surface 80b of the structure 80 and passes through the center of the back surface 80b.

On the other hand, as shown in FIG. 7B, the second radiation surface 15B of the second piezoelectric speaker 10B has a fourth region 15d, a fifth region 15e, and a sixth region 15f. The sixth region 15f is positioned between the fourth region 15d and the fifth region 15e. Specifically, the fourth region 15d is positioned near the left end portion 81 as viewed from the sixth region 15f, and the fifth region 15e is positioned near the right end portion 82 as viewed from the sixth region 15f.

As shown in FIG. 9D, the second piezoelectric speaker 10B forms a fourth wave front 16d propagating from the fourth region 15d so as to approach a second reference axis 10Y and a fifth wave front 16e propagating from the fifth region 15e so as to approach the second reference axis 10Y Specifically, in the present embodiment, the fourth wave front 16d and the fifth wave front 16e propagating in such a manner are formed by vibration of the second radiation surface 15B. In FIG. 9D, the propagation direction of the fourth wave front 16d is represented by reference numeral 13d, and the propagation direction of the fifth wave front 16e is represented by reference numeral 13e. The second reference axis 10Y is an axis passing through the sixth region 15f and extending away from the second radiation surface 15B.

In a typical example, under the control of the controller 120, the second piezoelectric speaker 10B forms the fourth wave front 16d propagating from the fourth region 15d so as to approach the second reference axis 10Y and the fifth wave front 16e propagating from the fifth region 15e so as to approach the second reference axis 10Y In a specific example, under the control of the controller 120, a state is maintained where the second piezoelectric speaker 10B forms the fourth wave front 16d and the fifth wave front 16e propagating in such a manner.

In the present embodiment, the fourth region 15d, the sixth region 15f, and the fifth region 15e are arranged in this order along the left-right direction D2. Accordingly, in the present embodiment, it can also be said that the wave front 81y derived from diffraction at the left end portion 81 and the wave front 82y derived from diffraction at the right end portion 82 propagate so as to approach the second reference axis 10Y shown in FIG. 9D. Thus, the wave front 81y derived from diffraction at the left end portion 81 and the wave front 82y derived from diffraction at the right end portion 82 have common propagation directions with the fourth wave front 16d and the fifth wave front 16e derived from the ANC system 500. This is suitable for reducing diffracted sound generated by diffraction of noise at the left end portion 81 and the right end portion 82.

In the present embodiment, the second reference axis 10Y is orthogonal to the sixth region 15f in a state where the sixth region 15f does not vibrate. A deviation angle 63 of the fourth wave front 16d relative to the second reference axis 10Y in the propagation direction is, for example, 5° or more and 85° or less, may be 15° or more and 75° or less, and may be 25° or more and 65° or less. A deviation angle θ4 of the fifth wave front 16e relative to the second reference axis 10Y in the propagation direction is, for example, 5° or more and 85° or less, may be 15° or more and 75° or less, and may be 25° or more and 65° or less. The sixth region 15f may be plane in a state where the sixth region 15f does not vibrate. Further, the entire second radiation surface 15B may be plane in a state where the entire second radiation surface 15B does not vibrate. The second reference axis 10Y may be an axis passing through the center of the second radiation surface 15B.

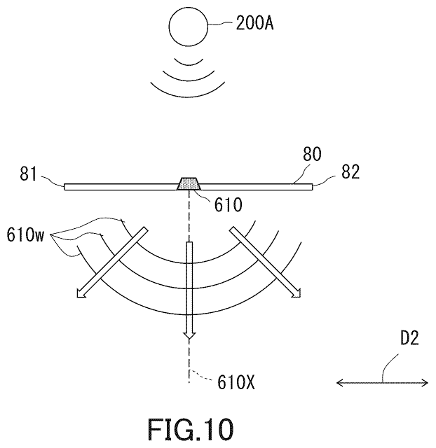

FIG. 10 is a diagram illustrating a conventional dynamic speaker 610. The dynamic speaker 610 radiates a substantially hemispherical wave from its radiation surface. The substantially hemispherical wave has a wave front 610w that is also substantially hemispherical. In FIG. 10, an axis 610X is an axis passing through the radiation surface of the dynamic speaker 610 and extending away from the radiation surface.

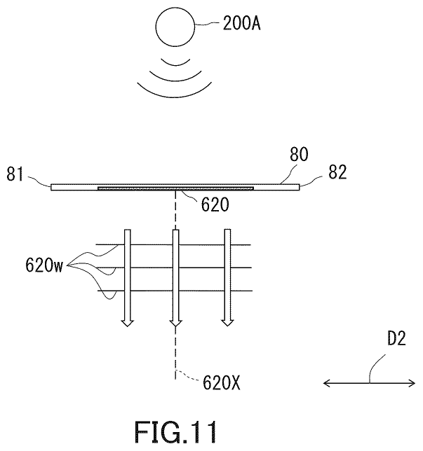

FIG. 11 is a diagram illustrating a conventional plane speaker 620. The plane speaker 620 radiates a substantially plane wave from its radiation surface. The substantially plane wave has a wave front 620w that is also substantially plane. In FIG. 11, an axis 620X is an axis passing through the radiation surface of the plane speaker 620 and extending away from the radiation surface.

As understood from FIG. 8D, FIG. 10, and FIG. 11, the conventional speakers 610 and 620 cannot achieve the combination according to the present embodiment composed of the first wave front 16a propagating from the first region 15a so as to approach the first reference axis 10X and the second wave front 16b propagating from the second region 15b so as to approach the first reference axis 10X. Similarly, the conventional speakers 610 and 620 cannot achieve the combination composed of the fourth wave front 16d propagating from the fourth region 15d so as to approach the second reference axis 10Y and the fifth wave front 16e propagating from the fifth region 15e so as to approach the second reference axis 10Y.

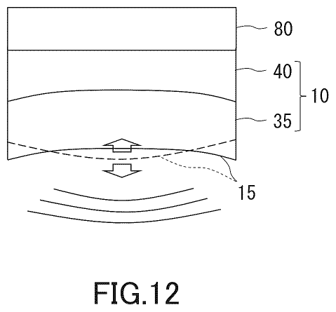

FIG. 12 is a diagram illustrating the vibration of the radiation surface 15 of the piezoelectric speaker 10 of the present embodiment. As shown in FIG. 12, the piezoelectric speaker 10 is configured to vibrate well even at the end portions of the radiation surface 15. The radiation surface 15 as a whole has a high degree of freedom of vibration. This has the possibility of contributing to the formation of the first wave front 16a, the second wave front 16b, the fourth wave front 16d, and the fifth wave front 16e. Typically, the radiation surface 15 can vibrate in a mode that is somewhat close to a free-end vibration mode. Specifically, the radiation surface 15 can vibrate in a mode that is somewhat close to a primary free-end vibration mode.

An advantage of the piezoelectric speaker 10 over the conventional speakers 610 and 620 in terms of sound reducing effect tends to be easily exhibited when noise from the first noise source 200A has a high frequency and when noise from the second noise source 200B has a high frequency.

In a specific example, in the first region 15a, a portion of the end portions of the first radiation surface 15A is formed. In the second region 15b, a portion of the end portions of the first radiation surface 15A is formed. In the fourth region 15d, a portion of the end portions of the second radiation surface 15B is formed. In the fifth region 15e, a portion of the end portions of the second radiation surface 15B is formed.

Here, a situation is considered in which the first piezoelectric speaker 10A does not vibrate and the first piezoelectric speaker 10A does not exhibit its sound reducing function (hereinafter referred to as a first non-sound-reducing situation). In the first non-sound-reducing situation, depending on the size of the structure 80 and the wavelength of noise from the first noise source 200A, as schematically shown in FIG. 8C, diffraction of the noise from the first noise source 200A at the structure 80 can cause appearance of a period, in the first piezoelectric speaker 10A, during which a sound wave in the first region 15a and a sound wave in the second region 15b have the same phase in terms of whether positive or negative, the sound wave in the first region 15a and a sound wave in the third region 15c have the phases opposite to each other in terms of whether positive or negative, and the sound wave in the second region 15b and the sound wave in the third region 15c have the phases opposite to each other in terms of whether positive or negative. In FIG. 8C, hatching 11m is associated the first region 15a and the second region 15b. This schematically represents that the phases of the sound waves in the first region 15a and the second region 15b are one of positive and negative. Further, in FIG. 8C, hatching 11n is associated with the third region 15c. This schematically represents that the phase of the sound wave in the third region 15c is the other of positive and negative.

With respect to this point, according to the present embodiment, noise derived from the first noise source 200A having such a phase distribution as above in the first region 15a, the second region 15b, and the third region 15c can be reduced by sound derived from the first piezoelectric speaker 10A, as described below.

The sound wave in the first region 15a formed by the first piezoelectric speaker 10A is defined as a first sound wave. The sound wave in the second region 15b formed by the first piezoelectric speaker 10A is defined as a second sound wave. The sound wave in the third region 15c formed by the first piezoelectric speaker 10A is defined as a third sound wave. In the present embodiment, as schematically shown in FIG. 8F, a period appears, in the first piezoelectric speaker 10A, during which the first sound wave and the second sound wave have the same phase in terms of whether positive or negative, the first sound wave and the third sound wave have the phases opposite to each other in terms of whether positive or negative, and the second sound wave and the third sound wave have the phases opposite to each other in terms of whether positive or negative. According to the present embodiment, noise derived from the first noise source 200A having such a phase distribution as above in the first region 15a, the second region 15b, and the third region 15c can be reduced by sound derived from the first piezoelectric speaker 10A. In FIG. 8F, the hatching 11m is associated with the third region 15c. This schematically represents that the phase of the sound wave derived from the first piezoelectric speaker 10A in the third region 15c is one of positive and negative. Further, in FIG. 8F, the hatching 11n is associated with the first region 15a and the second region 15b. This schematically represents that the phases of the sound waves derived from the first piezoelectric speaker 10A in the first region 15a and the second region 15b are the other of positive and negative.

In a typical example, under the control of the controller 120, a period T1 can appear during which the first sound wave and the second sound wave have the same phase in terms of whether positive or negative, the first sound wave and the third sound wave have the phases opposite to each other in terms of whether positive or negative, and the second sound wave and the third sound wave have the phases opposite to each other in terms of whether positive or negative. When one period of the first sound wave, the second sound wave, or the third sound wave is defined as Tp, T1/Tp is, for example, 0.01 or more and 1 or less, depending on the first noise source 200A. Further, in the case where the first noise source 200A radiates a sine wave, the period T1 can continue or can appear periodically. T1/Tp may be 0.1 or more and 1 or less, may be 0.5 or more and 1 or less, may be 0.7 or more and 1 or less, and may be 0.9 or more and 1 or less.

Further, a situation is considered in which the second piezoelectric speaker 10B does not vibrate and the second piezoelectric speaker 10B does not exhibit its sound reducing function (hereinafter referred to as a second non-sound-reducing situation). In the second non-sound-reducing situation, depending on the size of the structure 80 and the wavelength of noise from the second noise source 200B, as schematically shown in FIG. 9C, diffraction of the noise from the second noise source 200B at the structure 80 can cause appearance of a period, in the second piezoelectric speaker 10B, during which a sound wave in the fourth region 15d and a sound wave in the fifth region 15e have the same phase in terms of whether positive or negative, the sound wave in the fourth region 15d and a sound wave in the sixth region 15f have the phases opposite to each other in terms of whether positive or negative, and the sound wave in the fifth region 15e and the sound wave in the sixth region 15f have the phases opposite to each other in terms of whether positive or negative. In FIG. 9C, the hatching 11m is associated the fourth region 15d and the fifth region 15e. This schematically represents that the phases of the sound waves in the fourth region 15d and the fifth region 15e are one of positive and negative. Further, in FIG. 9C, the hatching 11n is associated with the sixth region 15f. This schematically represents that the phase of the sound wave in the sixth region 15f is the other of positive and negative.

With respect to this point, according to the present embodiment, noise derived from the second noise source 200B having such a phase distribution as above in the fourth region 15d, the fifth region 15e, and the sixth region 15f can be reduced by sound derived from the second piezoelectric speaker 10B, as described below.

The sound wave in the fourth region 15d formed by the second piezoelectric speaker 10B is defined as a fourth sound wave. The sound wave in the fifth region 15e formed by the second piezoelectric speaker 10B is defined as a fifth sound wave. The sound wave in the sixth region 15f formed by the second piezoelectric speaker 10B is defined as a sixth sound wave. In the present embodiment, as schematically shown in FIG. 9F, a period appears, in the second piezoelectric speaker 10B, during which the fourth sound wave and the fifth sound wave have the same phase in terms of whether positive or negative, the fourth sound wave and the sixth sound wave have the phases opposite to each other in terms of whether positive or negative, and the fifth sound wave and the sixth sound wave have the phases opposite to each other in terms of whether positive or negative. According to the present embodiment, noise derived from the second noise source 200B having such a phase distribution as above in the fourth region 15d, the fifth region 15e, and the sixth region 15f can be reduced by sound derived from the second piezoelectric speaker 10B. In FIG. 9F, the hatching 11m is associated with the sixth region 15f. This schematically represents that the phase of the sound wave derived from the second piezoelectric speaker 10B in the sixth region 15f is one of positive and negative. Further, in FIG. 9F, the hatching 11n is associated with the fourth region 15d and the fifth region 15e. This schematically represents that the phases of the sound waves derived from the second piezoelectric speaker 10B in the fourth region 15d and the fifth region 15e are the other of positive and negative.

In a typical example, under the control of the controller 120, a period T2 can appear during which the fourth sound wave and the fifth sound wave have the same phase in terms of whether positive or negative, the fourth sound wave and the sixth sound wave have the phases opposite to each other in terms of whether positive or negative, and the fifth sound wave and the sixth sound wave have the phases opposite to each other in terms of whether positive or negative. When one period of the fourth sound wave, the fifth sound wave, or the sixth sound wave is defined as Tq, T2/Tq is, for example, 0.01 or more and 1 or less, depending on the second noise source 200B. Further, in the case where the second noise source 200B radiates a sine wave, the period T2 can continue or can appear periodically. T2/Tq may be 0.1 or more and 1 or less, may be 0.5 or more and 1 or less, may be 0.7 or more and 1 or less, and may be 0.9 or more and 1 or less.

As described above, the first sound wave is a sound wave in the first region 15a formed by the first piezoelectric speaker 10A. The first sound wave conceptually encompasses a sound wave at a position infinitely close to the first region 15a in a space facing the first region 15a. Accordingly, measurement of the first sound wave can be achieved by measuring the sound wave at this “infinitely close position”. The same applies to the second sound wave and the third sound wave.

As described above, the fourth sound wave is a sound wave in the fourth region 15d formed by the second piezoelectric speaker 10B. The fourth sound wave conceptually encompasses a sound wave at a position infinitely close to the fourth region 15d in a space facing the fourth region 15d. Accordingly, measurement of the fourth sound wave can be achieved by measuring the sound wave at this “infinitely close position”. The same applies to the fifth sound wave and the sixth sound wave.

The phase distribution as above of the first sound wave, the second sound wave, and the third sound wave can be formed by vibrating the first radiation surface 15A in the primary free-end vibration mode. Further, the phase distribution as above of the fourth sound wave, the fifth sound wave, and the sixth sound wave can be formed by vibrating the second radiation surface 15B in the primary free-end vibration mode.

The ANC system 500 can reduce diffracted sound generated by diffraction at the upper end portion 83. FIG. 8B schematically shows a wave front 83w generated by diffraction of sound derived from the first noise source 200A at the upper end portion 83 and a propagation direction 83d of the wave front 83w. FIG. 9B schematically shows a wave front 83y generated by diffraction of sound derived from the second noise source 200B at the upper end portion 83 and a propagation direction 83e of the wave front 83y.

In the present embodiment, the ANC system 500 includes the controller 120. The controller 120 is configured to control the first piezoelectric speaker 10A to output sound in a first frequency range FR1. The first frequency range FR1 is, for example, 50 Hz or more and 3000 Hz or less, and may be 100 Hz or more and 2000 Hz or less.

In a specific example, a second frequency range FR2 can be set for the controller 120. The controller 120 controls the frequency of sound to be output from the first piezoelectric speaker 10A to have a value within the second frequency range FR2. The second frequency range FR2 is narrower than the first frequency range FR1. In reality, the ANC system 500 is sometimes desired to exercise its capability not maximally but only partially in consideration of the scale, computational load, and the like of the ANC system 500. This specific example is adoptable to such a case. Specifically, in this specific example, a desired band can be selected as the second frequency range FR2.

Further, in the present embodiment, the controller 120 is configured to control the second piezoelectric speaker 10B to output sound in a third frequency range FR3. The third frequency range FR3 is, for example, 50 Hz or more and 3000 Hz or less, and may be 100 Hz or more and 2000 Hz or less.

In a specific example, a fourth frequency range FR4 can be set for the controller 120. The controller 120 controls the frequency of sound to be output from the second piezoelectric speaker 10B to have a value within the fourth frequency range FR4. The fourth frequency range FR4 is narrower than the third frequency range FR3. In reality, the ANC system 500 is sometimes desired to exercise its capability not maximally but only partially in consideration of the scale, computational load, and the like of the ANC system 500. This specific example is adoptable to such a case. Specifically, in this specific example, a desired band can be selected as the fourth frequency range FR4.

In the present embodiment, the controller 120 has a control mode of controlling the frequency of sound to be output from the first piezoelectric speaker 10A to a value within a first specified frequency range and controlling the frequency of sound to be output from the second piezoelectric speaker 10B to a value within a second specified frequency range. In the following description, the wavelength of sound having the upper limit for the first specified frequency range is defined as a first reference wavelength. Further, the wavelength of sound having the upper limit for the second specified frequency range is defined as a second reference wavelength. The control mode may be a mode in which the first specified frequency range is the first frequency range FR1 and the second specified frequency range is the third frequency range FR3. The control mode may be a mode in which the first specified frequency range is the first frequency range FR1 and the second specified frequency range is the fourth frequency range FR4. The control mode may be a mode in which the first specified frequency range is the second frequency range FR2 and the second specified frequency range is the third frequency range FR3. The control mode may be a mode in which the first specified frequency range is the second frequency range FR2 and the second specified frequency range is the fourth frequency range FR4. The controller 120 may have these four modes. In that case, the four modes can be used selectively.

As shown in FIG. 4A, in the present embodiment, in plan view of the front surface 80a of the structure 80, the first radiation surface 15A has the left end portion 15j and the right end portion 15k facing each other. In plan view of the front surface 80a of the structure 80, a first left margin M1 between the left end portion 15j of the first radiation surface 15A and the left end portion 81 of the structure 80 is 0 or more and 1/10 or less of the first reference wavelength. In plan view of the front surface 80a of the structure 80, a first right margin M2 between the right end portion 15k of the first radiation surface 15A and the right end portion 82 of the structure 80 is 0 or more and 1/10 or less of the first reference wavelength. This is suitable for reducing diffracted sound generated by diffraction of noise derived from the first noise source 200A at the left end portion 81 and the right end portion 82. The ratio 1/10 is derived from the fact that a region where sound is to be reduced by a typical ANC is 1/10 of the wavelength of noise to be controlled.

In reality, there are cases where the first left margin M1 and the first right margin M2 should be increased to a certain extent for the sake of commercialization. Taking this into consideration, the upper limits for the first left margin M1 and the first right margin M2 may be set to more than 1/10 of the first reference wavelength. In view of performing a reasonable commercialization while achieving an effect of reducing diffracted sound, the first left margin M1 can be set to 0 or more and ⅓ or less of the first reference wavelength, for example. Further, the first right margin M2 in plan view of the front surface 80a of the structure 80 can be set to 0 or more and ⅓ or less of the first reference wavelength.

The first left margin M1 is, for example, 0 cm or more and 50 cm or less, and may be 0 cm or more and 10 cm or less. The first right margin M2 is, for example, 0 cm or more and 50 cm or less, and may be 0 cm or more and 10 cm or less.

In the present embodiment, in plan view of the front surface 80a of the structure 80, a first upper margin M3 between an upper end portion 15l of the first radiation surface 15A and the upper end portion 83 of the structure 80 is 0 or more and 1/10 or less of the first reference wavelength. The first upper margin M3 may be 0 or more and ⅓ or less of the first reference wavelength. The first upper margin M3 is, for example, 0 cm or more and 50 cm or less, and may be 0 cm or more and 10 cm or less.

There is a case where, as shown in FIG. 5A, the short direction of the first radiation surface 15A deviates from the up-down direction D1 and the long direction of the first radiation surface 15A deviates from the left-right direction D2. More generally, there is a case where in plan view of the front surface 80a of the structure 80, the end sides of the structure 80 and the end sides of the first radiation surface 15A are not parallel to each other. In such a case, the first left margin M1 adopted is the geometric mean of the distance between the left end side of the structure 80 and the left end side of the first radiation surface 15A. The first right margin M2 adopted is the geometric mean of the distance between the right end side of the structure 80 and the right end side of the first radiation surface 15A. The first upper margin M3 adopted is the geometric mean of the distance between the upper end side of the structure 80 and the upper end side of the first radiation surface 15A. A first lower margin M4, described later, adopted is the geometric mean of the distance between the lower end side of the structure 80 and the lower end side of the first radiation surface 15A.

As shown in FIG. 4B, in the present embodiment, in plan view of the back surface 80b of the structure 80, the second radiation surface 15B has the left end portion 15p and the right end portion 15q facing each other. In plan view of the back surface 80b of the structure 80, a second left margin M5 between the left end portion 15p of the second radiation surface 15B and the left end portion 81 of the structure 80 is 0 or more and 1/10 or less of the second reference wavelength. In plan view of the back surface 80b of the structure 80, a second right margin M6 between the right end portion 15q of the second radiation surface 15B and the right end portion 82 of the structure 80 is 0 or more and 1/10 or less of the second reference wavelength. This is suitable for reducing diffracted sound generated by diffraction of noise derived from the second noise source 200B at the left end portion 81 and the right end portion 82.

The upper limits for the second left margin M5 and the second right margin M6 may be set to more than 1/10 of the second reference wavelength. In view of performing a reasonable commercialization while achieving an effect of reducing diffracted sound, the second left margin M5 can be set to 0 or more and ⅓ or less of the second reference wavelength, for example. Further, the second right margin M6 in plan view of the back surface 80b of the structure 80 can be set to 0 or more and ⅓ or less of the second reference wavelength.

The second left margin M5 is, for example, 0 cm or more and 50 cm or less, and may be 0 cm or more and 10 cm or less. The second right margin M6 is, for example, 0 cm or more and 50 cm or less, and may be 0 cm or more and 10 cm or less.

In the present embodiment, in plan view of the back surface 80b of the structure 80, a second upper margin M7 between an upper end portion 15r of the second radiation surface 15B and the upper end portion 83 of the structure 80 is 0 or more and 1/10 or less of the second reference wavelength. The second upper margin M7 may be 0 or more and ⅓ or less of the second reference wavelength. The second upper margin M7 is, for example, 0 cm or more and 50 cm or less, and may be 0 cm or more and 10 cm or less.

There is a case where, as shown in FIG. 5B, the short direction of the second radiation surface 15B deviates from the up-down direction D1 and the long direction of the second radiation surface 15B deviates from the left-right direction D2. More generally, there is a case where in plan view of the back surface 80b of the structure 80, the end sides of the structure 80 and the end sides of the second radiation surface 15B are not parallel to each other. In such a case, the second left margin M5 adopted is the geometric mean of the distance between the left end side of the structure 80 and the left end side of the second radiation surface 15B. The second right margin M6 adopted is the geometric mean of the distance between the right end side of the structure 80 and the right end side of the second radiation surface 15B. The second upper margin M7 adopted is the geometric mean of the distance between the upper end side of the structure 80 and the upper end side of the second radiation surface 15B. A second lower margin M8, described later, adopted is the geometric mean of the distance between the lower end side of the structure 80 and the lower end side of the second radiation surface 15B.

In the present embodiment, in plan view of the front surface 80a or the back surface 80b of the structure 80, the left end portion 15j of the first radiation surface 15A and the left end portion 15p of the second radiation surface 15B overlap each other. However, these may not overlap each other. In the present embodiment, in plan view of the front surface 80a or the back surface 80b of the structure 80, the right end portion 15k of the first radiation surface 15A and the right end portion 15q of the second radiation surface 15B overlap each other. However, these may not overlap each other. In the present embodiment, in plan view of the front surface 80a or the back surface 80b of the structure 80, the upper end portion 15l of the first radiation surface 15A and the upper end portion 15r of the second radiation surface 15B overlap each other. However, these may not overlap each other. In the present embodiment, in plan view of the front surface 80a or the back surface 80b of the structure 80, a lower end portion 15m of the first radiation surface 15A and the lower end portion 15s of the second radiation surface 15B overlap each other. However, these may not overlap each other.

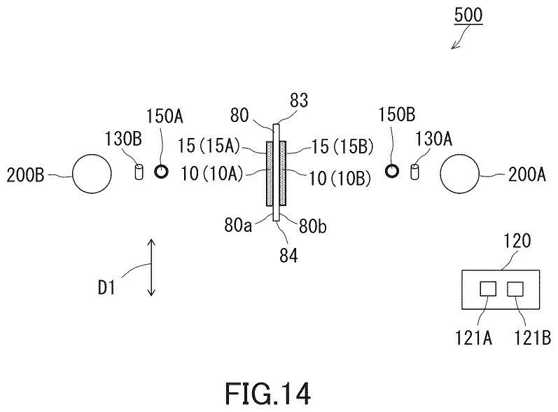

In the present embodiment, as shown in FIG. 14, the ANC system 500 includes a first reference microphone 130A, a second reference microphone 130B, and the controller 120. The controller 120 controls sound to be output from the first piezoelectric speaker 10A, with use of the first reference microphone 130A. The controller 120 controls sound to be output from the second piezoelectric speaker 10B, with use of the second reference microphone 130B.

In the present embodiment, the controller 120 has a first noise control filter 121A and a second noise control filter 121B. The controller 120 controls sound to be output from the first piezoelectric speaker 10A, with use of the first noise control filter 121A. The controller 120 controls sound to be output from the second piezoelectric speaker 10B, with use of the second noise control filter 121B.

In the example in FIG. 1 to FIG. 7B, the lower end portion 84 is in contact with the floor. However, the structure 80 can also be disposed so that a space will be formed under the lower end portion 84. In this case, the ANC system 500 can be configured to reduce diffracted sound generated at the lower end portion 84. For example, at least one stand may be installed on the floor so that the structure 80 will be placed on the stand.

In an example, in plan view of the front surface 80a of the structure 80, the first lower margin M4 between the lower end portion 15m of the first radiation surface 15A and the lower end portion 84 of the structure 80 is 0 or more and 1/10 or less of the first reference wavelength. The first lower margin M4 may be 0 or more and ⅓ or less of the first reference wavelength. The first lower margin M4 is, for example, 0 cm or more and 50 cm or less, and may be 0 cm or more and 10 cm or less.

In an example, in plan view of the back surface 80b of the structure 80, the second lower margin M8 between a lower end portion 15s of the second radiation surface 15B and the lower end portion 84 of the structure 80 is 0 or more and 1/10 or less of the second reference wavelength. The second lower margin M8 may be 0 or more and ⅓ or less of the second reference wavelength. The second lower margin M8 is, for example, 0 cm or more and 50 cm or less, and may be 0 cm or more and 10 cm or less.

The first piezoelectric speaker 10A may be disposed on any portion of the front surface 80a of the structure 80. The second piezoelectric speaker 10B may be disposed on any portion of the back surface 80b of the structure 80.

### [Specific Example of Control Performed by ANC System 500]

A specific example of control performed by the ANC system 500 will be described below.

In this specific example, the ANC system 500 includes the structure 80, the first piezoelectric speaker 10A, the second piezoelectric speaker 10B, the first reference microphone 130A, the second reference microphone 130B, and the controller 120. In the specific example, as shown in FIG. 14, the second noise source 200B, the second reference microphone 130B, the first piezoelectric speaker 10A, the structure 80, the second piezoelectric speaker 10B, the first reference microphone 130A, and the first noise source 200A are arranged in this order. The controller 120 has the first noise control filter 121A and the second noise control filter 121B.

Assume a case where a sound wave targeted for cancellation by the first piezoelectric speaker 10A has traveled from the first noise source 200A, become diffracted at the structure 80, and then reached a region 150A where sound is to be reduced (a region where sound is to be reduced is hereinafter simply referred to as a sound reducing region, and the region 150A is hereinafter referred to as a first sound reducing region 150A), and has a waveform X1 in the first sound reducing region 150A. The first piezoelectric speaker 10A radiates a sound wave that is to have, upon reaching the first sound reducing region 150A, a waveform Y1 opposite in phase to the waveform X1. These sound waves cancel out each other in the first sound reducing region 150A. In other words, these sound waves are synthesized in the first sound reducing region 150A to generate a synthetic sound wave having a waveform Z1 having an amplitude reduced to 0 or a low level.

Assume a case where a sound wave targeted for cancellation by the second piezoelectric speaker 10B has traveled from the second noise source 200B, become diffracted at the structure 80, and then reached a second sound reducing region 150B, and has a waveform X2 in the second sound reducing region 150B. The second piezoelectric speaker 10B radiates a sound wave that is to have, upon reaching the second sound reducing region 150B, a waveform Y2 opposite in phase to the waveform X2. These sound waves cancel out each other in the second sound reducing region 150B. In other words, these sound waves are synthesized in the second sound reducing region 150B to generate a synthetic sound wave having a waveform Z2 having an amplitude reduced to 0 or a low level.

The first reference microphone 130A and the first noise source 200A are positioned on the opposite side of the structure 80 as viewed from the first piezoelectric speaker 10A. The first reference microphone 130A detects sound from the first noise source 200A. On the basis of the sound detected by the first reference microphone 130A, the controller 120 adjusts a sound wave to be radiated from the first piezoelectric speaker 10A so that sound reduction in the first sound reducing region 150A will be performed.

The second reference microphone 130B and the second noise source 200B are positioned on the opposite side of the structure 80 as viewed from the second piezoelectric speaker 10B. The second reference microphone 130B detects sound from the second noise source 200B. On the basis of the sound detected by the second reference microphone 130B, the controller 120 adjusts a sound wave to be radiated from the second piezoelectric speaker 10B so that sound reduction in the second sound reducing region 150B will be performed.

The controller 120 has a first preamplifier (an amplifier is hereinafter also referred to as an amp), a first upper-stage low-pass filter, a first analog-to-digital converter (hereinafter also referred to as AD converter), a first power amp, a first operation unit, a first digital-to-analog converter (hereinafter also referred to as DA converter), and a first lower-stage low-pass filter.

The first preamp amplifies an output signal of the first reference microphone 130A. The first upper-stage low-pass filter passes a low-frequency component of an output signal of the first preamp. The first AD converter converts an output signal of the first upper-stage low-pass filter into a digital signal. Thus, a first reference signal x1(n) as of a time n is output from the first AD converter.

From the first reference signal x1(n), the first operation unit generates a first control signal y1 (n) as of the time n. The first operation unit includes, for example, a digital signal processor (DSP) or a field-programmable gate array (FPGA). The first operation unit has the first noise control filter 121A.

The first DA converter converts the first control signal y1(n) into an analog signal. The first lower-stage low-pass filter passes a low-frequency component of an output signal of the first DA converter. The first power amp amplifies an output signal of the first lower-stage low-pass filter. A signal output from the first power amp is transmitted as a control signal to the first piezoelectric speaker 10A. On the basis of this signal, sound is output from the first radiation surface 15A.

The first noise control filter 121A will be described below. In the tuning stage, the filter coefficients of the first noise control filter 121A are identified. Specifically, the filter coefficients are determined so that the first piezoelectric speaker 10A will radiate an opposite-phase sound wave for canceling out a traveling diffracted wave that has come from the first noise source 200A and then undergone diffraction at the structure 80. In the control stage, control based on the filter coefficients identified is performed. Thus, the first control signal y1(n) is generated, thereby achieving sound reduction using the first noise control filter 121A and the first piezoelectric speaker 10A.

In the specific example, in the control stage, the filter coefficients identified as above are not changed but fixed. That is, in the control stage in the specific example, the first noise control filter 121A is a fixed filter. Thus, in the control stage, sound input to the first reference microphone 130A and sound output from the first piezoelectric speaker 10A are in one-to-one correspondence and the correspondence is fixed over time. This can achieve the sound reduction by the first piezoelectric speaker 10A with a small amount of computational resources. In the case where the position of the first noise source 200A is fixed, the first piezoelectric speaker 10A easily exhibits the sound reduction performance even with the first noise control filter 121A set to a fixed filter.

Further, the controller 120 has a second preamp, a second upper-stage low-pass filter, a second AD converter, a second power amp, a second operation unit, a second DA converter, and a second lower-stage low-pass filter.

The second preamp amplifies an output signal of the second reference microphone 130B. The second upper-stage low-pass filter passes a low-frequency component of an output signal of the second preamp. The second AD converter converts an output signal of the second upper-stage low-pass filter into a digital signal. Thus, a second reference signal x2(n) as of the time n is output from the second AD converter.

From the second reference signal x2(n), the second operation unit generates a second control signal y2(n) as of the time n. The second operation unit includes, for example, a DSP or an FPGA. The second operation unit has the second noise control filter 121B.

The second DA converter converts the second control signal y2(n) into an analog signal. The second lower-stage low-pass filter passes a low-frequency component of an output signal of the second DA converter. The second power amp amplifies an output signal of the second lower-stage low-pass filter. A signal output from the second power amp is transmitted as a control signal to the second piezoelectric speaker 10B. On the basis of this signal, sound is output from the second radiation surface 15B.

The second noise control filter 121B will be described below. In the tuning stage, the filter coefficients of the second noise control filter 121B are identified. Specifically, the filter coefficients are determined so that the second piezoelectric speaker 10B will radiate an opposite-phase sound wave for canceling out a traveling diffracted wave that has come from the second noise source 200B and then undergone diffraction at the structure 80. In the control stage, control based on the filter coefficients identified is performed. Thus, the second control signal y2(n) is generated, thereby achieving sound reduction using the second noise control filter 121B and the second piezoelectric speaker 10B.

In the specific example, in the control stage, the filter coefficients identified as above are not changed but fixed. That is, in the control stage in the specific example, the second noise control filter 121B is a fixed filter. Thus, in the control stage, sound input to the second reference microphone 130B and sound output from the second piezoelectric speaker 10B are in one-to-one correspondence and the correspondence is fixed over time. This can achieve the sound reduction by the second piezoelectric speaker 10B with a small amount of computational resources. In the case where the position of the second noise source 200B is fixed, the second piezoelectric speaker 10B easily exhibits the sound reduction performance even with the second noise control filter 121B set to a fixed filter.

The ANC system 500 can be provided, for example, in an office. In a specific example, to the structure 80, which is a partition, the first piezoelectric speaker 10A and the second piezoelectric speaker 10B are attached. The first noise source 200A and the second noise source 200B are each a person.

A second embodiment of the ANC system will be described below. In the following description, the matters already described in the first embodiment of the ANC system may be omitted. The descriptions of these structure examples can be applied to each other unless they are technically contradictory to each other. These structure examples may be combined with each other unless they are technically contradictory to each other.

### Second Embodiment of Active Noise Control System

In the first embodiment described above, the piezoelectric speaker 10 is attached to both the front surface 80a and the back surface 80b of the structure 80. However, this configuration is not essential.

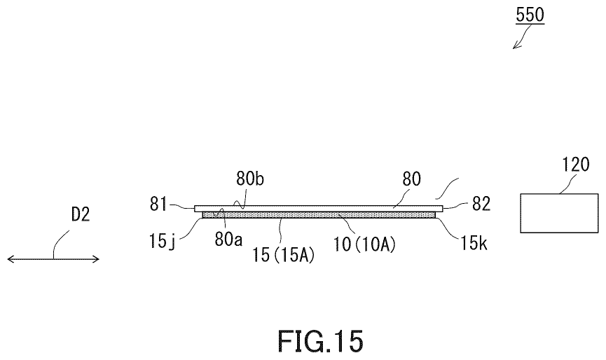

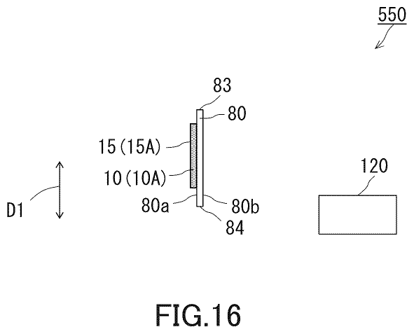

As shown in FIG. 15 and FIG. 16, in an active noise control system (ANC system) 550 according to the second embodiment, the first piezoelectric speaker 10A is attached to the front surface 80a of the structure 80 as in the first embodiment. However, the piezoelectric speaker 10 is not attached to the back surface 80b of the structure 80. Specifically, the ANC system 550 is a single ANC system using the first piezoelectric speaker 10A.

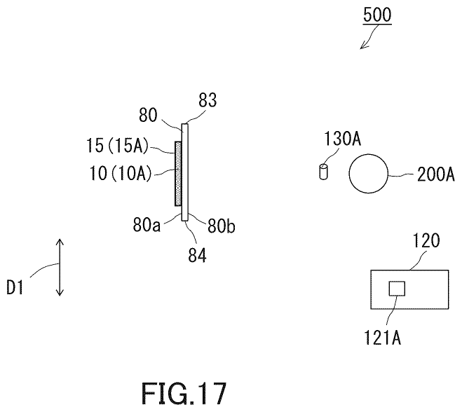

In the present embodiment, as shown in FIG. 17, the ANC system 550 includes the first reference microphone 130A and the controller 120. With use of the first reference microphone 130A, the controller 120 controls sound to be output from the first piezoelectric speaker 10A. In the present embodiment, the controller 120 has the first noise control filter 121A.

In the present embodiment, the controller 120 has a control mode of controlling the frequency of sound to be output from the first piezoelectric speaker 10A to a value within the first specified frequency range. The control mode may be a mode in which the first specified frequency range is the first frequency range FR1. The control mode may be a mode in which the first specified frequency range is the second frequency range FR2. The controller 120 may have these two modes. In that case, the two modes can be used selectively.

In a specific example of the present embodiment, the controller 120 has the first preamp, the first upper-stage low-pass filter, the first AD converter, the first power amp, the first operation unit, the first DA converter, and the first lower-stage low-pass filter. The first operation unit has the first noise control filter 121A.

[Attenuation of Sound that has Traveled Around from Piezoelectric Speaker 10 to Rear of Structure 80]

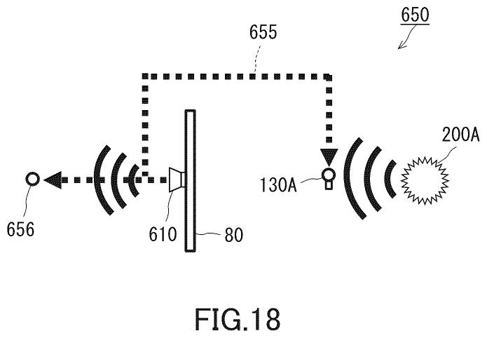

The ANC system 500 according to the first embodiment and the ANC system 550 according to the second embodiment each have a configuration suitable for attenuating sound that has traveled around from the piezoelectric speaker 10 to the rear of the structure 80. This point will be described below with reference to FIG. 18 to FIG. 20.

As described above, sound has not only a property of straightness but also a property of diffraction. Accordingly, sound output from a speaker attached to a structure not only travels straight forward, where the speaker faces, but also becomes diffracted to travel around to the rear of the structure.

FIG. 18 is a schematic diagram showing an ANC system 650 configured by attaching the conventional dynamic speaker 610 to the structure 80. In the example in FIG. 18, the first reference microphone 130A detects noise from the first noise source 200A. On the basis of the detected sound, the dynamic speaker 610 outputs sound toward a sound reducing region 656. Sound reduction is thus performed on the noise from the first noise source 200A that has become diffracted at the structure 80 to reach the sound reducing region 656. However, a portion of the sound output from the dynamic speaker 610 has traveled around to the rear of the structure 80. The sound that has traveled around is input to the first reference microphone 130A. The sound thus input to the first reference microphone 130A is to act as noise in the control on sound that is to be output later from the dynamic speaker 610. Consequently, travel around of sound in such a manner can deteriorate the sound reduction performance of the ANC system 650. In FIG. 18, a dotted line 655 schematically represents a state in which sound travels around from the dynamic speaker 610 to the rear of the structure 80 and is input to the first reference microphone 130A. Acoustic radiation traveling around to the rear in such a manner is also referred to as an acoustic feedback path (AFP).

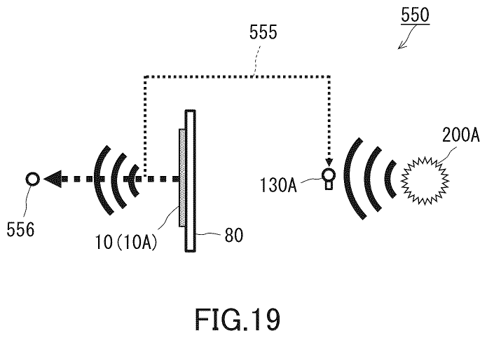

FIG. 19 is a schematic diagram showing the ANC system 550 according to the second embodiment configured by attaching the first piezoelectric speaker 10A to the structure 80. In the example in FIG. 19, the first reference microphone 130A detects noise from the first noise source 200A. On the basis of the detected sound, the first piezoelectric speaker 10A outputs sound toward a sound reducing region 556. Sound reduction is thus performed on the noise from the first noise source 200A that has become diffracted at the structure 80 to reach the sound reducing region 556. Moreover, the ANC system 550 more easily attenuates sound that has traveled around to the rear of the structure 80 in the above manner than the ANC system 650. In FIG. 19, a dotted line 555 schematically represents a state in which sound travels around from the first piezoelectric speaker 10A to the rear of the structure 80 and is input to the first reference microphone 130A. The amount of sound that has traveled around to the rear of the structure 80 is smaller in the ANC system 550 in FIG. 19 than in the ANC system 650 in FIG. 18. This is represented by the fact that the dotted line 555 is thinner than the dotted line 655.

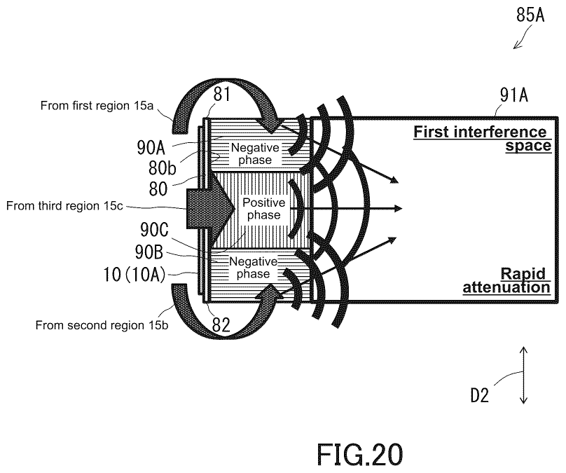

FIG. 20 is a schematic top view showing a phase distribution that can be formed with respect to the rear of the back surface 80b of the structure 80 in the ANC system 550 according to the second embodiment. Specifically, FIG. 20 shows a phase distribution that can be formed with respect to a first reference plane 85A perpendicular to the up-down direction D1.

Behind the back surface 80b, there are a first rear space 90A, a second rear space 90B, and a third rear space 90C. The third rear space 90C is positioned between the first rear space 90A and the second rear space 90B. The first rear space 90A is positioned near the left end portion 81 as viewed from the third rear space 90C. The second rear space 90B is positioned near the right end portion 82 as viewed from the third rear space 90C. In the illustrated example, the first rear space 90A, the second rear space 90B, and the third rear space 90C are positioned near the back surface 80b.

A sound wave in the first region 15a radiated by the first piezoelectric speaker 10A travels around to the first rear space 90A via the left end portion 81 with the phase maintained at either positive or negative. A sound wave radiated in the second region 15b by the first piezoelectric speaker 10A travels around to the second rear space 90B via the right end portion 82 with the phase maintained at either positive or negative. A sound wave radiated in the third region 15c by the first piezoelectric speaker 10A travels around to the third rear space 90C via the upper end portion 83 with the phase maintained at either positive or negative.

FIG. 20 illustrates that the travel around of sound causes appearance of a period during which the phase of the sound wave in the first rear space 90A is negative, the phase of the sound wave in the second rear space 90B is negative, and the phase of the sound wave in the third rear space 90C is positive. The travel around of sound can also cause appearance of a period during which these phases are inverted. That is, the travel around of sound can also case appearance of a period during which the phase of the sound wave in the first rear space 90A is positive, the phase of the sound wave in the second rear space 90B is positive, and the phase of the sound wave in the third rear space 90C is negative.

In FIG. 20, a first interference space 91A is illustrated. The first interference space 91A is a space that is more distant than the first rear space 90A, the third rear space 90C, and the second rear space 90B are as viewed from the back surface 80b of the structure 80. As described above, a period can appear during which the respective phases of the sound waves in the first rear space 90A, the third rear space 90C, and the second rear space 90B are respectively negative, positive, and negative, or are respectively positive, negative, and positive. The sound wave in the first rear space 90A, the sound wave in the third rear space 90C, and the sound wave in the second rear space 90B propagate to the first interference space 91A, which is positioned further behind. In the first interference space 91A, these sound waves interfere with each other and cancel out each other. Consequently, in the first interference space 91A, sound derived from the first piezoelectric speaker 10A is attenuated. In the spaces behind the back surface 80b of the structure 80, the above attenuation action tends to occur particularly at a position distant from the back surface 80b.

As described with reference to FIG. 12, the first radiation surface 15A of the first piezoelectric speaker 10A has a distinctive vibration pattern. It is considered that the sound attenuation action in the first interference space 91A is exhibited on the basis of the distinctive vibration pattern.

The attenuation of sound derived from the first piezoelectric speaker 10A performed in the first interference space 91A can contribute to good sound reduction. For example, in the case where the first reference microphone 130A is present in the first interference space 91A, sound that has traveled around from the first piezoelectric speaker 10A to the first interference space 91A is less prone to action as noise in the control on sound that is to be output later from the first piezoelectric speaker 10A.

The description has been given with reference to FIG. 19 and FIG. 20 on the advantages obtained by the ANC system 550 according to the second embodiment in which the piezoelectric speaker 10 is attached to either the front surface 80a or the back surface 80b of the structure 80. The same effects are also obtained by the ANC system 500 according to the first embodiment in which the piezoelectric speaker 10 is attached to both the front surface 80a and the back surface 80b of the structure 80. Further, in the ANC system 500 according to the first embodiment, in the space behind the back surface 80b of the structure 80, sound derived from the first piezoelectric speaker 10A becomes attenuated. It is consequently possible to reduce giving of sound derived from the first piezoelectric speaker 10A as noise to a space targeted for sound reduction by the second piezoelectric speaker 10B. This can contribute to good sound reduction in the targeted space. In the space behind the front surface 80a of the structure 80, sound derived from the second piezoelectric speaker 10B becomes attenuated. It is consequently possible to reduce giving of sound derived from the second piezoelectric speaker 10B as noise to a space targeted for sound reduction by the first piezoelectric speaker 10A. This can contribute to good sound reduction in the above space.

As described above, at least one stand may be installed on the floor so that the structure 80 will be placed on the stand to form a space under the lower end portion 84. In this example, a sound wave radiated in the third region 15c by the first piezoelectric speaker 10A can travel around to the third rear space 90C via the lower end portion 84 with the phase maintained at either positive or negative. However, in this example, the respective sound waves that have traveled around via the four end portions 81, 82, 83, and 84 can, in the first interference space 91A, interfere with each other and cancel out each other. Then, in the first interference space 91A, sound derived from the first piezoelectric speaker 10A can be attenuated as in the example described with reference to FIG. 20.

### [First Structure Example of Piezoelectric Speaker 10]

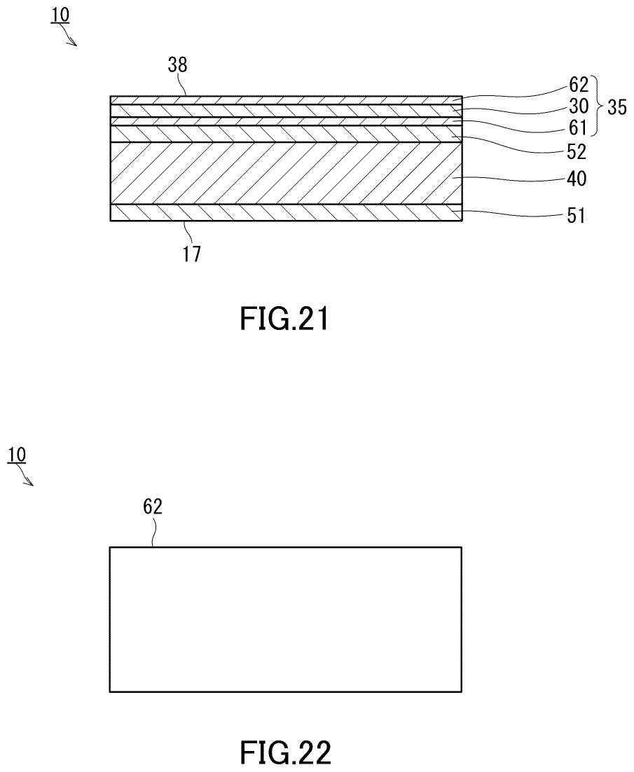

A piezoelectric speaker 10 according to a first structure example will be described with reference to FIG. 21 and FIG. 22.

The piezoelectric speaker 10 includes a piezoelectric film 35, a first joining layer 51, an interposed layer 40, and a second joining layer 52. The first joining layer 51, the interposed layer 40, the second joining layer 52, and the piezoelectric film 35 are laminated in this order.

The piezoelectric film 35 includes a piezoelectric body 30, a first electrode 61, and a second electrode 62.

The piezoelectric body 30 has the shape of a film. The piezoelectric body 30 is vibrated by application of voltage. A ceramic film, a resin film, and the like can be used as the piezoelectric body 30. Examples of the material of the piezoelectric body 30 that is a ceramic film include lead zirconate, lead zirconate titanate, lead lanthanum zirconate titanate, barium titanate, Bi-layered compounds, compounds having a tungsten bronze structure, and solid solutions of barium titanate and bismuth ferrite. Examples of the material of the piezoelectric body 30 that is a resin film include polyvinylidene fluoride and polylactic acid. The material of the piezoelectric body 30 that is a resin film may be a polyolefin such as polyethylene or polypropylene. The piezoelectric body 30 may be a non-porous body or may be a porous body.

The thickness of the piezoelectric body 30 is, for example, 10 μm or more and 300 μm or less, and may be 30 μm or more and 110 μm or less.

The first electrode 61 and the second electrode 62 are in contact with the piezoelectric body 30 so as to sandwich the piezoelectric body 30 therebetween. The first electrode 61 and the second electrode 62 each have the shape of a film. The first electrode 61 and the second electrode 62 are each connected to a lead wire which is not illustrated. The first electrode 61 and the second electrode 62 can be formed on the piezoelectric body 30 by vapor deposition, plating, sputtering, or the like. A metal foil can be used as each of the first electrode 61 and the second electrode 62. A metal foil can be stuck to the piezoelectric body 30 by using a double-faced tape, a pressure-sensitive adhesive, an adhesive, or the like. Examples of the materials of the first electrode 61 and the second electrode 62 include metals, and specific examples thereof include gold, platinum, silver, copper, palladium, chromium, molybdenum, iron, tin, aluminum, and nickel. Examples of the materials of the first electrode 61 and the second electrode 62 also include carbon and electrically conductive polymers. Examples of the materials of the first electrode 61 and the second electrode 62 also include alloys of the above metals. The first electrode 61 and the second electrode 62 may include, for example, a glass component.

The respective thicknesses of the first electrode 61 and the second electrode 62 are, for example, 10 nm or more and 150 μm or less and may be 20 nm or more and 100 μm or less.

In the example in FIG. 21 and FIG. 22, the first electrode 61 covers entirely one of principal surfaces of the piezoelectric body 30. The first electrode 61 may cover only partially the one principal surface of the piezoelectric body 30. The second electrode 62 covers entirely the other principal surface of the piezoelectric body 30. The second electrode 62 may cover only partially the other principal surface of the piezoelectric body 30.

In the first structure example, the interposed layer 40 is disposed between the piezoelectric film 35 and the first joining layer 51. The interposed layer 40 may be a layer other than an adhesive layer and a pressure-sensitive adhesive layer, or may be an adhesive layer or a pressure-sensitive adhesive layer. In the first structure example, the interposed layer 40 is a porous body layer and/or a resin layer. Here, the resin layer conceptually includes a rubber layer and an elastomer layer. Accordingly, the interposed layer 40 that is a resin layer may be a rubber layer or an elastomer layer. Examples of the interposed layer 40 that is a resin layer include an ethylene propylene rubber layer, a butyl rubber layer, a nitrile rubber layer, a natural rubber layer, a styrene-butadiene rubber layer, a silicone layer, a urethane layer, and an acrylic resin layer. Examples of the interposed layer 40 that is a porous body layer include foam layers. Specifically, examples of the interposed layer 40 that is a porous body layer and a resin layer include an ethylene propylene rubber foam layer, a butyl rubber foam layer, a nitrile rubber foam layer, a natural rubber foam layer, a styrene-butadiene rubber foam layer, a silicone foam layer, and a urethane foam layer. Examples of the interposed layer 40 that is not a porous body layer and is a resin layer include acrylic resin layers. Examples of the interposed layer 40 that is not a resin layer and is a porous body layer include porous metal body layers. Here, the resin layer refers to a layer containing a resin, and refers to a layer that may contain a resin in an amount of 30% or more, may contain a resin in an amount of 45% or more, may contain a resin in an amount of 60% or more, and may contain a resin in an amount of 80% or more. The same applies to, for example, a rubber layer, an elastomer layer, an ethylene propylene rubber layer, a butyl rubber layer, a nitrile rubber layer, a natural rubber layer, a styrene-butadiene rubber layer, a silicone layer, a urethane layer, an acrylic resin layer, and a metal layer. Further, the same applies to a resin film, a ceramic film, and the like that can be employed as the piezoelectric body 30. The interposed layer 40 may be a blended layer including two or more materials.

The elastic modulus of the interposed layer 40 is, for example, 10000 N/m² or more and 20000000 N/m² or less and may be 20000 N/m² or more and 100000 N/m² or less.

In an example, the pore diameter of the interposed layer 40 that is a porous body layer is 0.1 mm or more and 7.0 mm or less, and may be 0.3 mm or more and 5.0 mm or less. In another example, the pore diameter of the interposed layer 40 that is a porous body layer is, for example, 0.1 mm or more and 2.5 mm or less, may be 0.2 mm or more and 1.5 mm or less, and may be 0.3 mm or more and 0.7 mm or less. The porosity of the interposed layer 40 that is a porous body layer is, for example, 70% or more and 99% or less, may be 80% or more and 99% or less, and may be 90% or more and 95% or less.

A known foam (for example, the foam used in Patent Literature 2) can be used as the interposed layer 40 that is a foam layer. The interposed layer 40 that is a foam layer may have an open-cell structure, may have a closed-cell structure, or may have a semi-open-/semi-closed-cell structure. The term “open-cell structure” refers to a structure having an open cell rate of 100%. The term “closed-cell structure” refers to a structure having an open cell rate of 0%. The term “semi-open-/semi-closed-cell structure” refers to a structure having an open cell rate of greater than 0% and less than 100%. The open cell rate can be calculated, for example, by using the following equation after a test in which a foam layer is sunk in water: open cell rate (%)={(volume of absorbed water)/(volume of cell part)}×100. In a specific example, the “volume of absorbed water” can be obtained by sinking and leaving a foam layer in water under a reduced pressure of −750 mmHg for 3 minutes, measuring the mass of water having replaced the air in cells of the foam layer, and converting the mass of water in the cells into volume on the assumption that the density of water is 1.0 g/cm³. The term “volume of cell part” refers to a value calculated by using the following equation: volume of cell part (cm³)={(mass of foam layer)/(apparent density of foam layer)}−{(mass of foam layer)/(density of material)}. The term “density of material” refers to the density of a matrix (solid, or non-hollow, body) forming the foam layer.

The foaming factor (the ratio between the density before foaming and that after foaming) of the interposed layer 40 that is a foam layer is, for example, 5 or more and 40 or less, and may be 10 or more and 40 or less.

The thickness of the interposed layer 40 in an uncompressed state is, for example, 0.1 mm or more and 30 mm or less, may be 1 mm or more and 30 mm or less, may be 1.5 mm or more and 30 mm or less, and may be 2 mm or more and 25 mm or less. The interposed layer 40 in an uncompressed state is typically thicker than the piezoelectric film 35 in an uncompressed state. The thickness of the interposed layer 40 in an uncompressed state is, for example, 3 or more times the thickness of the piezoelectric film 35 in an uncompressed state, may be 10 or more times the thickness of the piezoelectric film 35 in an uncompressed state, and may be 30 or more times the thickness of the piezoelectric film 35 in an uncompressed state. The interposed layer 40 in an uncompressed state is also typically thicker than the first joining layer 51 in an uncompressed state. The thickness of the interposed layer 40 in an uncompressed state refers to the thickness of the interposed layer 40 before being incorporated into the piezoelectric speaker, in other words, the thickness of the separate interposed layer 40.

The surface of the first joining layer 51 forms the fixing surface 17. The first joining layer 51 is a layer to be joined to the structure 80. In the example in FIG. 21, the first joining layer 51 is joined to the interposed layer 40.

In the first structure example, the first joining layer 51 is a layer having pressure-sensitive adhesiveness or adhesiveness. In other words, the first joining layer 51 is an adhesive layer or a pressure-sensitive adhesive layer. The fixing surface 17 is an adhesive surface or a pressure-sensitive adhesive surface. The first joining layer 51 can be stuck to the structure 80. In the example in FIG. 21, the first joining layer 51 is in contact with the interposed layer 40.

Examples of the first joining layer 51 include a double-faced tape including a substrate and a pressure-sensitive adhesive applied to both sides of the substrate. Examples of the substrate of the double-faced tape used as the first joining layer 51 include non-woven fabric. Examples of the pressure-sensitive adhesive of the double-faced tape used as the first joining layer 51 include pressure-sensitive adhesives including an acrylic resin. The first joining layer 51 may be a layer including no substrate and formed of a pressure-sensitive adhesive.

The thickness of the first joining layer 51 is, for example, 0.01 mm or more and 1.0 mm or less and may be 0.05 mm or more and 0.5 mm or less.

The second joining layer 52 is disposed between the interposed layer 40 and the piezoelectric film 35. In the first structure example, the second joining layer 52 is a layer having pressure-sensitive adhesiveness or adhesiveness. In other words, the second joining layer 52 is an adhesive layer or a pressure-sensitive adhesive layer. Specifically, the second joining layer 52 is joined to the interposed layer 40 and the piezoelectric film 35.

Examples of the second joining layer 52 include a double-faced tape including a substrate and a pressure-sensitive adhesive applied to both sides of the substrate. Examples of the substrate of the double-faced tape used as the second joining layer 52 include non-woven fabric. Examples of the pressure-sensitive adhesive of the double-faced tape used as the second joining layer 52 include pressure-sensitive adhesives including an acrylic resin. The second joining layer 52 may be a layer including no substrate and formed of a pressure-sensitive adhesive.

The thickness of the second joining layer 52 is, for example, 0.01 mm or more and 1.0 mm or less and may be 0.05 mm or more and 0.5 mm or less.

In the first structure example, the piezoelectric film 35 is integrated with the layers on the fixing surface 17 side by bringing an adhesive surface or a pressure-sensitive adhesive surface into contact with the piezoelectric film 35. Specifically, in the first structure example, the adhesive surface or the pressure-sensitive adhesive surface is a face formed of the surface of the second pressure-sensitive adhesive or adhesive layer 52.

It is possible to configure the ANC system 500 or the ANC system 550 by employing the piezoelectric speaker 10 according to the first structure example. Compared with dynamic speakers, the piezoelectric speaker 10 requires a short time from reach of an electric signal to the speaker to output of sound (this time is hereinafter also referred to as a delay time). Accordingly, the piezoelectric speaker 10 is suitable for configuring a compact ANC system because of not only being small in size but also being capable of having a reduced distance between the reference microphone 130 and the piezoelectric speaker 10. It is also possible, for example, to attach the reference microphone 130, the controller 120, and the piezoelectric speaker 10 to a single partition.

While the piezoelectric speaker 10 is fixed to the structure 80, a voltage is applied to the piezoelectric film 35 through a lead wire. This vibrates the piezoelectric film 35, and thus a sound wave is radiated from the piezoelectric film 35.

The piezoelectric speaker 10 and the ANC system 500 or the ANC system 550, to which the piezoelectric speaker 10 is applied, are further described.

The piezoelectric speaker 10 can be fixed to the structure 80 by the fixing surface 17. In such a manner, the ANC system 500 or the ANC system 550, employing the piezoelectric speaker 10, can be configured. In the ANC system 500 or the ANC system 550, the interposed layer 40 is disposed between the piezoelectric film 35 and the structure 80. In the illustrated example, the interposed layer 40 holds only one of two principal surfaces of the piezoelectric film 35.

Lower-frequency sound in the audible range is easily generated from the piezoelectric film 35 owing to the interposed layer 40 adequately holding one of the principal surfaces of the piezoelectric film 35. Given this, the piezoelectric speaker 10 can be configured so that the interposed layer 40 will be disposed on a region accounting for 25% or more of the area of the piezoelectric film 35 when the piezoelectric film 35 is viewed in plan. The piezoelectric speaker 10 may be configured so that the interposed layer 40 will be disposed on a region accounting for 50% or more of the area of the piezoelectric film 35, on a region accounting for 75% or more of the area of the piezoelectric film 35, or on the entire region of the piezoelectric film 35 when the piezoelectric film 35 is viewed in plan. Also, 50% or more of a principal surface 38 can be formed of the piezoelectric film 35. The principal surface 38 is one of principal surfaces of the piezoelectric speaker 10 and is opposite to the fixing surface 17 that is the other principal surface. Further, 75% or more of the principal surface 38 may be formed of the piezoelectric film 35, or the entire principal surface 38 may be formed of the piezoelectric film 35.

In the first structure example, the second joining layer 52 prevents the piezoelectric film 35 and the interposed layer 40 from separating from each other. In view of adequate holding, which is mentioned above, the piezoelectric speaker 10 can be configured so that the second joining layer 52 and the interposed layer 40 will be disposed on a region accounting for 25% or more of the area of the piezoelectric film 35 when the piezoelectric film 35 is viewed in plan. The piezoelectric speaker 10 may be configured so that the second joining layer 52 and the interposed layer 40 will be disposed on a region accounting for 50% or more of the area of the piezoelectric film 35, on a region accounting for 75% or more of the area of the piezoelectric film 35, or on the entire region of the piezoelectric film 35 when the piezoelectric film 35 is viewed in plan.

In the case where the interposed layer 40 is a porous body, the rate of the region where the interposed layer 40 is disposed is defined not from a microscopical perspective in consideration of pores in the porous structure of the interposed layer 40, but rather from a relatively macroscopic perspective. For example, in the case where the piezoelectric film 35, the interposed layer 40 that is a porous body, and the second joining layer 52 are plate-like bodies having the same outline in plan, the second joining layer 52 and the interposed layer 40 are described as being disposed on a region accounting for 100% of the area of the piezoelectric film 35.

In the first structure example, the interposed layer 40 has a holding degree of 5×10⁹ N/m³ or less. The interposed layer 40 has a holding degree of, for example, 1×10⁴ N/m³ or more. The interposed layer 40 has a holding degree of preferably 5×10⁸ N/m³ or less, more preferably 2×10⁸ N/m³ or less, and even more preferably 1×10⁵ or more and 5×10⁷ N/m³ or less. The holding degree (N/m³) of the interposed layer 40 is a value obtained by dividing the product of the elastic modulus (N/m²) of the interposed layer 40 and the surface filling area ratio of the interposed layer 40 by the thickness (m) of the interposed layer 40, as represented by the following equation. The surface filling area ratio of the interposed layer 40 is the filling area ratio (a value obtained by subtracting the porosity from 1) of the principal surface on the piezoelectric film 35 side of the interposed layer 40. In the case where pores of the interposed layer 40 are evenly distributed, the surface filling area ratio can be regarded as equal to a three-dimensionally determined filling area ratio of the interposed layer 40.

Holding degree (N/m³)=Elastic modulus (N/m²)×Surface filling area ratio Thickness (m)

The holding degree can be considered to be a parameter representing the degree of holding the piezoelectric film 35 by means of the interposed layer 40. The above equation indicates that the greater the elastic modulus of the interposed layer 40 is, the greater the degree of holding becomes. The above equation indicates that the greater the surface filling area ratio of the interposed layer 40 is, the greater the degree of holding becomes. The above equation indicates that the smaller the thickness of the interposed layer 40 is, the greater the degree of holding becomes. An excessively great holding degree prevents the piezoelectric film 35 from deforming, which is necessary to emit lower-frequency sound. On the other hand, in the case where the holding degree is excessively small, the piezoelectric film 35 does not sufficiently deform in its thickness direction and extends and contracts only in its in-plane direction (the direction perpendicular to the thickness direction) and thus generation of lower-frequency sound is prevented. Since the holding degree of the interposed layer 40 is set within an adequate range, extension and contraction of the piezoelectric film 35 in the in-plane direction is adequately converted into deformation thereof in the thickness direction and that results in appropriate bending of the piezoelectric film 35 as a whole and makes it easy to generate lower-frequency sound.

As understood from the above description, there may be a layer other than the interposed layer 40 between the piezoelectric film 35 and the fixing surface 17. The other layer is, for example, the second joining layer 52.

The structure 80 may have a greater holding degree than that of the interposed layer 40. In this case as well, lower-frequency sound can be generated from the piezoelectric film 35 because of the contribution by the interposed layer 40. The structure 80 may have the same holding degree as that of the interposed layer 40, or may have a smaller holding degree than that of the interposed layer 40. The holding degree (N/m³) of the structure 80 is a value obtained by dividing the product of the elastic modulus (N/m²) of the structure 80 and the surface filling area ratio of the structure 80 by the thickness (m) of the structure 80. The surface filling area ratio of the structure 80 is the filling area ratio (a value obtained by subtracting the porosity from 1) of the principal surface on the piezoelectric film 35 side of the structure 80.

The structure 80 typically has a high stiffness (the product of Young's modulus and the second moment of area), a high Young's modulus, and/or a great thickness, compared to the interposed layer 40. The structure 80 may have the same stiffness, Young's modulus, and/or thickness as that of the interposed layer 40, or may have a lower stiffness, a lower Young's modulus, and/or a smaller thickness than that of the interposed layer 40. The Young's modulus of the structure 80 is, for example, 1 GPa or more, may be 10 GPa or more, and may be 50 GPa or more. The upper limit for the Young's modulus of the structure 80 is not particularly limited, and is, for example, 1000 GPa.

In the illustrated example, the piezoelectric film 35 is not completely surrounded by the interposed layer 40. In the illustrated example, a virtual straight line passes through the interposed layer 40 and the piezoelectric film 35 in this order, and then reaches the outside of the piezoelectric speaker 10 without passing through the interposed layer 40. Here, the phrase “virtual straight line passes” means that such a straight line can be drawn. In the illustrated example, the interposed layer 40 extends only toward the fixing surface 17 when viewed from the piezoelectric film 35.

In the illustrated example, the principal surface 38, which is opposite to the fixing surface 17, of the piezoelectric film 35, forms the radiation surface 15. That is, the principal surface 38 is one of principal surfaces of the piezoelectric film 35 which is more distant from the interposed layer 40 than the other is, and forms the radiation surface 15. In this structure, since the principal surface of the piezoelectric film 35 on the interposed layer 40 side is held by the interposed layer 40, extension and contraction of the piezoelectric film 35 in the in-plane direction can be adequately converted into deformation thereof in the thickness direction. Other embodiments can be employed.

Specifically, a first layer may be provided on the opposite side of the piezoelectric film 35 from the interposed layer 40. For example, the first layer is used for protecting the piezoelectric film 35. In this case, a principal surface of the first layer can form the radiation surface 15. Alternatively, a second layer other than the first layer can form the radiation surface 15.

The thickness of the first layer is, for example, 0.05 mm or more and 5 mm or less. The material of the first layer is, for example, a polyester-based material. Here, the polyester-based material refers to a material containing polyester, and refers to a material that may contain 30% or more polyester, 45% or more polyester, 60% or more polyester, or 80% or more polyester. In an example, the material of the interposed layer 40 is different from the material of the first layer. In the case where the material of the interposed layer 40 is different from the material of the first layer, it is possible to make a difference between the degree to which the principal surface on the interposed layer 40 side of the piezoelectric film 35 is held and the degree to which the principal surface on the first layer side of the piezoelectric film 35 is held. This can allow to adequately convert extension and contraction of the piezoelectric film 35 in the in-plane direction into deformation thereof in the thickness direction. The holding degree of the interposed layer 40 may be different from the holding degree of the first layer. Here, the holding degree (N/m³) of the first layer is a value obtained by dividing the product of the elastic modulus (N/m²) of the first layer and the surface filling area ratio of the first layer by the thickness (m) of the first layer. The surface filling area ratio of the first layer is the filling area ratio (a value obtained by subtracting the porosity from 1) of the principal surface on the piezoelectric film 35 side of the first layer. The interposed layer 40 and the first layer differing from each other in holding degree can allow to adequately convert extension and contraction of the piezoelectric film 35 in the in-plane direction into deformation thereof in the thickness direction. In a specific example, the interposed layer 40 has a higher holding degree than the first layer has. The first layer may have the shape of a film. The first layer may be non-woven fabric.

In the first structure example, the fixing surface 17 is disposed so that at least a portion of the piezoelectric film 35 will overlap the fixing surface 17 (the first joining layer 51 in the example in FIG. 21) when the piezoelectric film 35 is viewed in plan. In view of stably fixing the piezoelectric speaker 10 to the structure 80, the piezoelectric speaker 10 can be configured so that the fixing surface 17 will be disposed on a region accounting for 50% or more of the area of the piezoelectric film 35 when the piezoelectric film 35 is viewed in plan. The piezoelectric speaker 10 may be configured so that the fixing surface 17 will be disposed on a region accounting for 75% or more of the area of the piezoelectric film 35 or on the entire region of the piezoelectric film 35 when the piezoelectric film 35 is viewed in plan.

In the first structure example, adjacent layers between the piezoelectric film 35 and the fixing surface 17 are joined to each other. Here, the phrase “between the piezoelectric film 35 and the fixing surface 17” encompasses the piezoelectric film 35 and the fixing surface 17. Specifically, the first joining layer 51 and the interposed layer 40 are joined to each other, the interposed layer 40 and the second joining layer 52 are joined to each other, and the second joining layer 52 and the piezoelectric film 35 are joined to each other. This allows the piezoelectric film 35 to be stably disposed regardless of the orientation in which the piezoelectric film 35 is attached to the structure 80. This also makes it easy to attach the piezoelectric film 35 to the structure 80. Moreover, because of the contribution of the interposed layer 40, sound is emitted from the piezoelectric film 35 regardless of the orientation in which the piezoelectric film 35 is attached. Thus, in the first structure example, the combination of these allows achievement of a piezoelectric speaker of high usability. The phrase “adjacent layers are joined to each other” means that the adjacent layers are entirely or partially joined to each other. In the illustrated examples, the adjacent layers are joined to each other in a predetermined region extending along the thickness direction of the piezoelectric film 35 and passing through the piezoelectric film 35, the interposed layer 40, and the fixing surface 17 in this order.

In the first structure example, the piezoelectric film 35 and the interposed layer 40 each have a substantially uniform thickness. This is often advantageous from various points of view, for example, in view of storage of the piezoelectric speaker 10, the usability thereof, and control of sound emitted from the piezoelectric film 35. Having a “substantially uniform thickness” refers to, for example, having the smallest thickness which is 70% or more and 100% or less of the largest thickness. The smallest thickness of each of the piezoelectric film 35 and the interposed layer 40 may be 85% or more and 100% or less of the largest thickness.

Resin is a material less likely to be cracked than, for example, ceramics. In a specific example, the piezoelectric body 30 of the piezoelectric film 35 is a resin film and the interposed layer 40 is a resin layer not functioning as a piezoelectric film. This specific example is advantageous in view of cutting the piezoelectric speaker 10, for example, with scissors or by hand without cracking the piezoelectric body 30 or the interposed layer 40 (the fact that the piezoelectric speaker 10 is cuttable, for example, with scissors or by hand contributes to greater design flexibility of the ANC system 500 or the ANC system 550 and facilitates to configure the ANC system 500 or the ANC system 550). Additionally, in this specific example, the piezoelectric body 30 or the interposed layer 40 is less likely to be cracked even when the piezoelectric speaker 10 is bent. Moreover, the piezoelectric body 30 being a resin film and the interposed layer 40 being a resin layer are advantageous in view of fixing the piezoelectric speaker 10 onto a curved surface without cracking the piezoelectric body 30 or the interposed layer 40.

In the example in FIG. 21, the piezoelectric film 35, the interposed layer 40, the first joining layer 51, and the second joining layer 52 share the same outline when viewed in plan. Their outlines may be misaligned.

In the example in FIG. 21, the piezoelectric film 35, the interposed layer 40, the first joining layer 51, and the second joining layer 52 are each a rectangle having a short side and a long side when viewed in plan. The piezoelectric film 35, the interposed layer 40, the joining layer 51, and the second joining layer 52 each may be, for example, a square, a circle, or an oval.

The piezoelectric speaker 10 may also include a layer other than the layers shown in FIG. 21. The layer other than the layer layers shown in FIG. 21 is, for example, the first layer and the second layer described above.

### [Second Structure Example of Piezoelectric Speaker 10]

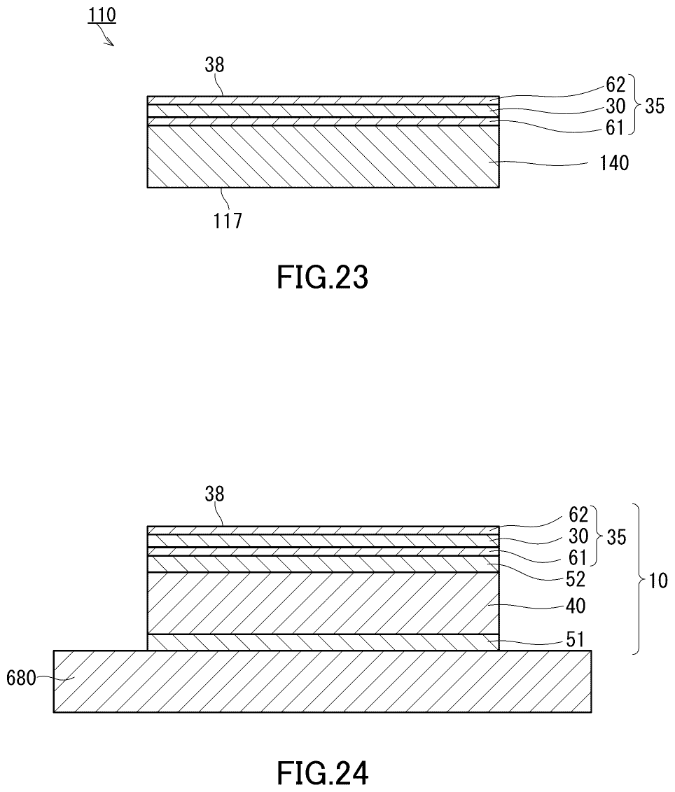

A piezoelectric speaker 10 according to a second structure example will be described below with reference to FIG. 23. The piezoelectric speaker 10 according to the second structure example is referred to as the piezoelectric speaker 110. The features that are the same as or similar to those of the first structure example may not be described below.

The piezoelectric speaker 110 includes the piezoelectric film 35, a fixing surface 117, and an interposed layer 140. The fixing surface 117 can be used to fix the piezoelectric film 35 to the structure 80.

The interposed layer 140 is disposed between the piezoelectric film 35 and the fixing surface 117. (The phrase “between the piezoelectric film 35 and the fixing surface 117” encompasses the fixing surface 117. The same applies to the first structure example.) The fixing surface 117 is formed of the surface (principal surface) of the interposed layer 140.

The interposed layer 140 is a porous body layer and/or a resin layer. The interposed layer 140 is a pressure-sensitive adhesive layer or an adhesive layer. A pressure-sensitive adhesive including an acrylic resin can be used as the interposed layer 140. Another pressure-sensitive adhesive, for example, a pressure-sensitive adhesive including rubber, silicone, or urethane may be used as the interposed layer 140. The interposed layer 140 may be a blended layer including two or more materials.

The elastic modulus of the interposed layer 140 is, for example, 10000 N/m² or more and 20000000 N/m² or less and may be 20000 N/m² or more and 100000 N/m² or less.

The thickness of interposed layer 140 in an uncompressed state is, for example, 0.1 mm or more and 30 mm or less, may be 1 mm or more and 30 mm or less, may be 1.5 mm or more and 30 mm or less, and may be 2 mm or more and 25 mm or less. The interposed layer 140 in an uncompressed state is typically thicker than the piezoelectric film 35 in an uncompressed state. The thickness of the interposed layer 140 in an uncompressed state is, for example, 3 or more times the thickness of the piezoelectric film 35 in an uncompressed state, may be 10 or more times the thickness of the piezoelectric film 35 in an uncompressed state, and may be 30 or more times the thickness of the piezoelectric film 35 in an uncompressed state.

In the second structure example, the interposed layer 140 has a holding degree of 5×10⁹ N/m³ or less. The interposed layer 140 has a holding degree of, for example, 1×10⁴ N/m³ or more. The interposed layer 140 has a holding degree of preferably 5×10⁸ N/m³ or less, more preferably 2×10⁸ N/m³ or less, and even more preferably 1×10⁵ or more and 5×10⁷ N/m³ or less. The definition of the holding degree is as described previously.

In the second structure example, the piezoelectric film 35 is integrated with the layer on the fixing surface 117 side by bringing an adhesive surface or a pressure-sensitive adhesive surface into contact with the piezoelectric film 35. Specifically, in the second structure example, the adhesive surface or the pressure-sensitive adhesive surface is a face formed of the interposed layer 140.

The piezoelectric speaker 110 can also be fixed to the structure 80 by the fixing surface 117. In such a manner, it is possible to configure the ANC system 500 or the ANC system 550, employing the piezoelectric speaker 110 according to the second structure example.

The ANC system 500 may be configured by employing the piezoelectric speaker 10 according to the first structure example and the piezoelectric speaker 10 according to the second structure example.

### Experimental Examples

The present invention will be described in detail with use of experimental examples. It should be noted that the experimental examples given below are only illustrative of the present invention and do not limit the present invention.

### (Sample E1)

The fixing surface 17 of the piezoelectric speaker 10 was stuck to a supporting member 680 fixed. The structure shown in FIG. 24 was thus produced. Specifically, a 5-mm-thick stainless steel plate (SUS plate) was used as the supporting member 680. A 0.16-mm-thick pressure-sensitive adhesive sheet (double-faced tape) including non-woven fabric both sides of which were impregnated with an acrylic pressure-sensitive adhesive was used as the first joining layer 51. A 3-mm-thick closed-cell foam obtained by foaming a mixture including ethylene propylene rubber and butyl rubber by a foaming factor of about 10 was used as the interposed layer 40. A 0.15-mm-thick pressure-sensitive adhesive sheet (double-faced tape) including non-woven fabric as a substrate having both sides to which a pressure-sensitive adhesive including a solventless acrylic resin was applied was used as the second joining layer 52. A polyvinylidene fluoride film (total thickness of 33 μm) having both sides on which copper electrodes (including nickel) were vapor-deposited was used as the piezoelectric film 35. The first joining layer 51, the interposed layer 40, the second joining layer 52, and the piezoelectric film 35 of Sample E1 each have a dimension of 37.5 mm in the lateral direction and a dimension of 37.5 mm in the longitudinal direction when viewed in plan, each have the shape of a plate which is neither divided nor frame-shaped, and have outlines overlapping when viewed in plan. (The same applies to Samples E2 to E17 and R1 described later.) The supporting member 680 has a dimension of 50 mm in the lateral direction and a dimension of 50 mm in the longitudinal direction when viewed in plan and covers the entire first joining layer 51. Sample E1 having the structure shown in FIG. 24 was produced in this manner.

### (Sample E2)

A 3-mm-thick semi-open-/semi-closed-cell foam obtained by foaming a mixture including ethylene propylene rubber by a foaming factor of about 10 was used as an interposed layer 40. This foam includes sulfur. Sample E2 that is the same as Sample E1 except for the above was produced.

### (Sample E3)

A 5-mm-thick foam formed of the same material and having the same structure as those of the interposed layer 40 of Sample E2 was used as an interposed layer 40 in Sample E3. Sample E3 that is the same as Sample E2 except for the above was produced.

### (Sample E4)

A 10-mm-thick foam formed of the same material and having the same structure as those of the interposed layer 40 of Sample E2 was used as an interposed layer 40 in Sample E4. Sample E4 that is the same as Sample E2 except for the above was produced.

### (Sample E5)

A 20-mm-thick foam formed of the same material and having the same structure as those of the interposed layer 40 of Sample E2 was used as an interposed layer 40 in Sample E5. Sample E5 that is the same as Sample E2 except for the above was produced.

### (Sample E6)

A 20-mm-thick semi-open-/semi-closed-cell foam obtained by foaming a mixture including ethylene propylene rubber by a foaming factor of about 10 was used as an interposed layer 40. This foam does not include sulfur and is more flexible than the foams used as the interposed layers 40 of Samples E2 to E5. Sample E6 that is the same as Sample E1 except for the above was produced.

### (Sample E7)

A 20-mm-thick semi-open-/semi-closed-cell foam obtained by foaming a mixture including ethylene propylene rubber by a foaming factor of about 20 was used as an interposed layer 40. Sample E7 that is the same as Sample E1 except for the above was produced.

### (Sample E8)

A porous metal body was used as an interposed layer 40. This porous metal body is made of nickel and has a pore diameter of 0.9 mm and a thickness of 2.0 mm. A pressure-sensitive adhesive layer that is the same as a first joining layer 51 as used in Sample E1 was used as a second joining layer 52. Sample E8 that is the same as Sample E1 except for the above was produced.

### (Sample E9)

A first joining layer 51 and a second joining layer 52 as used in Sample E1 were omitted, and only an interposed layer 140 was interposed between a piezoelectric film 35 and a structure 80 as used in Sample E1. A 3-mm-thick substrate-less pressure-sensitive adhesive sheet formed of an acrylic pressure-sensitive adhesive was used as the interposed layer 140. Sample E9 was produced that is the same as Sample E1 except for the above, which has the structure in which the laminate in FIG. 23 is attached to the supporting member 680 in FIG. 24.

### (Sample E10)

An interposed layer that is the same as an interposed layer 140 as used in Sample E9 was used as an interposed layer 40. Sample E10 that is the same as Sample E8 except for the above was produced.

### (Sample E11)

A 5-mm-thick urethane foam was used as an interposed layer 40. Sample E11 that is the same as Sample E8 except for the above was produced.

### (Sample E12)

A 10-mm-thick urethane foam was used as an interposed layer 40. This urethane foam has a smaller pore diameter than that of the urethane foam used as the interposed layer 40 of Sample E11. Sample E12 that is the same as Sample E8 except for the above was produced.

### (Sample E13)

A 5-mm-thick closed-cell acrylonitrile butadiene rubber foam was used as an interposed layer 40. Sample E13 that is the same as Sample E8 except for the above was produced.

### (Sample E14)

A 5-mm-thick closed-cell ethylene propylene rubber foam was used as an interposed layer 40. Sample E14 that is the same as Sample E8 except for the above was produced.

### (Sample E15)

A 5-mm-thick closed-cell foam in which natural rubber and styrene-butadiene rubber are blended was used as an interposed layer 40. Sample E15 that is the same as Sample E8 except for the above was produced.

### (Sample E16)

A 5-mm-thick closed-cell silicone foam was used as an interposed layer 40. Sample E16 that is the same as Sample E8 except for the above was produced.

### (Sample E17)

A 10-mm-thick foam formed of the same materials and having the same structure as those of the interposed layer 40 of Sample E1 was used as an interposed layer 40. A pressure-sensitive adhesive sheet that is the same as that in Sample E1 was used as a second joining layer 52. A 35-μm-thick resin sheet including a corn-derived polylactic acid as a main raw material was used as a piezoelectric body 30 of a piezoelectric film 35. A first electrode 61 and a second electrode 62 of the piezoelectric film 35 are each formed of a 0.1-μm-thick aluminum film and were formed by vapor deposition. The piezoelectric film 35 having a total thickness of 35.2 μm was thus obtained. Sample E17 that is the same as Sample E1 except for the above was produced.

### (Sample R1)

A piezoelectric film 35 as used in Sample E1 was employed as Sample R1. In Sample R1, the sample was placed on a board parallel to the ground without being adhered to the board.

The methods for evaluation of Samples E1 to E17 and R1 are as follows.

### <Thickness of Interposed Layer (Uncompressed State)>

The thickness of each of the interposed layers was measured by using a thickness gauge.

### <Elastic Modulus of Interposed Layer>

A small piece was cut out from each of the interposed layers. The small piece was subjected to a compression test at ordinary temperature by using a tensile tester (“RSA-G2” manufactured by TA Instruments). A stress-strain curve was thus obtained. The elastic modulus was calculated from the initial slope of the stress-strain curve.

### <Pore Diameter of Interposed Layer>

An enlarged image of each of the interposed layers was obtained by using a microscope. The average of the pore diameters of the interposed layer was determined by image analysis of the enlarged image. The average thus determined was employed as the pore diameter of the interposed layer.

### <Porosity of Interposed Layer>

A small rectangular cuboid piece was cut out from each of the interposed layers. The apparent density was determined from the volume and the mass of the small rectangular cuboid piece. The apparent density was divided by the density of a matrix (solid, or non-hollow, body) forming the interposed layer. The filling area ratio was thus calculated. Then, the filling area ratio was subtracted from 1. The porosity was thus obtained.

### <Surface Filling Area Ratio of Interposed Layer>

For Samples E2 to E16, the filling area ratio calculated as above is employed as the surface filling area ratio. For Samples E1 and E17, the surface filling area ratio is 100% because the interposed layers have a surface skin layer.

### <Frequency Characteristics of Sample in Terms of Sound Pressure Level>

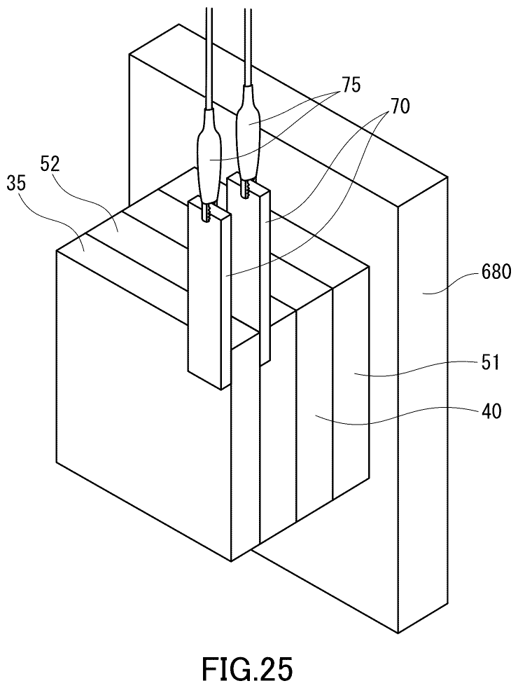

A measurement structure for Samples E1 to E8 and E10 to E17 is shown in FIG. 25. An electrically conductive copper foil tape 70 (CU-35C manufactured by 3M) having a dimension of 70 μm in the thickness direction, a dimension of 70 mm in the lateral direction and a dimension of 5 mm in the longitudinal direction was attached to a corner of each side of the piezoelectric film 35. An alligator clip 75 with a cover was attached to each of the electrically conductive copper foil tapes 70. The electrically conductive copper foil tapes 70 and the alligator clips 75 with covers compose a portion of an electrical pathway used for application of AC voltage to the piezoelectric film 35.

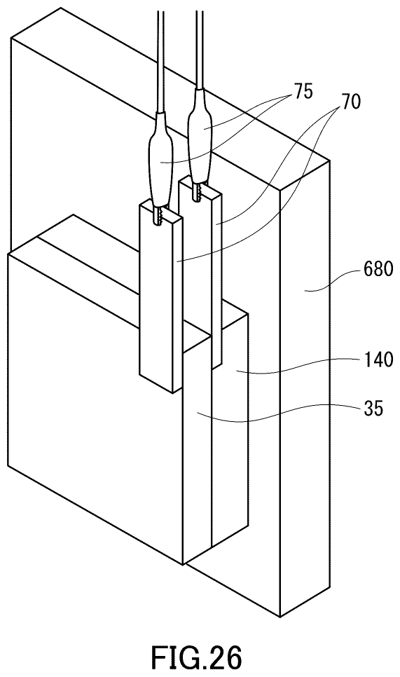

A measurement structure for Sample E9 is shown in FIG. 26. The structure in FIG. 26 lacks the first joining layer 51 and the second joining layer 52 in FIG. 25. The structure in FIG. 26 includes the interposed layer 140.

A measurement structure for Sample R1 is based on the structures in FIG. 25 and FIG. 26. Specifically, as in FIG. 25 and FIG. 26, an electrically conductive copper foil tape 70 was attached to a corner of each side of the piezoelectric film 35, and an alligator clip 75 with a cover was attached to each of the tapes 70. The resulting assembly was placed on a board parallel to the ground without being adhered to the board.

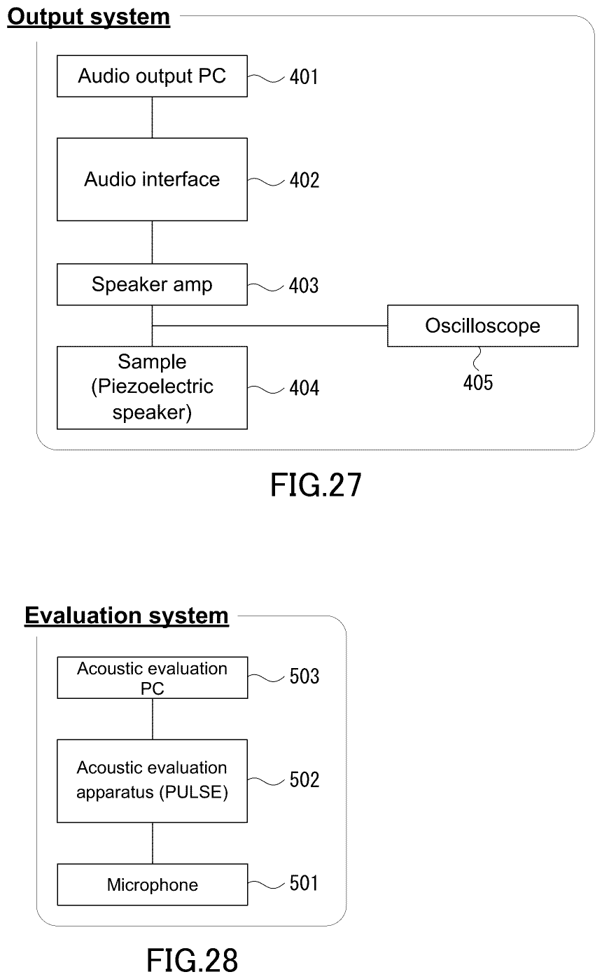

Block diagrams for measurement of the acoustic characteristics of the samples are shown in FIG. 27 and FIG. 28. Specifically, an output system is shown in FIG. 27, and an evaluation system is shown in FIG. 28.

In the output system shown in FIG. 27, an audio output personal computer (a personal computer is hereinafter also referred to simply as a PC) 401, an audio interface 402, a speaker amp 403, a sample 404 (any of the piezoelectric speakers of Samples E1 to E17 and R1) were connected in this order. The speaker amp 403 was also connected to an oscilloscope 405 so that output from the speaker amp 403 to the sample 404 could be monitored.

WaveGene was installed in the audio output PC 401. WaveGene is free software for generation of a test audio signal. QUAD-CAPTURE manufactured by Roland Corporation was used as the audio interface 402. The sampling frequency of the audio interface 402 was set to 192 kHz. A-924 manufactured by Onkyo Corporation was used as the speaker amp 403. DP02024 manufactured by Tektronix, Inc. was used as the oscilloscope 405.

In the evaluation system shown in FIG. 28, a microphone 501, an acoustic evaluation apparatus (PULSE) 502, and an acoustic evaluation PC 503 were connected in this order.

Type 4939-C-002 manufactured by Bruel & Kjaer Sound & Vibration Measurement A/S was used as the microphone 501. The microphone 501 was disposed 1 m away from the sample 404. Type 3052-A-030 manufactured by Bruel & Kjaer Sound & Vibration Measurement A/S was used as the acoustic evaluation apparatus 502.

The output system and the evaluation system were configured in the above manners. AC voltage was applied from the audio output PC 401 to the sample 404 via the audio interface 402 and the speaker amp 403. Specifically, a test audio signal whose frequency sweeps from 100 Hz to 100 kHz in 20 seconds was generated by using the audio output PC 401. During this, voltage output from the speaker amp 403 was monitored by using the oscilloscope 405. Additionally, sound generated from the sample 404 was evaluated by using the evaluation system. A test for measurement of the sound pressure frequency characteristics was performed in this manner.

The details of the output system and evaluation system settings are as follows.

### [Output System Settings]

Frequency range: 100 Hz to 100 kHz
Sweep time: 20 seconds
Effective voltage: 10 V
Output waveform: sine curve

### [Evaluation System Settings]

Measurement time: 22 seconds
Peak hold
Measurement range: 4 Hz to 102.4 kHz
Number of lines: 6400
   <Determination of Frequency at which Emission of Sound Starts>

The lower end of a frequency domain (exclusive of a sharp peak portion in which a frequency range where the sound pressure level is maintained higher than that of background noise by +3 dB or more falls within ±10% of a peak frequency (a frequency at which the sound pressure level reaches a peak)) where the sound pressure level is higher than that of background noise by 3 dB or more was determined as a frequency at which emission of sound starts.

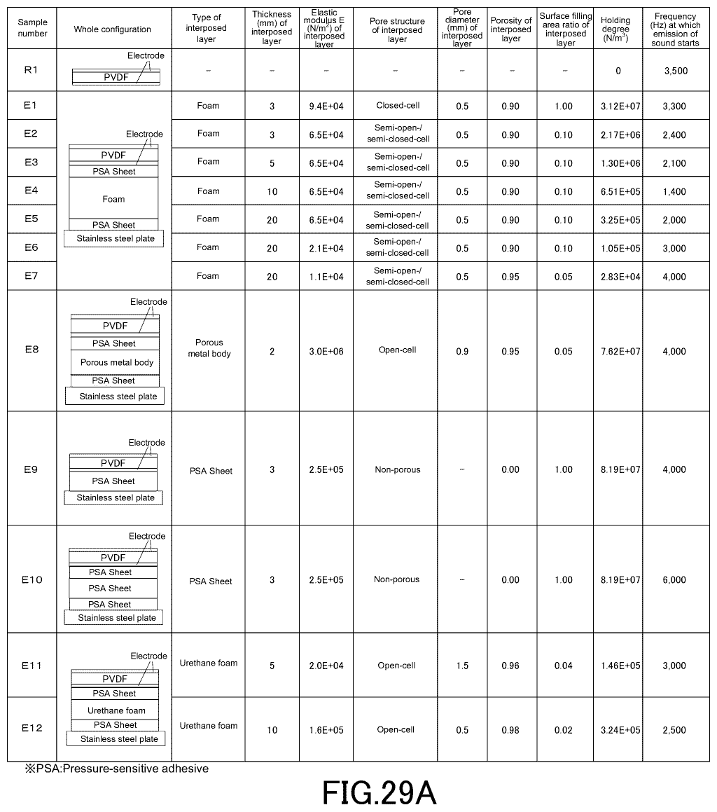

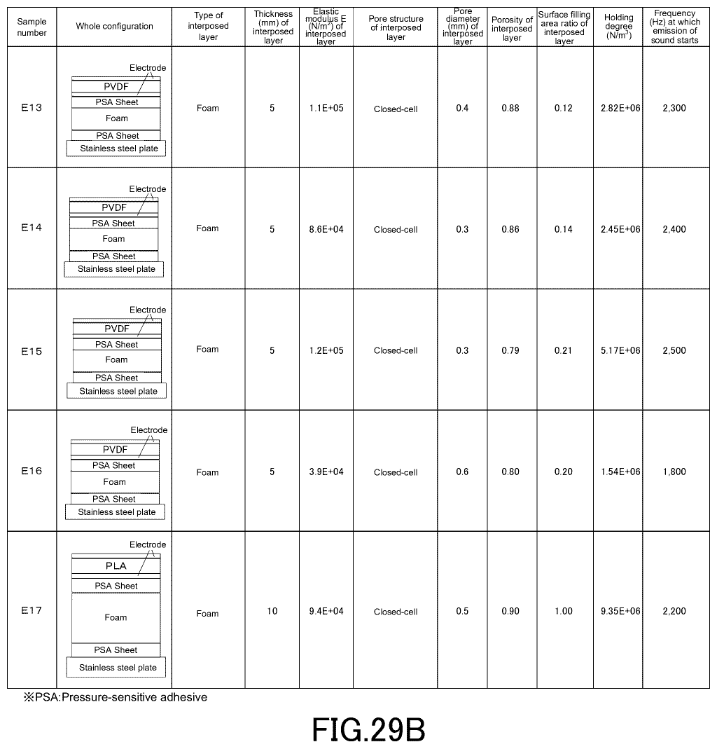

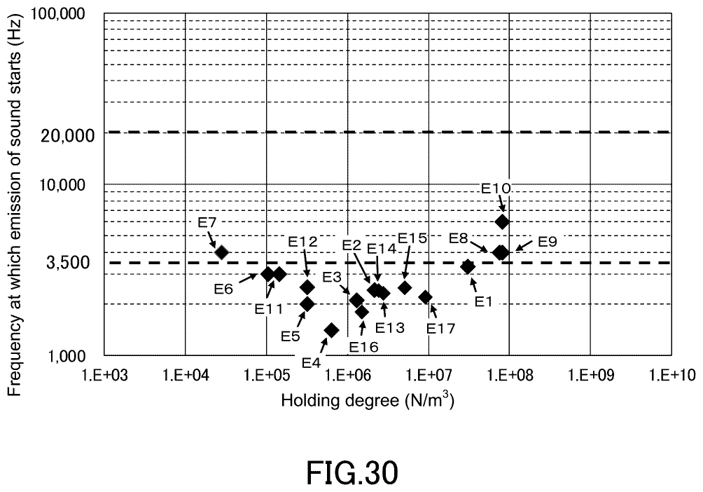

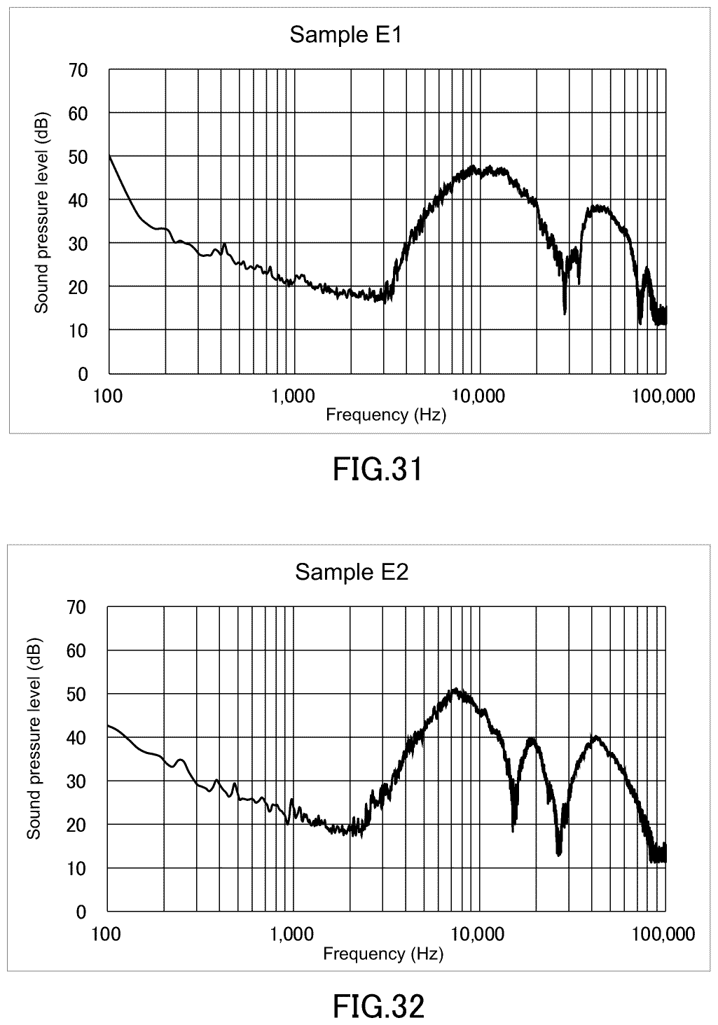

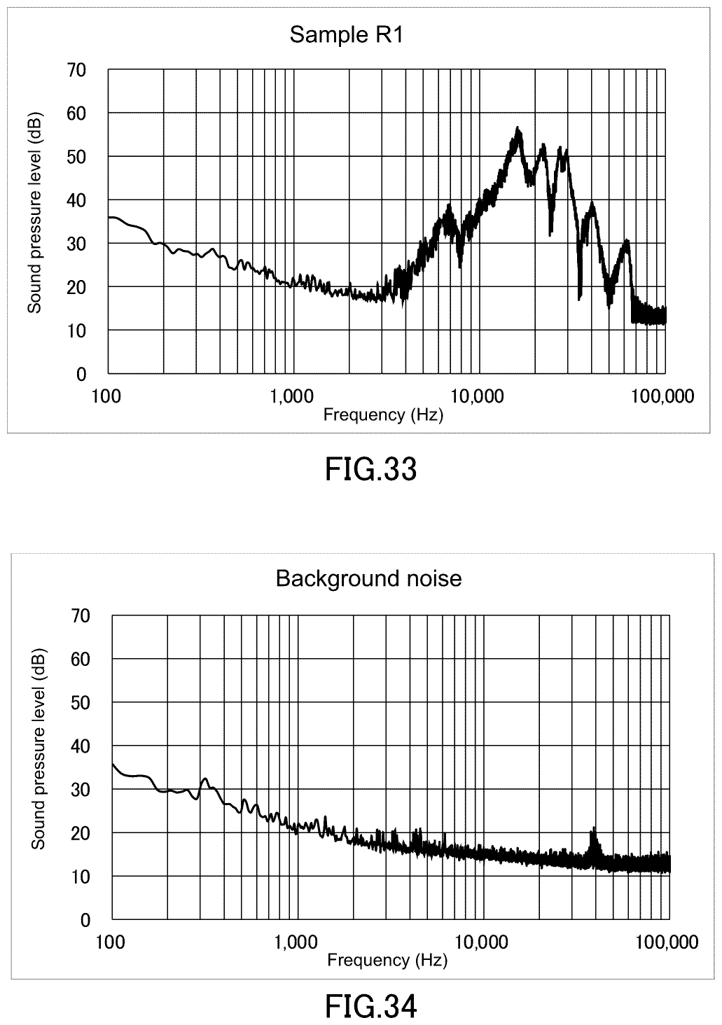

FIG. 29A and FIG. 29B show the evaluation results for Samples E1 to E17 and R1. FIG. 30 shows the relationship between the holding degree and the frequency at which emission of sound starts for Samples E1 to E17. In FIG. 30, reference numerals E1 to E17 respectively correspond to Samples E1 to E17. FIG. 31, FIG. 32, and FIG. 33 show the frequency characteristics of Samples E1, E2, and R1 in terms of sound pressure level. FIG. 34 shows the frequency characteristics of background noise in terms of sound pressure level.

### [Evaluation of Reference ANC System]

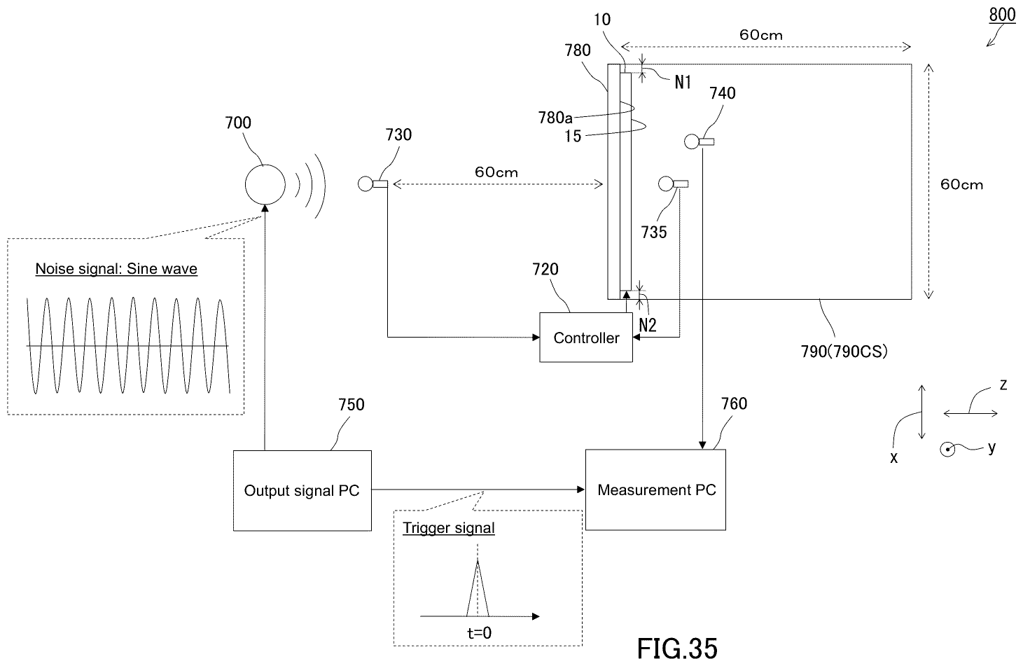

A reference ANC evaluation system 800 shown in FIG. 35 was configured by employing a piezoelectric speaker 10 that is the same as the piezoelectric speaker 10 of Sample E1 except that the plan view dimensions of the piezoelectric speaker 10 were set to 50 cm in the lateral direction and 35 cm in the longitudinal direction. The number of the piezoelectric speakers 10 used in the reference ANC evaluation system 800 is one.

The piezoelectric speaker 10 was attached to a surface 780a of a partition 780. A noise source 700, a reference microphone 730, the partition 780, the piezoelectric speaker 10, and an error microphone 735 were disposed so that the noise source 700, the reference microphone 730, the center of the partition 780, the center of the piezoelectric speaker 10, and the error microphone 735 would be arranged in this order on a straight line. A control region 790 was set on the piezoelectric speaker 10 side when viewed from the partition 780. A measurement microphone 740 was disposed in the control region 790.

In FIG. 35, the x direction is the lateral direction of the control region 790, the y direction is the longitudinal direction of the control region 790, and the z direction is the depth direction of the control region 790. The x direction, the y direction, and the z direction are directions orthogonal to each other.

The z direction is also the direction along which the noise source 700, the reference microphone 730, the center of the partition 780, the center of the piezoelectric speaker 10, and the error microphone 735 are arranged. The z direction is further the direction in which the radiation surface 15 of the piezoelectric speaker 10 faces.

The noise source 700 used was Eclipse TD508MK3 manufactured by Fujitsu Ten Limited. The partition 780 used was Desk side screen R manufactured by Mihashi kougei, Inc. The reference microphone 730 used was ECM-PC60 manufactured by Sony Corporation. The error microphone 735 used was ECM-PC60 manufactured by Sony Corporation. The measurement microphone 740 used was ECM-PC60 manufactured by Sony Corporation.

The distance between the noise source 700 and the reference microphone 730 is 5 cm. The distance between the reference microphone 730 and the partition 780 is 60 cm. The distance between the radiation surface 15 of the piezoelectric speaker 10 and the error microphone 735 is 17.5 cm. These distances are dimensions in the z direction.

The partition 780 has a rectangular plate in plan view. This plate has a dimension of 60 cm in the lateral direction, a dimension of 45 cm in the longitudinal direction, and a dimension of 0.5 cm in the thickness direction. The control region 790 has a dimension of 60 cm in the lateral direction, a dimension of 45 cm in the longitudinal direction, and a dimension of 60 cm in the depth direction. These lateral directions are the x direction. These longitudinal directions are the y direction. These thickness direction and depth directions are the z direction. The partition 780 has a leg not shown in the figures, as well as the plate. The leg supports the plate in an upright state. The plate has the surface 780a.

Further, the lateral direction of the piezoelectric speaker 10, namely, the direction along the 50-cm dimension of the piezoelectric speaker 10 is the x direction. The longitudinal direction of the piezoelectric speaker 10, namely, the direction along the 35-cm dimension of the piezoelectric speaker 10 is the y direction. The thickness direction of the piezoelectric speaker 10 is the z direction.

The left margin N1 is 5 cm and the right margin N2 is 5 cm. The left margin N1 corresponds to the first left margin M1 described in the first embodiment and the second embodiment. The right margin N2 corresponds to the first right margin M2 described in the first embodiment and the second embodiment. The margins N1 and N2 are dimensions in the x direction.

In the reference ANC evaluation system 800, an output signal personal computer (PC) 750, a measurement PC 760, and a controller 720 were used. The output signal PC 750 was connected to the noise source 700 and the measurement PC 760.

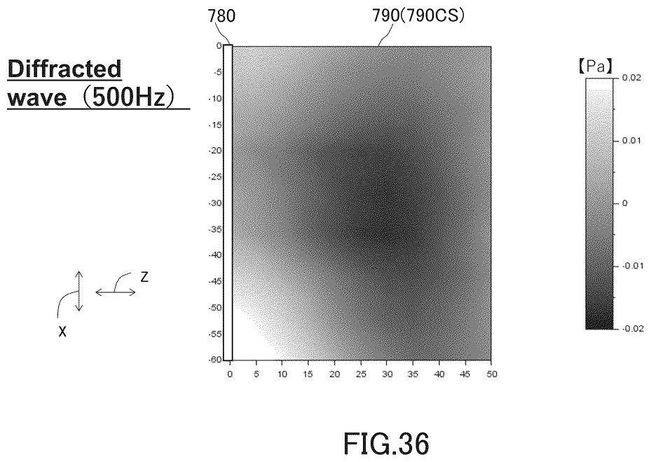

The output signal PC 750 transmits a noise signal to the noise source 700. The output signal PC 750 thus controls the noise source 700 to radiate a sine wave. Also, the output signal PC 750 transmits a trigger signal to the measurement PC 760. The trigger signal enables to give a common reference time to each measurement data piece. Specifically, sound pressure data pieces with the uniform time axis can be obtained for 176 measurement points described later. This enables mapping of sound pressure distributions shown in FIG. 36 to FIG. 51 described later.

The reference microphone 730 detects sound from the noise source 700. An output signal of the reference microphone 730 is transmitted to the controller 720.

The error microphone 735 detects sound in the control region 790. An output signal of the error microphone 735 is transmitted to the controller 720.

On the basis of the output signals of the reference microphone 730 and the error microphone 735, the controller 720 transmits a control signal to the piezoelectric speaker 10. The controller 720 thus controls a sound wave to be radiated from the piezoelectric speaker 10.

The measurement microphone 740 detects sound at a position where the measurement microphone 740 is disposed. An output signal of the measurement microphone 740 is transmitted to the measurement PC 760.

The measurement PC 760 receives the trigger signal from the output signal PC 750 and the output signal of the measurement microphone 740.

The control region 790 has a measurement cross section 790CS extending in the x direction and the z direction. In the reference ANC evaluation system 800, 176 measurement points are provided on the measurement cross section 790CS. Specifically, the measurement cross section 790CS is divided equally into 11 pieces in the x direction and is divided equally into 16 pieces in the z direction. The number of measurement points, 176, is the product of 11, which is the number of divisions in the x direction, and 16, which is the number of divisions in the z direction. The position of the measurement cross section 790CS in the y direction is the same as the center position of the radiation surface 15 in the y direction. The error microphone 735 is provided on the measurement cross section 790CS.

In the reference ANC evaluation system 800, the measurement microphone 740 is successively moved to the 176 measurement points. Thus, in cooperation with the measurement PC 760, the measurement microphone 740 measures the sound pressures at the 176 measurement points. Specifically, the measurement PC 760 maps the distribution of the sound pressures at the 176 measurement points. This mapping visualizes the sound field of the measurement cross section 790CS.

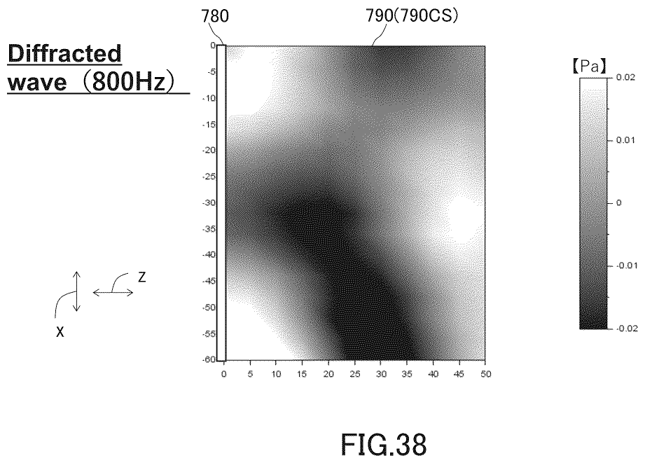

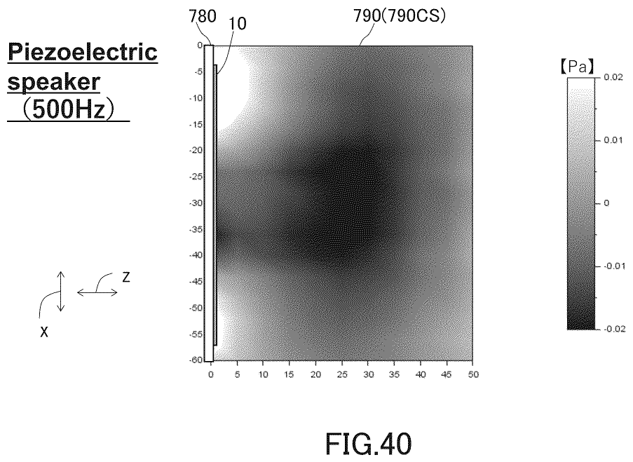

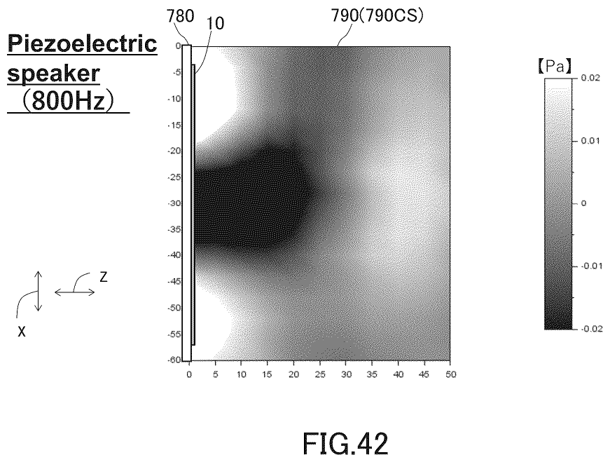

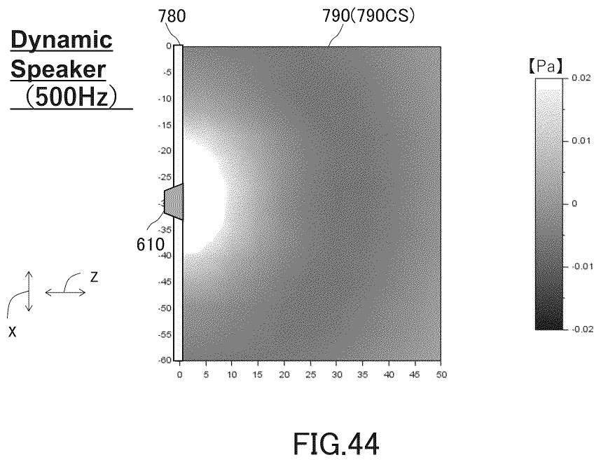

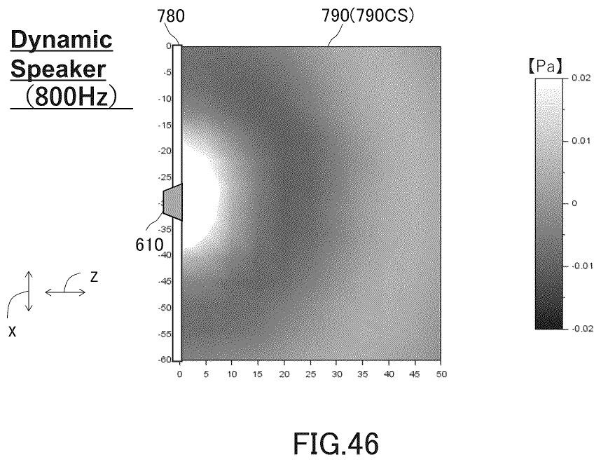

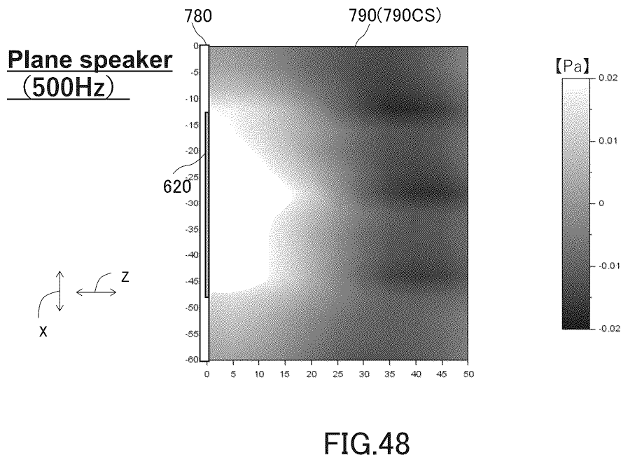

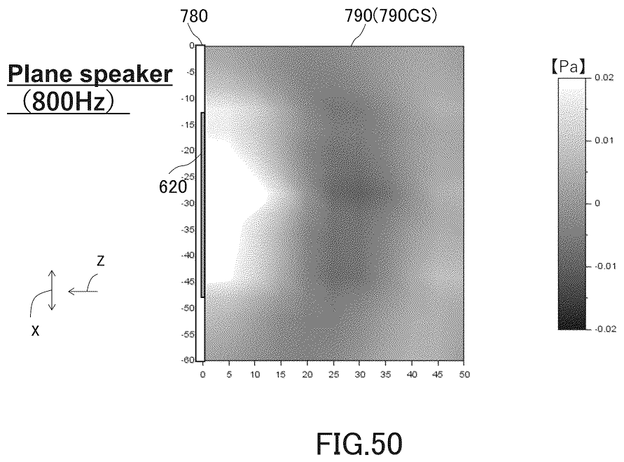

A description based on actual measurement data will be given below with reference to FIG. 36 to FIG. 53C. FIG. 36 to FIG. 53C omit a portion of the control region 790 shown in FIG. 35 that is distant from the partition 780. In FIG. 36, FIG. 38, FIG. 40, FIG. 42, FIG. 44, FIG. 46, FIG. 48, and FIG. 50, the numerical values on the color bars indicate sound pressure levels in units of pascal (Pa). While the numerical value being positive means that the sound pressure is positive, the numerical value being negative means that the sound pressure is negative.

### Reference Example 1: Measurement of Diffracted Sound

In a state where the piezoelectric speaker 10 radiated no sound and the noise source 700 radiated a sine wave, sound pressures at the 176 measurement points on the measurement cross section 790CS were measured for mapping. FIG. 36 to FIG. 39 show the sound pressure distributions obtained by the mapping. In FIG. 36 to FIG. 39, the piezoelectric speaker 10 is not shown so as to facilitate an intuitive understanding that diffracted sound is measured. However, the measurement of Reference Example 1 was performed while the piezoelectric speaker 10 was attached to the partition 780, in the same manner as that in Reference Example 2 described later.

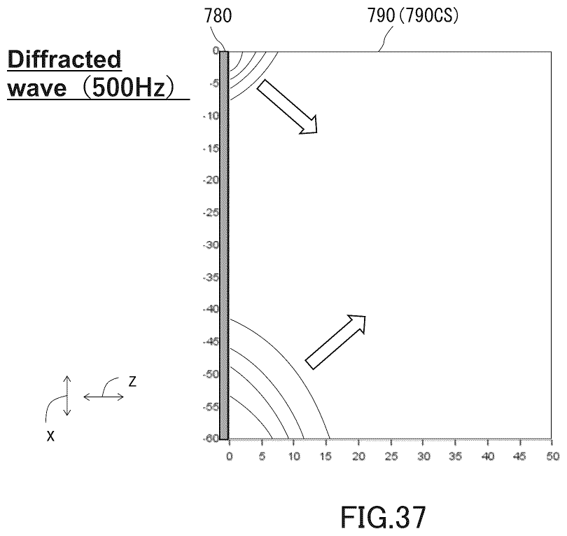

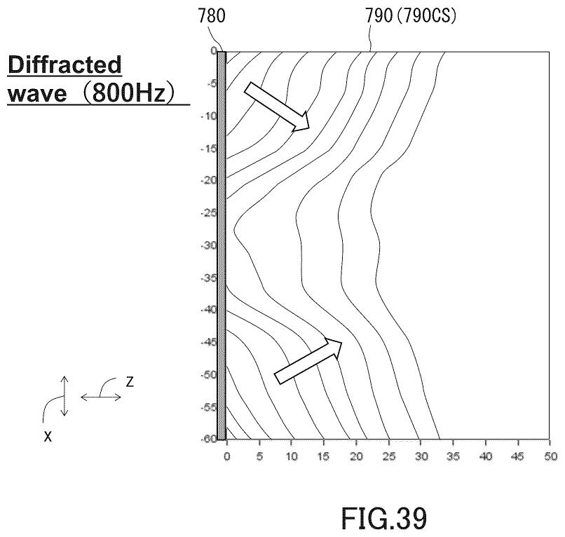

Specifically, FIG. 36 shows the sound pressure distribution derived from the noise source 700 relating to a certain time for the case where the frequency of the sine wave radiated from the noise source 700 is 500 Hz. A series of lines in FIG. 37 represent propagation over time of a certain wave front generated by the noise source 700 radiating the sine wave of 500 Hz. FIG. 38 shows the sound pressure distribution derived from the noise source 700 relating to a certain time for the case where the frequency of the sine wave radiated from the noise source 700 is 800 Hz. A series of lines in FIG. 39 represent propagation over time of a certain wave front generated by the noise source 700 radiating the sine wave of 800 Hz.

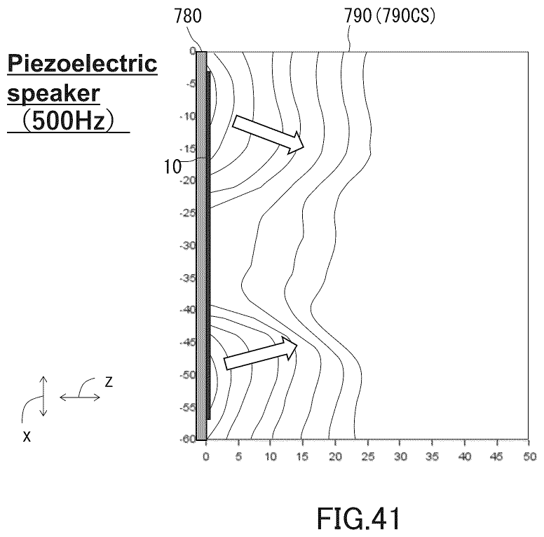

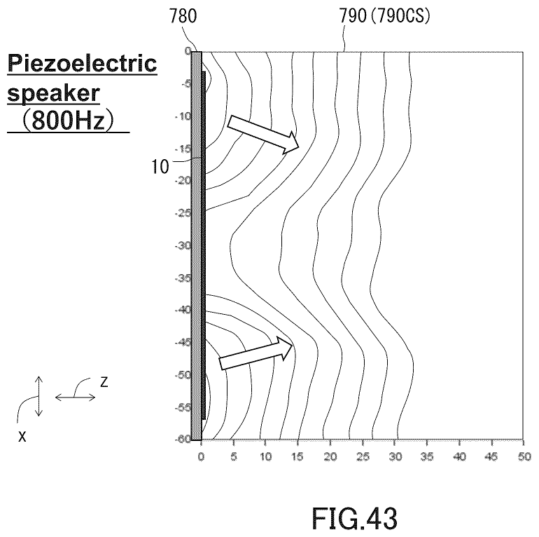

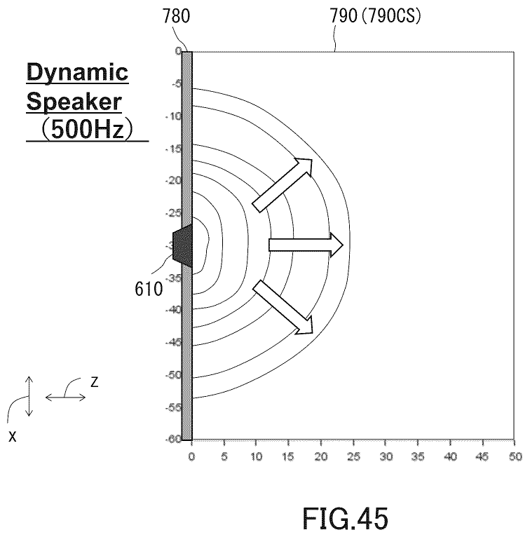

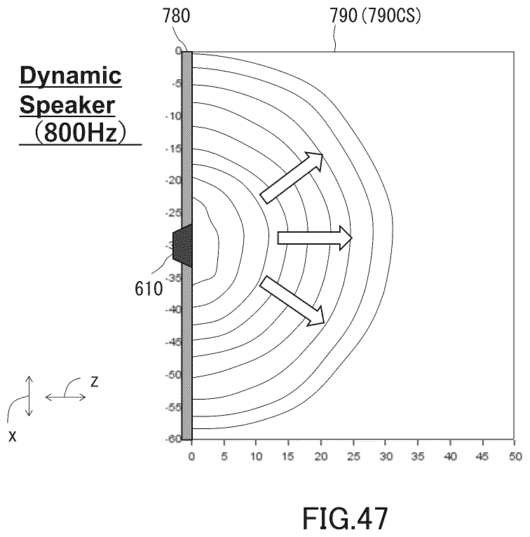

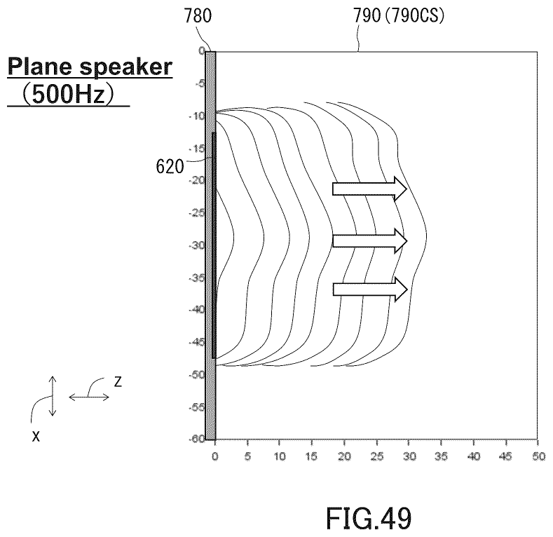

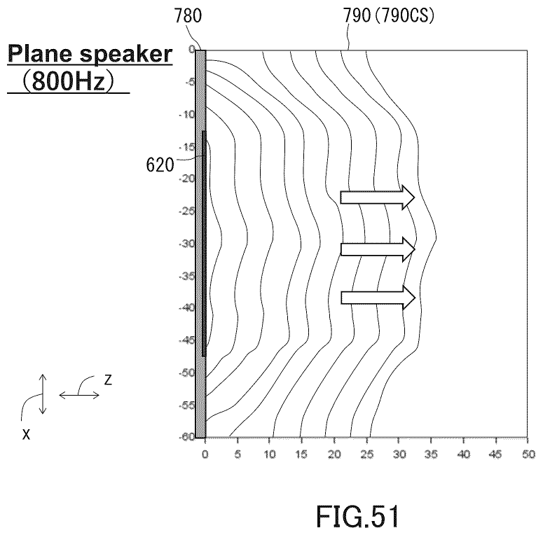

In FIG. 37, the lines in the series of lines represent respective positions of the “certain wave front” as of different times. In general, in FIG. 37, one of two adjacent lines that is further away from the partition 780 than the other is represents the “certain wave front” as of a more advanced time. Block arrows in FIG. 37 represent the propagation directions of the wave fronts. The same descriptions of the series of lines and the block arrows apply to FIG. 39, FIG. 41, FIG. 43, FIG. 45, FIG. 47, FIG. 49, and FIG. 51.

FIG. 37 was prepared by the following procedure. First, a plurality of sound pressure distribution maps based on actual measurements relating to different times, similar to that in FIG. 36, were obtained. Next, in each of the plurality of sound pressure distribution maps, a line corresponding to the certain wave front was manually drawn. Then, the plurality of sound pressure distribution maps on which the lines have been drawn were overlapped each other. Thus, the diagram shown in FIG. 37 was obtained in which the series of lines representing propagation of the wave fronts were drawn. The same description of the drawing procedure applies to FIG. 39, FIG. 41, FIG. 43, FIG. 45, FIG. 47, FIG. 49, and FIG. 51.

FIG. 36 to FIG. 39 show that diffraction occurs at end portions of the partition 780 that face each other. FIG. 36 to FIG. 39 also show that wave fronts generated by diffraction at these end portions propagate so as to travel around to the rear of the partition 780. Specifically, FIG. 36 to FIG. 39 show that the wave fronts generated by diffraction at these end portions propagate so as to approach an axis passing through the center of the partition 780 and extending in the z direction. Wave front propagation shown in FIG. 36 to FIG. 39 occurs in a manner similar to that in FIG. 8A to FIG. 8C and FIG. 9A to FIG. 9C.

### Reference Example 2: Measurement of Sound Output from Piezoelectric Speaker 10

In a state where the noise source 700 radiated a sine wave as in Reference Example 1, the controller 720 was used to vibrate the piezoelectric speaker 10 thereby to control the piezoelectric speaker 10 to generate a sound wave for sound reduction. At this time, a control signal that had been transmitted to piezoelectric speaker 10 was stored in the controller 720. Then, in a state where the noise source 700 radiated no sound, the controller 720 was controlled to transmit the stored control signal to the piezoelectric speaker 10. In this manner, vibration of the piezoelectric speaker 10 was reproduced in the state where the noise source 700 radiated no sound, and sound pressures at the 176 measurement points on the measurement cross section 790CS were measured for mapping. FIG. 40 to FIG. 43 show the sound pressure distributions obtained by the mapping.

Specifically, FIG. 40 shows the sound pressure distribution derived from the piezoelectric speaker 10 relating to a certain time for the case where the frequency of the sine wave radiated from the noise source 700 is 500 Hz. A series of lines in FIG. 41 represent propagation over time of a certain wave front generated by the piezoelectric speaker 10 for the case where the frequency of the sine wave radiated from the noise source 700 is 500 Hz. FIG. 42 shows the sound pressure distribution derived from the piezoelectric speaker 10 relating to a certain time for the case where the frequency of the sine wave radiated from the noise source 700 is 800 Hz. A series of lines in FIG. 43 represent propagation over time of a certain wave front generated by the piezoelectric speaker 10 for the case where the frequency of the sine wave radiated from the noise source 700 is 800 Hz.

FIG. 40 to FIG. 43 show that the wave front propagates, from two outer regions of the radiation surface 15 of the piezoelectric speaker 10 with a center region sandwiched therebetween so as to approach an axis passing through the center region and extending in the z direction. Wave front propagation shown in FIG. 40 to FIG. 43 occurs in a manner similar to that in FIG. 8D to FIG. 8F and FIG. 9D to FIG. 9F. Specifically, a wave front of a diffracted wave generated by diffraction of noise from the noise source 700 at the partition 780 and the wave front derived from the piezoelectric speaker 10 have a common point that both wave fronts propagate while approaching the above axis. The first piezoelectric speaker 10A and the second piezoelectric speaker 10B are expected to form similar wave fronts as well in Examples 1 to 7 described later.

Further, from FIG. 36 to FIG. 39, it is understood that diffraction at the partition 780 causes appearance of a period during which the sound wave in the first region 15a and the sound wave in the second region 15b have the same phase in terms of whether positive or negative, the sound wave in the first region 15a and the sound wave in the third region 15c have the phases opposite to each other in terms of whether positive or negative, and the sound wave in the second region 15b and the sound wave in the third region 15c have the phases opposite to each other in terms of whether positive or negative (see FIG. 1 to FIG. 3C and related descriptions for the regions 15a, 15b and 15c). From FIG. 40 to FIG. 43, it is understood that the piezoelectric speaker 10 causes appearance of a period during which the first sound wave and the second sound wave have the same phase in terms of whether positive or negative, the first sound wave and the third sound wave have the phases opposite to each other in terms of whether positive or negative, and the second sound wave and the third sound wave have the phases opposite to each other in terms of whether positive or negative (see the description given with reference to FIG. 1 to FIG. 3C for the first sound wave, the second sound wave and the third sound wave). The phase distribution in the first region 15a, the second region 15b, and the third region 15c is also common to noise derived from the noise source 700 and sound derived from the piezoelectric speaker 10. The first piezoelectric speaker 10A is expected to form similar phase distributions as well in Examples 1 to 7 described later. Further, the second piezoelectric speaker 10B of Examples 6 and 7 described later is also expected to form similar phase distributions in the regions 15d, 15e, and 15f.

### Reference Example 3: Measurement of Sound Output from Dynamic Speaker 610

The piezoelectric speaker 10 of Reference Example 2 was replaced with the dynamic speaker 610. This dynamic speaker 610 is Fostex P650K manufactured by Foster Electric Company, Limited. In the same manner as that in Reference Example 2 except for the replacement above, sound pressures derived from the dynamic speaker 610 at the 176 measurement points on the measurement cross section 790CS were measured for mapping. FIG. 44 to FIG. 47 show the sound pressure distributions obtained by the mapping. The dynamic speaker 610 is embedded in the partition 780.

Specifically, FIG. 44 shows the sound pressure distribution derived from the dynamic speaker 610 relating to a certain time for the case where the frequency of the sine wave radiated from the noise source 700 is 500 Hz. A series of lines in FIG. 45 represent propagation over time of a certain wave front generated by the dynamic speaker 610 for the case where the frequency of the sine wave radiated from the noise source 700 is 500 Hz. FIG. 46 shows the sound pressure distribution derived from the dynamic speaker 610 relating to a certain time for the case where the frequency of the sine wave radiated from the noise source 700 is 800 Hz. A series of lines in FIG. 47 represent propagation over time of a certain wave front generated by the dynamic speaker 610 for the case where the frequency of the sine wave radiated from the noise source 700 is 800 Hz.

FIG. 44 to FIG. 47 show that a substantially hemispherical wave is radiated from the radiation surface of the dynamic speaker 610, and the substantially hemispherical wave has also a substantially hemispherical wave front. Wave front propagation shown in FIG. 44 to FIG. 47 occurs in a manner similar to that in FIG. 10.

### Reference Example 4: Measurement of Sound Output from Plane Speaker 620

The piezoelectric speaker 10 of Reference Example 2 was replaced with the plane speaker 620. This plane speaker 620 is FPS2030M3P1R manufactured by FPS Inc. In the same manner as that in Reference Example 2 except for the replacement above, sound pressures derived from the plane speaker 620 at the 176 measurement points on the measurement cross section 790CS were measured for mapping. FIG. 48 to FIG. 51 show the sound pressure distributions obtained by the mapping.

Specifically, FIG. 48 shows the sound pressure distribution derived from the plane speaker 620 relating to a certain time for the case where the frequency of the sine wave radiated from the noise source 700 is 500 Hz. A series of lines in FIG. 49 represent propagation over time of a certain wave front generated by the plane speaker 620 for the case where the frequency of the sine wave radiated from the noise source 700 is 500 Hz. FIG. 50 shows the sound pressure distribution derived from the plane speaker 620 relating to a certain time for the case where the frequency of the sine wave radiated from the noise source 700 is 800 Hz. A series of lines in FIG. 51 represent propagation over time of a certain wave front generated by the plane speaker 620 for the case where the frequency of the sine wave radiated from the noise source 700 is 800 Hz.

FIG. 48 to FIG. 51 show that a substantially plane wave is radiated from the radiation surface of the plane speaker 620, and the substantially plane wave also has a substantially plane wave front. Wave front propagation shown in FIG. 48 to FIG. 51 occurs in a manner similar to that in FIG. 11.

### (Sound Reducing Effect)

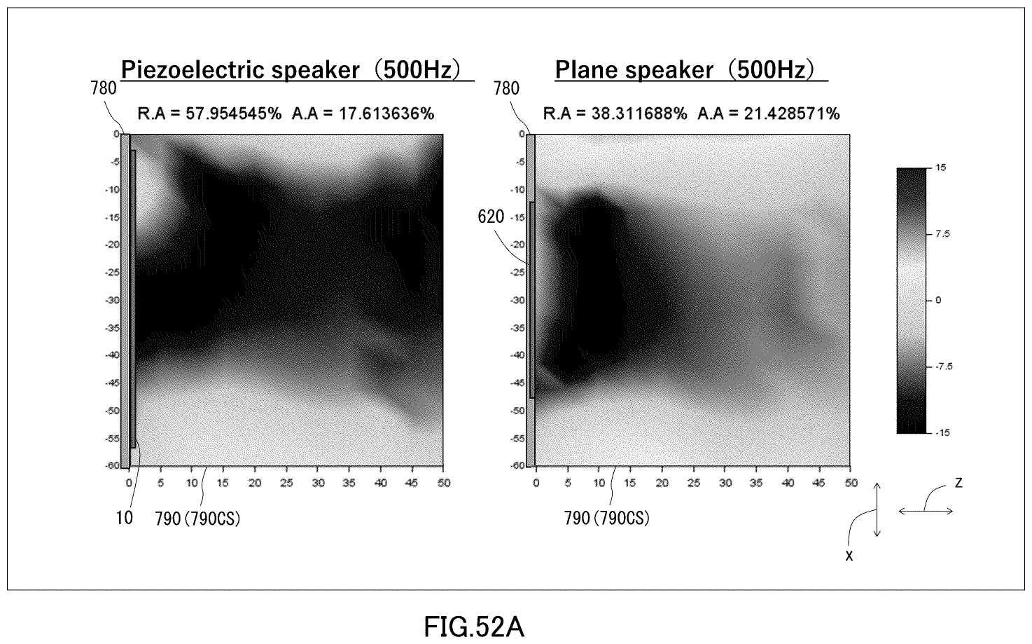

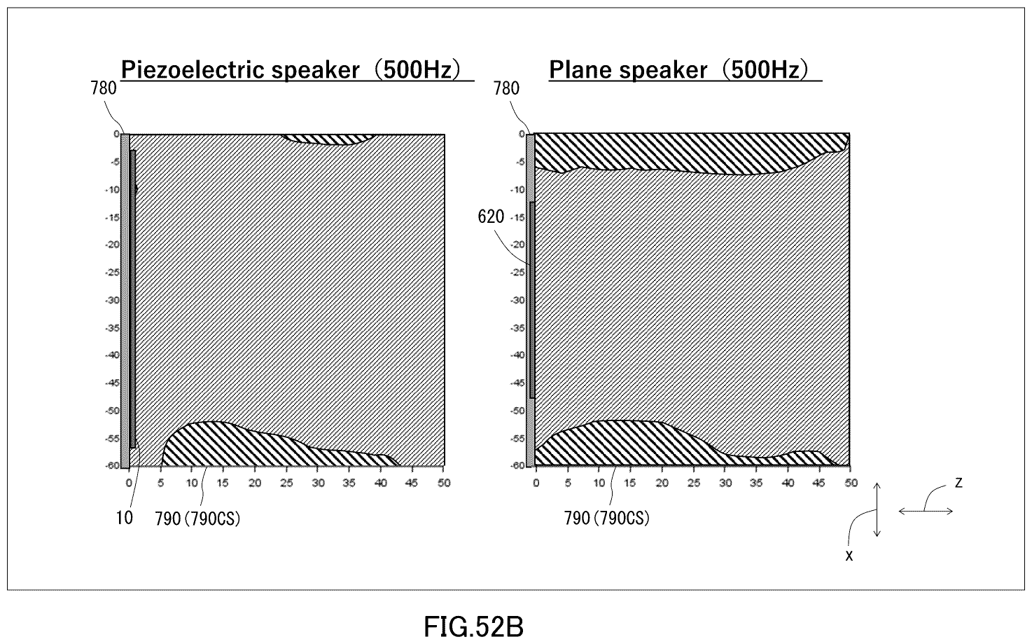

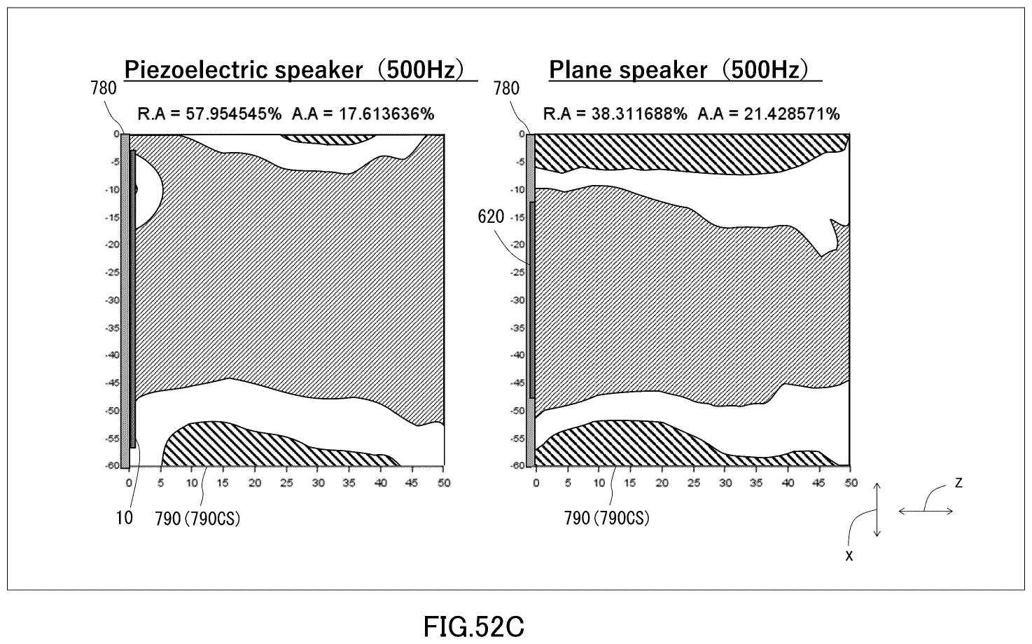

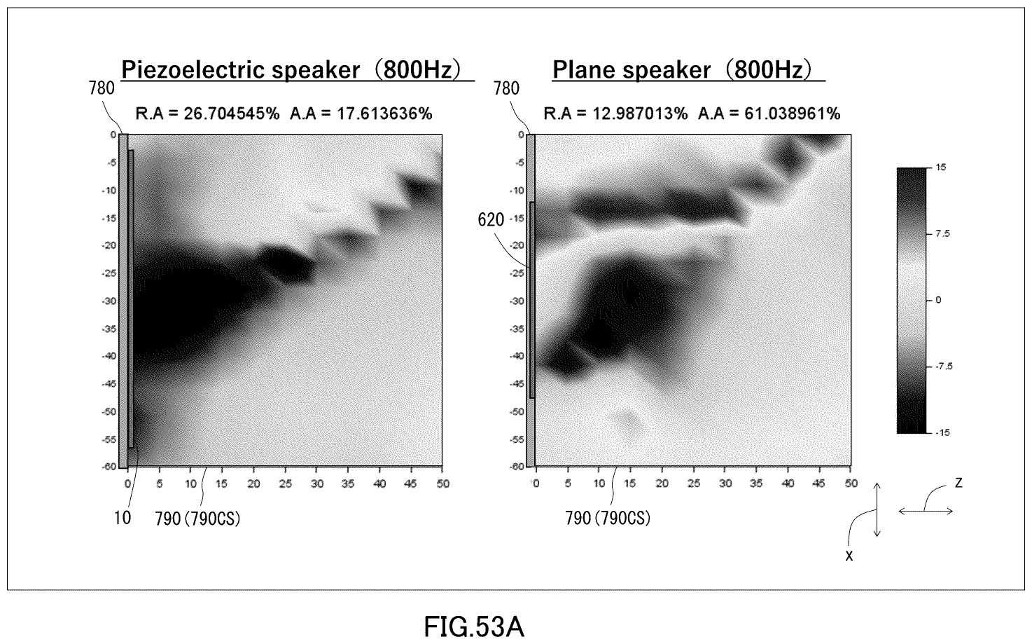

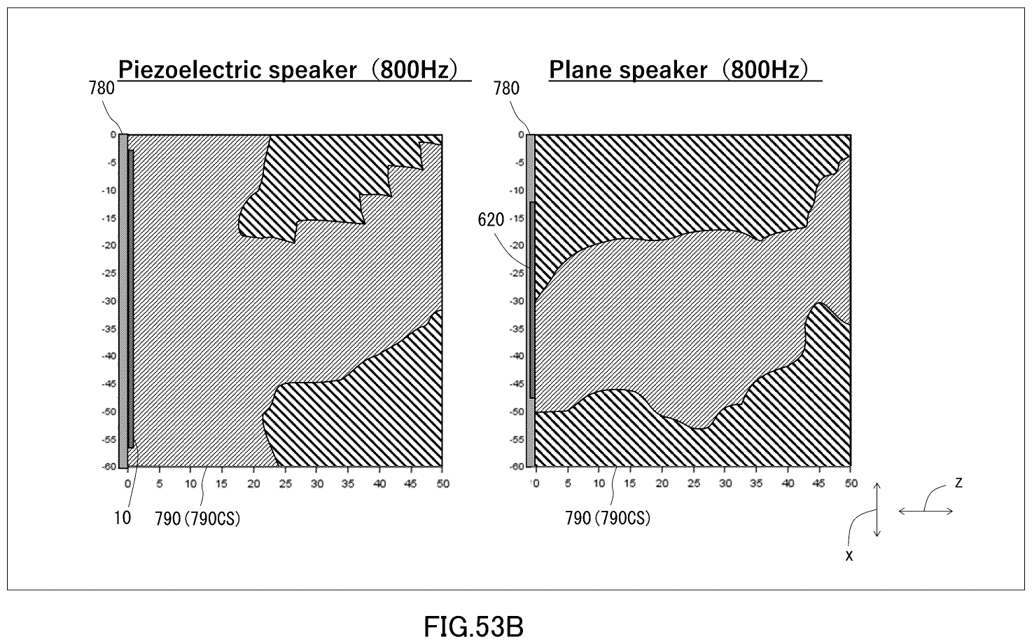

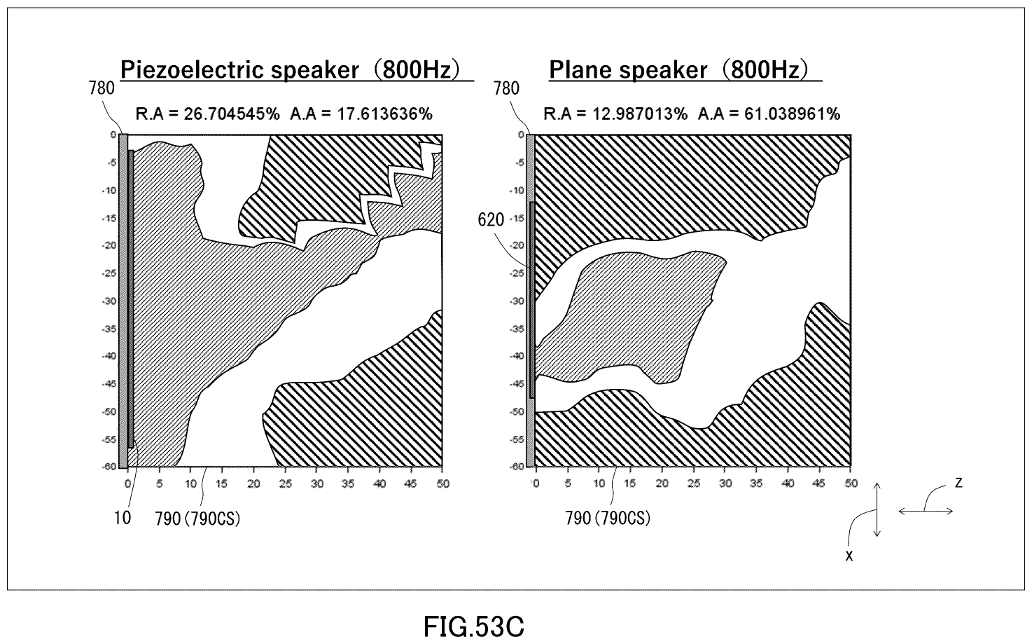

The difference in sound reducing effect between Reference Example 2 and Reference Example 4 will be described with reference to FIG. 52A to FIG. 53C. In the following description, terms “speaker ON time” and “speaker OFF time” may be used. A speaker ON time indicates a time during which sound for sound reduction is radiated from the speaker. A speaker OFF time indicates a time during which sound for sound reduction is not radiated from the speaker.

Color maps in FIG. 52A and FIG. 53A show sound reducing states as of a certain time at which a sine wave is radiated from the noise source 700. In FIG. 52A and FIG. 53A, the color maps on the left show the sound reducing states by the piezoelectric speaker 10 of Reference Example 2, and the color maps on the right show the sound reducing states by the plane speaker 620 of Reference Example 4. FIG. 52A shows a sound pressure distribution as of the certain time for the case where the frequency of the sine wave radiated from the noise source 700 is 500 Hz. FIG. 53A shows a sound pressure distribution as of the certain time for the case where the frequency of the sine wave radiated from the noise source 700 is 800 Hz.

In FIG. 52A and FIG. 53A, the numerical values on the right side of the color bars indicate amplification factors in units of dB. The amplification factor being X represents that a sound pressure is amplified by X dB at a speaker ON time with reference to a speaker OFF time. The amplification factor being negative indicates that a sound reducing effect is exhibited. In contrast, the amplification factor being positive indicates that noise is amplified. Reduction area (R.A) indicates the ratio of an area where the amplification factor is −6 dB or less (i.e., area where the sound reducing effect is exhibited well) on the measurement cross section 790CS. Amplification area (A.A) indicates the ratio of an area where the amplification factor is more than 0 dB (i.e., area where the noise is amplified) on the measurement cross section 790CS.

FIG. 52B shows a finely hatched region where the amplification factor in FIG. 52A is less than 0 dB and a coarsely hatched region where the amplification factor is more than 0. FIG. 53B shows a finely hatched region where the amplification factor in FIG. 53A is less than 0 dB and a coarsely hatched region where the amplification factor is more than 0. That is, in FIG. 52B and FIG. 53B, the regions where noise is reduced are finely hatched and the amplification areas are coarsely hatched. The hatching in FIG. 52B and FIG. 53B is roughly done manually on the basis of the visual observation in FIG. 52A and FIG. 53A. The manual hatching based on the visual observation is also true for FIG. 52C and FIG. 53C described later.

FIG. 52C shows a finely hatched region where the amplification factor in FIG. 52A is −6 dB or less and a coarsely hatched region where the amplification factor is more than 0. FIG. 53C shows a finely hatched region where the amplification factor in FIG. 53A is −6 dB or less and a coarsely hatched region where the amplification factor is more than 0. That is, in FIG. 52C and FIG. 53C, the reduction regions are finely hatched and the amplification areas are coarsely hatched.

As shown in FIG. 52A to FIG. 53C, in the case where the piezoelectric speaker 10 of Reference Example 2 is used, the area where the noise is reduced and the reduction area are large and the amplification area is small compared to the case where the plane speaker 620 of Reference Example 4 is used.

Specifically, in the use case of the piezoelectric speaker 10 of Reference Example 2, in the case where the frequency of the sine wave radiated from the noise source 700 is 500 Hz, the reduction area covers about 58% and the amplification area covers about 18%. In the case where the frequency of the sine wave radiated from the noise source 700 is 800 Hz, the reduction area covers about 27% and the amplification area covers about 18%.

On the other hand, in the use case of the plane speaker 620 of Reference Example 4, in the case where the frequency of the sine wave radiated from the noise source 700 is 500 Hz, the reduction area covers about 38% and the amplification area covers about 21%. In the case where the frequency of the sine wave radiated from the noise source 700 is 800 Hz, the reduction area covers about 13% and the amplification area covers about 61%.

FIG. 52A to FIG. 53C demonstrate that an advantage of the piezoelectric speaker 10 over the plane speaker 620 in terms of sound reducing effect is exhibited more prominently when the frequency of the sine wave radiated from the noise source 700 is 800 Hz than when the frequency is 500 Hz.

It is expected that in the case where the dynamic speaker 610 of Reference Example 3 is used, the area where the noise is reduced and the reduction area are small and the amplification is large compared to the case where the plane speaker 620 of Reference Example 4 is used.

[Evaluation of Sound Traveling Around from Piezoelectric Speaker to Rear of Partition]

As understood from the description with reference to FIG. 18 to FIG. 20, the fact that sound output from a speaker attached to a partition becomes attenuated behind the partition as viewed from the speaker can contribute to good sound reduction. To achieve this, it is effective to adopt, as the speaker, a piezoelectric speaker. This point is further described below with reference to Example 1, Example 2, Example 3, Example 4, Example 5, Comparative Example 1, Comparative Example 2, Comparative Example 3, Comparative Example 4, and Comparative Example 5.

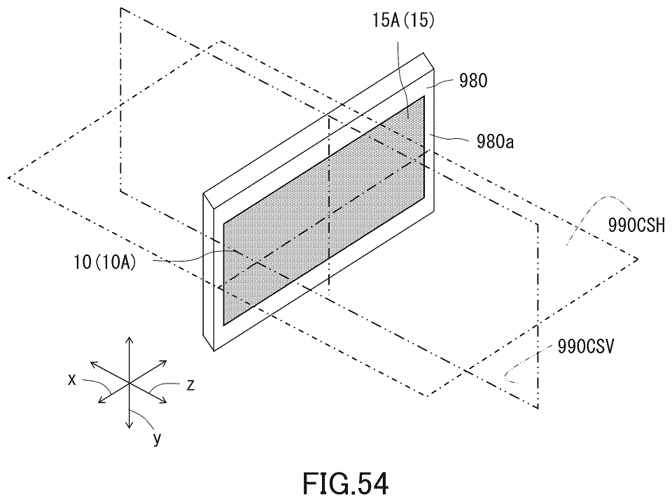

In Examples 1 to 5 and Comparative Examples 1 to 5, the x direction, the y direction, and the z direction are directions orthogonal to each other. A measurement horizontal cross section 990CSH is a plane extending in the x direction and the z direction. A measurement sagittal cross section 990CSV is a plane extending in the y direction and the z direction to be orthogonal to the measurement horizontal cross section and taken with respect to the combination of the partition and the piezoelectric speaker in a laterally symmetrical manner. FIG. 54 is a perspective view for illustrating the measurement horizontal cross section 990CSH and the measurement sagittal cross section 990CSV. In FIG. 54, the measurement horizontal cross section 990CSH is represented by a dashed-and-dotted line, and the measurement sagittal cross section 990CSV is represented by a dashed and double-dotted line.

### Example 1

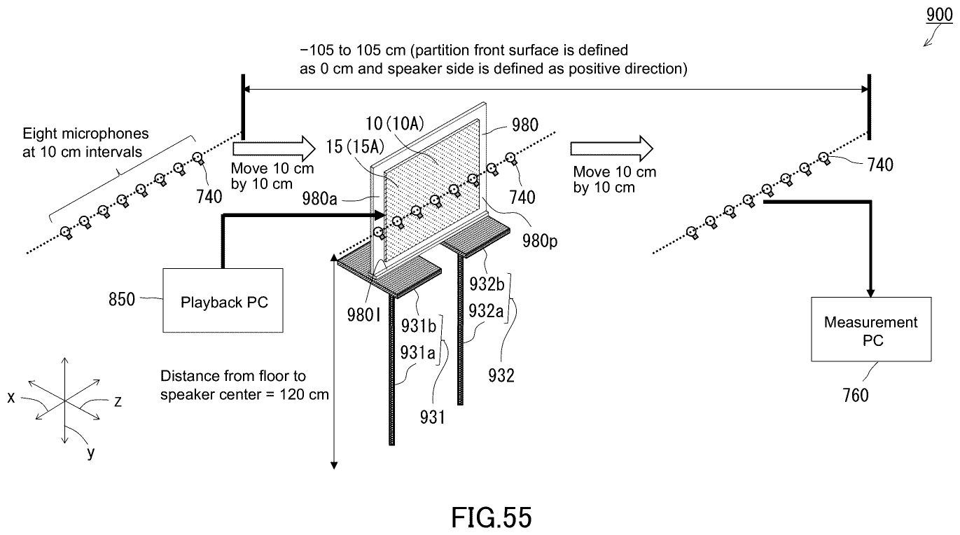

As shown in FIG. 55, an ANC evaluation system 900 was configured. In the ANC evaluation system 900 of Example 1, the same piezoelectric speaker 10 was used as the piezoelectric speaker 10 of Sample E1, except that the plan view dimensions were set to 50 cm in the lateral direction and 35 cm in the longitudinal direction. The number of the piezoelectric speakers 10 used in the ANC evaluation system of Example 1 is one. In Example 1, this piezoelectric speaker 10 is referred to as the first piezoelectric speaker 10A. Further, the radiation surface 15 of this piezoelectric speaker 10 is referred to as the first radiation surface 15A.

As shown in FIG. 55, a first stand 931 and a second stand 932 were installed on the floor. A partition 980 was installed on the first stand 931 and the second stand 932. The first piezoelectric speaker 10A was attached to the partition 980.

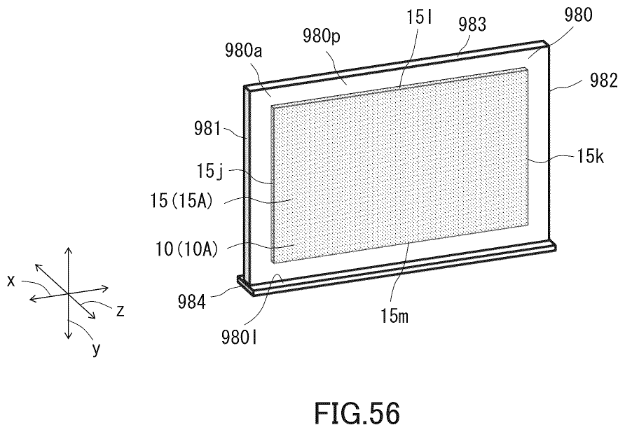

The partition 980 was prototyped for experiments. FIG. 56 is a perspective view showing the partition 980 to which the first piezoelectric speaker 10A is attached. The partition 980 has a plate 980p and a leg 9801. The leg 9801 supports the plate 980p in an upright state. The plate 980p has a front surface 980a and a back surface 980b. In the other figures, the leg 9801 may be omitted.

The plate 980p of the partition 980 has a dimension of 60 cm in the lateral direction, a dimension of 45 cm in the longitudinal direction, and a dimension of 0.5 cm in the thickness direction. The lateral direction is the x direction, the longitudinal direction is the y direction, and the thickness direction is the z direction. Further, the leg 9801 of the partition 980 has a dimension of 60 cm in the x direction, a dimension of 0.5 cm in the y direction, and a dimension of 5.5 cm in the z direction.

The left-right direction along which a left end portion 981 and a right end portion 982 of the plate 980p are arranged is the lateral direction of the plate 980p, namely, the direction along the 60-cm dimension of the plate 980p. The up-down direction along which an upper end portion 983 and a lower end portion 984 of the plate 980p are arranged is the longitudinal direction of the plate 980p, namely, the direction along the 45-cm dimension of the plate 980p.

Further, the lateral direction of the first piezoelectric speaker 10A, namely, the direction along the 50-cm dimension of the first piezoelectric speaker 10A is the x direction. The longitudinal direction of the first piezoelectric speaker 10A, namely, the direction along the 35-cm dimension of the first piezoelectric speaker 10A is the y direction. The thickness direction of the first piezoelectric speaker 10A is the z direction.

As shown in FIG. 55, specifically, the first stand 931 has a first pole 931a and a first plate 931b. To the upper end of the first pole 931a, the lower surface of the first plate 931b is joined. The second stand 932 has a second pole 932a and a second plate 932b. To the upper end of the second pole 932a, the lower surface of the second plate 932b is joined. The first stand 931 and the second stand 932 are installed on the floor so that the first pole 931a and the second pole 932a will be distant from each other in the x direction and the first plate 931b and the second plate 932b will be distant from each other in the x direction. The partition 980 is installed on the first stand 931 and the second stand 932 so that the leg 9801 will be in contact with the upper surface of the first plate 931b and the upper surface of the second plate 932b. Thus, the center position of the first piezoelectric speaker 10A in the longitudinal direction, that is, in the y direction, is set to a position at a height of 120 cm from the floor.

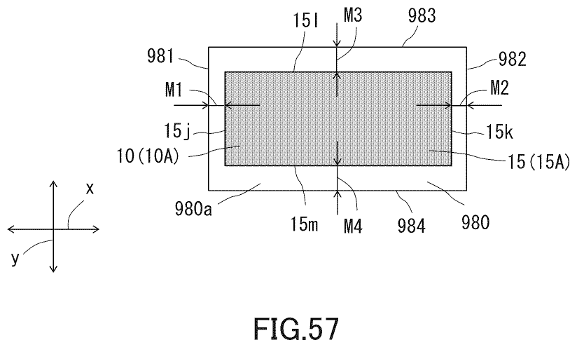

As shown in FIG. 57, the first left margin M1 is 5 cm, and the first right margin M2 is 5 cm. The first left margin M1 and the first right margin M2 are dimensions in the x direction.

The first upper margin M3 is 5 cm, and the first lower margin M4 is 5 cm. The first upper margin M3 and the first lower margin M4 are dimensions in the y direction.

In the ANC evaluation system 900 of Example 1, 88 measurement points are provided on the measurement horizontal cross section 990CSH. Specifically, the measurement horizontal cross section 990CSH is divided into 8 pieces at 10 cm intervals in the x direction and is divided into 11 pieces at 10 cm intervals in the z direction. The number of measurement points, 88, is the product of 8, which is the number of divisions in the x direction and 11, which is the number of divisions in the z direction. The position of the measurement horizontal cross section 990CSH in the y direction is the same as the center position of the first radiation surface 15A of the first piezoelectric speaker 10A in the y direction.

In the ANC evaluation system 900 of Example 1, the measurement PC 760 was used as in the reference ANC evaluation system 800. Further, in the ANC evaluation system 900 of Example 1, a playback PC 850 and eight measurement microphones 740 were used. The measurement microphones 740 each detect sound at a position where the measurement microphone 740 is disposed. An output signal of each of the measurement microphones 740 is transmitted to the measurement PC 760.

As shown in FIG. 55, in the ANC evaluation system 900 of Example 1, the eight measurement microphones 740 are arranged at 10 cm intervals in the x direction to constitute a row of the measurement microphones 740. This row is then moved 10 cm by 10 cm in the z direction. Thus, in cooperation with the measurement PC 760, the eight measurement microphones 740 measure sound pressures at the 88 measurement points on the measurement horizontal cross section 990CSH. Specifically, the measurement PC 760 maps the distribution of the sound pressures at the measurement points. This mapping visualizes the sound field of the measurement horizontal cross section 990CSH extending in the x-z directions.

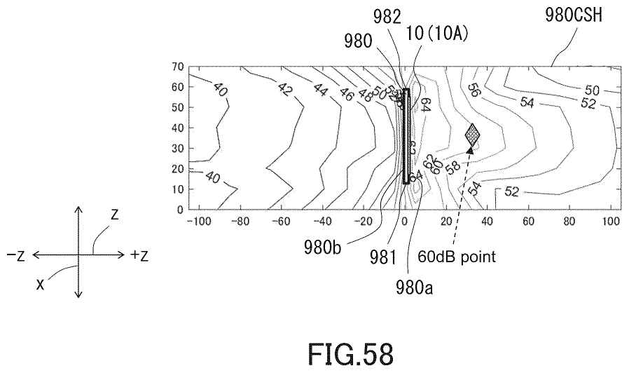

The contour map in FIG. 58 shows the sound pressure distribution with respect to the measurement horizontal cross section 990CSH in Example 1. In the contour map in FIG. 58, the numerical values on the horizontal axis each indicate a distance from the front surface 980a of the partition 980. This distance is a distance along the z axis. Specifically, the z direction from the back surface 980b of the partition 980 toward the front surface 980a of the partition 980 is defined as the +z direction. The direction opposite to the +z direction is defined as the −z direction. On the horizontal axis of the contour map in FIG. 58, the positions in the +z direction are indicated by positive values and the positions in the −z direction are indicated by negative values. In the contour map in FIG. 58, the numerical values on the vertical axis each indicate a position in the x direction. The position indicated by “35” on the vertical axis corresponds to the center position of the first radiation surface 15A of the first piezoelectric speaker 10A in the x direction.

The contour map in FIG. 58 was prepared as follows. The playback PC 850 was used to control the first piezoelectric speaker 10A to radiate a sound wave so that the sound pressure at a distance of 35 cm from the front surface 980a of the partition 980 in the +z direction (the position represented by the diamond mark in FIG. 58) would be approximately 60 dB. Specifically, the first piezoelectric speaker 10A was controlled to radiate white noise limited to a band of 200 Hz to 900 Hz. In this state, the eight measurement microphones 740 were moved as above, so that the sound pressures at the 88 measurement points on the measurement horizontal cross section 990CSH were measured for mapping. The numerical values in the contour map in FIG. 58 indicate sound pressure levels (unit: dB) represented by the respective contours.

In FIG. 58, the region on the left as viewed from the partition 980 as well as the region on the right as viewed from the partition 980 has a portion with a nonzero sound pressure. This demonstrates that the sound, output from the first piezoelectric speaker 10A attached to the partition 980, has traveled around to a “−z direction region behind the partition 980”. The “−z direction region behind the partition 980” refers to a region positioned behind the partition 980 in the −z direction. However, the sound pressure level is low in the −z direction region behind the partition 980. As described with reference to FIG. 18 to FIG. 20, the sounds presumably have canceled out each other in the −z direction region behind the partition 980.

A portion of sound output from the first piezoelectric speaker 10A reflects off the floor to reach a position at the height of the first piezoelectric speaker 10A. In Example 1, however, the partition 980 to which the first piezoelectric speaker 10A is attached is installed on the first stand 931 and the second stand 932. According to this configuration, it is possible to reduce the sound pressure of the above reflected sound at the height of the first piezoelectric speaker 10A. However, the first stand 931 and the second stand 932 may not be installed. Even in the case where the partition 980 to which the first piezoelectric speaker 10A is attached is installed directly on the floor, sound output from the first piezoelectric speaker 10A can become attenuated behind the partition 980 as viewed from the first piezoelectric speaker 10A.

### Example 2

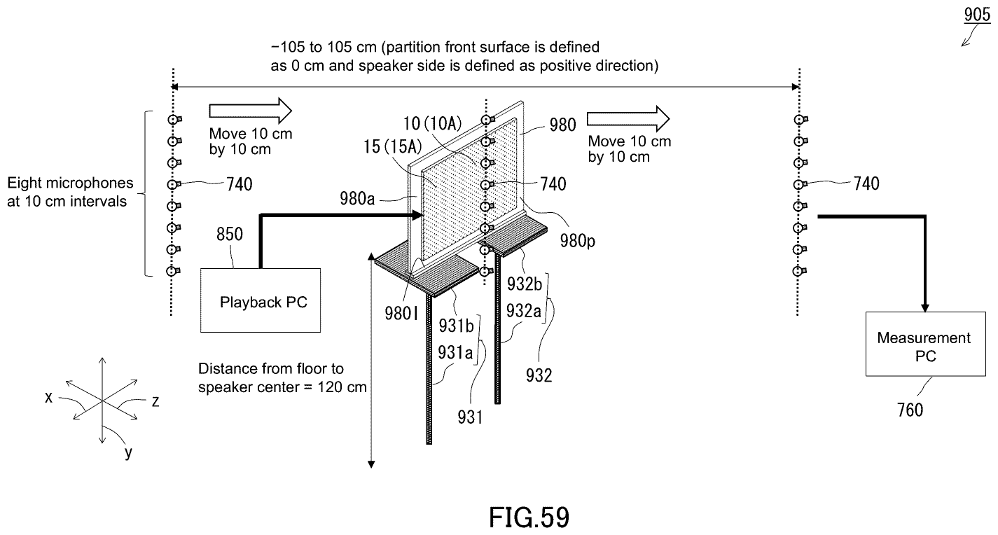

In Example 2, mapping for sound pressure distribution was performed with respect to the measurement sagittal cross section 990CSV instead of the measurement horizontal cross section 990CSH. The measurement performed in Example 2 except for the above point was the same as that in Example 1. FIG. 59 shows an ANC evaluation system 905 of Example 2.

In the ANC evaluation system 905 of Example 2, 88 measurement points are provided on the measurement sagittal cross section 990CSV. Specifically, the measurement sagittal cross section 990CSV is divided into 8 pieces at 10 cm intervals in the y direction and is divided into 11 pieces at 10 cm intervals in the z direction. The number of measurement points, 88, is the product of 8, which is the number of divisions in the y direction and 11, which is the number of divisions in the z direction. The position of the measurement sagittal cross section 990CSV in the x direction is the same as the center position of the first radiation surface 15A of the first piezoelectric speaker 10A in the x direction.

As shown in FIG. 59, in the ANC evaluation system 905 of Example 2, the eight measurement microphones 740 are arranged at 10 cm intervals in the y direction to constitute a row of the measurement microphones 740. This row is then moved 10 cm by 10 cm in the z direction. Thus, in cooperation with the measurement PC 760, the eight measurement microphones 740 measure sound pressures at the 88 measurement points on the measurement sagittal cross section 990CSV. Specifically, the measurement PC 760 maps the distribution of the sound pressures at the measurement points. This mapping visualizes the sound field of the measurement sagittal cross section 990CSV extending in the y-z directions.

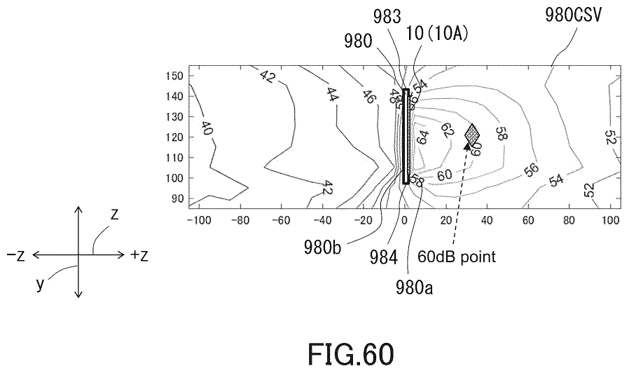

The contour map in FIG. 60 shows the sound pressure distribution with respect to the measurement sagittal cross section 990CSV in Example 2. In the contour map in FIG. 60, the numerical values on the horizontal axis each indicate a distance from the front surface 980a of the partition 980. This distance is a distance along the z axis. On the horizontal axis of the contour map in FIG. 60, the positions in the +z direction are indicated by positive values and the positions in the −z direction are indicated by negative values. In the contour map in FIG. 60, the numerical values on the vertical axis each indicate a position in the y direction. Specifically, the numerical values on the vertical axis each indicate a height (unit: cm) from the floor.

In FIG. 60, the region on the left as viewed from the partition 980 as well as the region on the right as viewed from the partition 980 has a portion with a nonzero sound pressure. This demonstrates that the sound, output from the first piezoelectric speaker 10A attached to the partition 980, has traveled around to the −z direction region behind the partition 980. However, the sound pressure level is low in the −z direction region behind the partition 980. With respect to the sagittal plane as in the horizontal plane, the sounds presumably have canceled out each other in the −z direction region behind the partition 980.

### Example 3

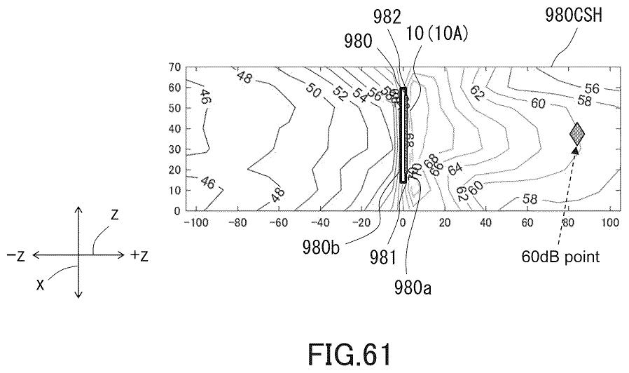

In Example 3, the playback PC 850 was used to control the first piezoelectric speaker 10A to radiate a sound wave so that the sound pressure, instead of at a distance of 35 cm from the front surface 980a of the partition 980 in the +z direction, at a distance of 85 cm from the front surface 980a in the +z direction (the position represented by the diamond mark in FIG. 61), would be approximately 60 dB. The measurement performed in Example 3 except for the above point was the same as that in Example 1.

The contour map in FIG. 61 shows the sound pressure distribution with respect to the measurement horizontal cross section 990CSH in Example 3. In FIG. 61, the region on the left as viewed from the partition 980 as well as the region on the right as viewed from the partition 980 has a portion with a nonzero sound pressure. This demonstrates that the sound, output from the first piezoelectric speaker 10A attached to the partition 980, has traveled around to the −z direction region behind the partition 980. However, the sound pressure level is low in the −z direction region behind the partition 980. Even with a sound pressure level calibration based on a position distant from the partition 980 as compared with that in Example 1, the sounds presumably have canceled out each other in the −z direction region behind the partition 980.

### Example 4

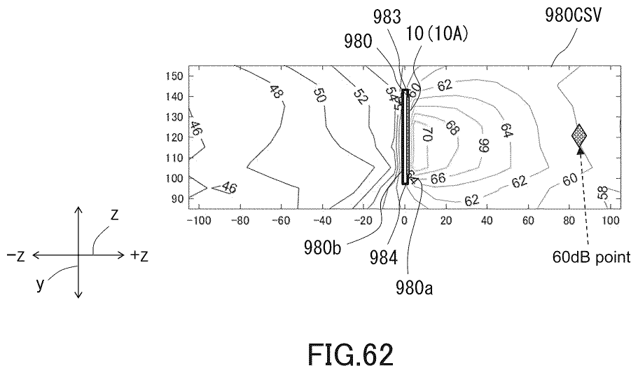

In Example 4, the playback PC 850 was used to control the first piezoelectric speaker 10A to radiate a sound wave so that the sound pressure, instead of at a distance of 35 cm from the front surface 980a of the partition 980 in the +z direction, at a distance of 85 cm from the front surface 980a in the +z direction (the position represented by the diamond mark in FIG. 62), would be approximately 60 dB. The measurement performed in Example 4 except for the above point was the same as that in Example 2.

The contour map in FIG. 62 shows the sound pressure distribution with respect to the measurement sagittal cross section 990CSV in Example 4. In FIG. 62, the region on the left as viewed from the partition 980 as well as the region on the right as viewed from the partition 980 has a portion with a nonzero sound pressure. This demonstrates that the sound, output from the first piezoelectric speaker 10A attached to the partition 980, has traveled around to the −z direction region behind the partition 980. However, the sound pressure level is low in the −z direction region behind the partition 980. Even with a sound pressure level calibration based on a position distant from the partition 980 as compared with that in Example 2, the sounds presumably have canceled out each other in the −z direction region behind the partition 980.

### Example 5

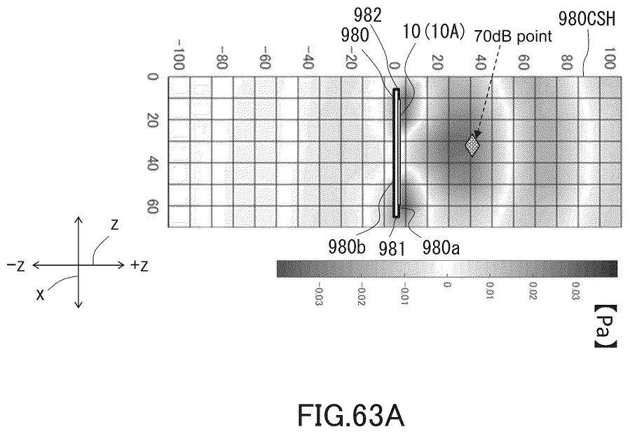

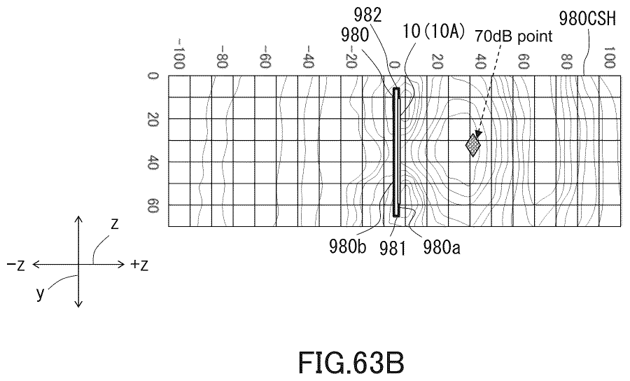

In Example 5, Example 1 was modified so that the sound pressure at a distance of 35 cm from the front surface 980a of the partition 980 in the +z direction (the position represented by the diamond mark in FIG. 63A) would be approximately 70 dB and the sound wave radiated from the first piezoelectric speaker 10A would be a 500 Hz sound wave. In this state, the sound phases at the 88 measurement points on the measurement horizontal cross section 990CSH were measured for mapping. Thus, the sound phase distribution with respect to the measurement horizontal cross section 990CSH was measured. The color map in FIG. 63A shows the sound phase distribution with respect to the measurement horizontal cross section 990CSH. In FIG. 63A, 70 dB corresponds to approximately 0.25 Pa. The contours in FIG. 63B are rough contours manually drawn on the basis of the visual observation of FIG. 63A.

It is understood from the color map in FIG. 63A and the contour map in FIG. 63B that in the vicinity of the back surface 980b of the partition 980, a phase distribution in which the phase is negative, positive, and negative in order as described with reference to FIG. 20 is formed along the left-right direction along which the left end portion 981 and the right end portion 982 are arranged.

### Comparative Example 1

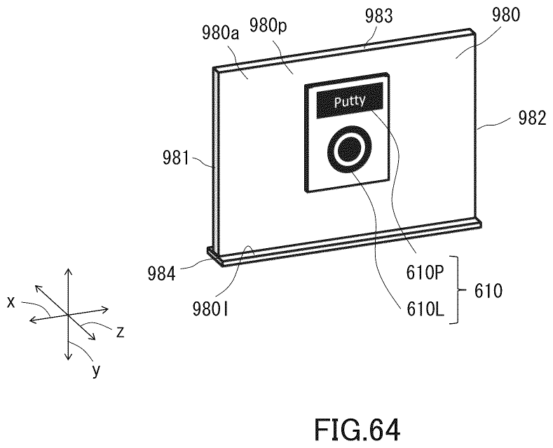

In Comparative Example 1, the first piezoelectric speaker 10A of Example 1 was replaced with the dynamic speaker 610. FIG. 64 is a perspective view showing the partition 980 to which the dynamic speaker 610 is attached. This dynamic speaker 610 is a speaker obtained by processing a wall-mounted speaker PLB-501 W manufactured by K's Wave Inc. The wall-mounted speaker PLB-501 W has a dimension of 18.3 cm in the lateral direction, a dimension of 27.0 cm in the longitudinal direction, and a dimension of 3.7 cm in the thickness direction. The wall-mounted speaker PLB-501 W has a low-middle-frequency speaker 610L and a high-frequency tweeter. The processing involves closing the high-frequency tweeter with putty 610P to prevent sound output from the tweeter thus to prevent an influence on measurement of sound in a frequency domain of 200 Hz to 900 Hz. Further, the dynamic speaker 610 was attached to the plate 980p so that: the lateral direction, the longitudinal direction, and the thickness direction above would respectively correspond to the x direction, the y direction, and the z direction; and the low-middle-frequency speaker 610L would be disposed at the center position of the plate 980p of the partition 980 in the x direction and the y direction. The measurement performed in Comparative Example 1 except for the speaker replacement as above was the same as that in Example 1.

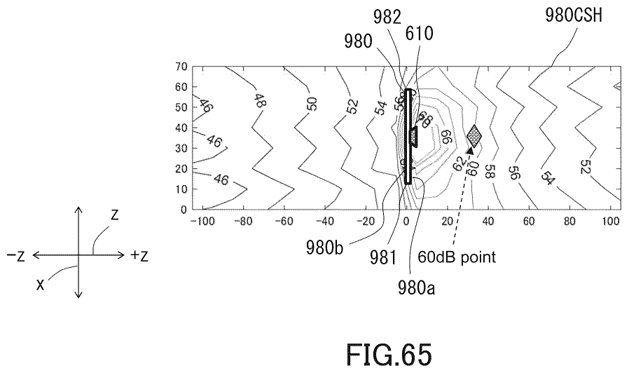

The contour map in FIG. 65 shows the sound pressure distribution with respect to the measurement horizontal cross section 990CSH in Comparative Example 1. In FIG. 65, the region on the left as viewed from the partition 980 as well as the region on the right as viewed from the partition 980 has a portion with a nonzero sound pressure. This demonstrates that the sound, output from the dynamic speaker 610 attached to the partition 980, has traveled around to the −z direction region behind the partition 980. It is understood from FIG. 58 and FIG. 65 that the sound pressure level in the −z direction region behind the partition 980 is higher in Comparative Example 1 than in Example 1 by approximately 7 dB to approximately 8 dB.

### Comparative Example 2

In Comparative Example 2, the first piezoelectric speaker 10A of Example 2 was replaced with the dynamic speaker 610 used in Comparative Example 1. Further, the dynamic speaker 610 was attached to the plate 980p as in Comparative Example 1. The measurement performed in Comparative Example 2 except for the speaker replacement as above was the same as that in Example 2.

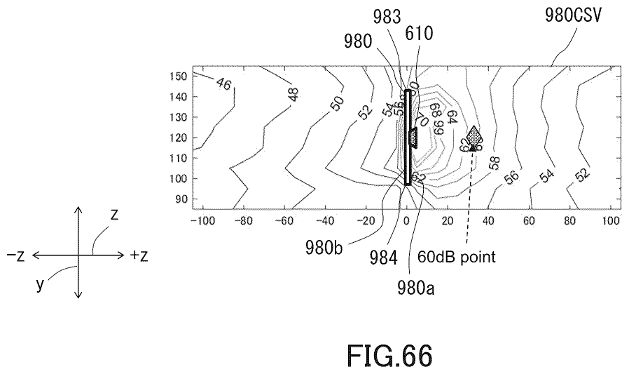

The contour map in FIG. 66 shows the sound pressure distribution with respect to the measurement sagittal cross section 990CSV in Comparative Example 2. In FIG. 66, the region on the left as viewed from the partition 980 as well as the region on the right as viewed from the partition 980 has a portion with a nonzero sound pressure. This demonstrates that the sound, output from the dynamic speaker 610 attached to the partition 980, has traveled around to the −z direction region behind the partition 980. It is understood from FIG. 60 and FIG. 66 that the sound pressure level in the −z direction region behind the partition 980 is higher in Comparative Example 2 than in Example 2. Specifically, the sound pressure level at a position of −40 cm in the z direction is higher in Comparative Example 2 than in Example 2 by approximately 8 dB.

### Comparative Example 3

In Comparative Example 3, the first piezoelectric speaker 10A of Example 3 was replaced with the dynamic speaker 610 used in Comparative Example 1. Further, the dynamic speaker 610 was attached to the plate 980p as in Comparative Example 1. The measurement performed in Comparative Example 3 except for the speaker replacement as above was the same as that in Example 3.

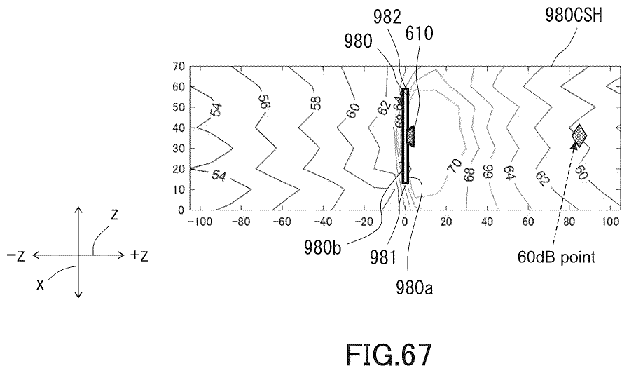

The contour map in FIG. 67 shows the sound pressure distribution with respect to the measurement horizontal cross section 990CSH in Comparative Example 3. In FIG. 67, the region on the left as viewed from the partition 980 as well as the region on the right as viewed from the partition 980 has a portion with a nonzero sound pressure. This demonstrates that the sound, output from the dynamic speaker 610 attached to the partition 980, has traveled around to the −z direction region behind the partition 980. It is understood from FIG. 61 and FIG. 67 that the sound pressure level in the −z direction region behind the partition 980 is higher in Comparative Example 3 than in Example 3.

### Comparative Example 4

In Comparative Example 4, the first piezoelectric speaker 10A of Example 4 was replaced with the dynamic speaker 610 used in Comparative Example 1. Further, the dynamic speaker 610 was attached to the plate 980p as in Comparative Example 1. The measurement performed in Comparative Example 4 except for the speaker replacement as above was the same as that in Example 4.

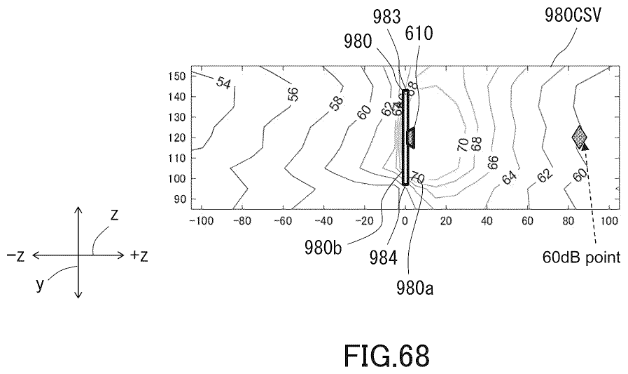

The contour map in FIG. 68 shows the sound pressure distribution with respect to the measurement sagittal cross section 990CSV in Comparative Example 4. In FIG. 68, the region on the left as viewed from the partition 980 as well as the region on the right as viewed from the partition 980 has a portion with a nonzero sound pressure. This demonstrates that the sound, output from the dynamic speaker 610 attached to the partition 980, has traveled around to the −z direction region behind the partition 980. It is understood from FIG. 62 and FIG. 68 that the sound pressure level in the −z direction region behind the partition 980 is higher in Comparative Example 4 than in Example 4.

### Comparative Example 5

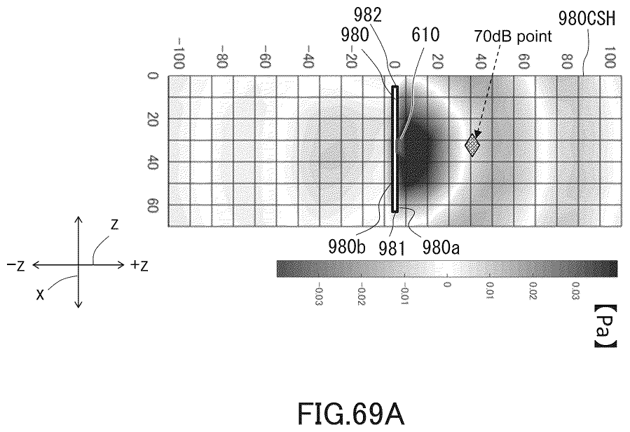

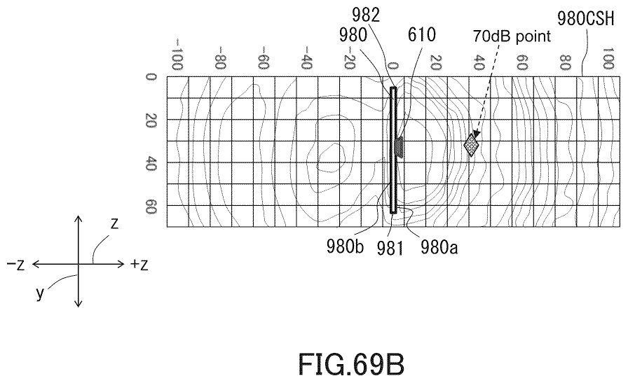

In Comparative Example 5, Comparative Example 1 was modified so that the sound pressure at a distance of 35 cm from the front surface 980a of the partition 980 in the +z direction (the position represented by the diamond mark in FIG. 69A) would be approximately 70 dB and the sound wave radiated from the dynamic speaker 610 would be a 500 Hz sound wave. In this state, the sound phases at the 88 measurement points on the measurement horizontal cross section 990CSH were measured for mapping. Thus, the sound phase distribution with respect to the measurement horizontal cross section 990CSH was measured. The color map in FIG. 69A shows the sound phase distribution with respect to the measurement horizontal cross section 990CSH. In FIG. 69A, 70 dB corresponds to approximately 0.25 Pa. The contours in FIG. 69B are rough contours manually drawn on the basis of the visual observation of FIG. 69A.

Unlike the color map in FIG. 63A and the contour map in FIG. 63B, the color map in FIG. 69A and the contour map in FIG. 69B illustrate that in the vicinity of the back surface 980b, a positive and negative phase distribution is not formed along the left-right direction along which the left end portion 981 and the right end portion 982 of the plate 980p are arranged.

### [Evaluation of Dual ANC System]

The following considers a dual ANC system in which a speaker is attached to each side of a partition, and the speakers are each associated with a reference microphone positioned on the opposite side of the partition as viewed from the speaker. As understood from the description with reference to FIG. 18 to FIG. 20, using piezoelectric speakers as the speakers in such a dual ANC system can contribute to good sound reduction. This is due to the following reasons. Sound derived from one piezoelectric speaker attached to the front surface of the partition becomes attenuated in a space behind the partition as viewed from the one piezoelectric speaker, that is, a space behind the back surface, and is thus less prone to be input as noise to the reference microphone associated with the one piezoelectric speaker. Further, sound derived from the other piezoelectric speaker attached to the back surface of the partition becomes attenuated in a space behind the partition as viewed from the other piezoelectric speaker, that is, a space behind the front surface, and is thus less prone to be input as noise to the reference microphone associated with the other piezoelectric speaker. This point is further described below with reference to Example 6, Example 7, Reference Example 5, Comparative Example 6, Comparative Example 7, and Reference Example 6.

### Example 6: Without Feedback Compensation

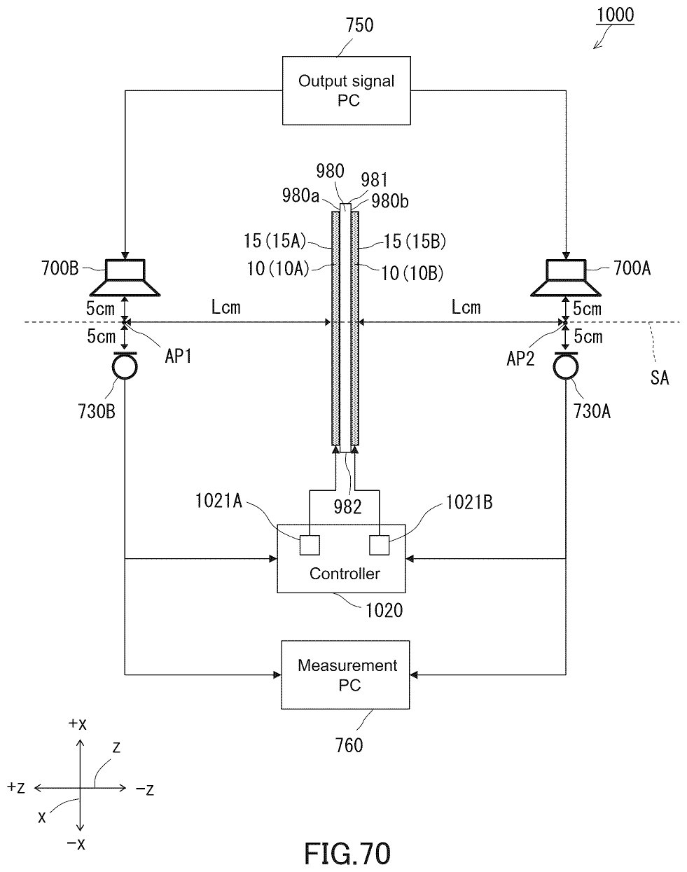

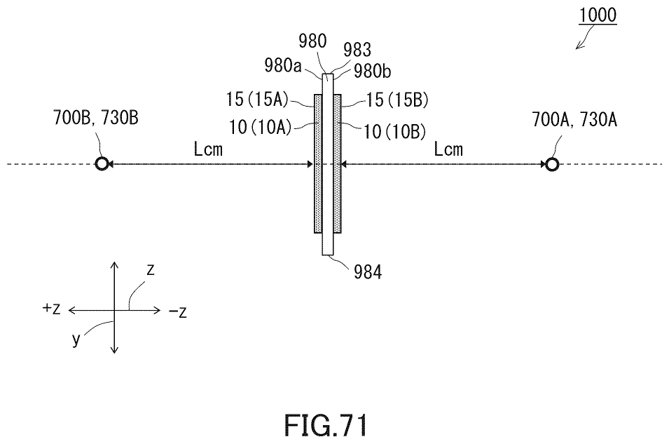

As shown in FIG. 70 to FIG. 72, an ANC evaluation system 1000 was configured. In the ANC evaluation system 1000 of Example 6, to the partition 980 with the first piezoelectric speaker 10A configured in the ANC evaluation systems 900 and 905, the second piezoelectric speaker 10B was attached. The first stand 931 and the second stand 932 were omitted, and the leg 9801 of the partition 980 was installed directly on the floor. Further, a first noise source 700A, a second noise source 700B, a first reference microphone 730A, and a second reference microphone 730B were added. In FIG. 70 and FIG. 71 in contrast to FIG. 55 and FIG. 59, the first piezoelectric speaker 10A is drawn on the left side of the partition 980.

In the ANC evaluation systems 900 and 905, the first piezoelectric speaker 10A is attached to the front surface 980a of the partition 980, as described above. In the ANC evaluation system 1000, the second piezoelectric speaker 10B was attached to the back surface 980b of the partition 980 in addition. The partition 980 was thus obtained in which one piezoelectric speaker 10 is attached to each of the front surface 980a and the back surface 980b. The second piezoelectric speaker 10B is the same piezoelectric speaker as the first piezoelectric speaker 10A.

The first noise source 700A and the second noise source 700B of the ANC evaluation system 1000 are the same as the noise source 700 of the reference ANC evaluation system 800. The first reference microphone 730A and the second reference microphone 730B of the ANC evaluation system 1000 are the same as the reference microphone 730 of the reference ANC evaluation system 800.

In the ANC evaluation system 1000, the output signal PC 750 and the measurement PC 760 were used as in the reference ANC evaluation system 800. The output signal PC 750 was connected to the first noise source 700A and the second noise source 700B. In the ANC evaluation system 1000, a controller 1020 was used. The controller 1020 has a first noise control filter 1021A and a second noise control filter 1021B.

The output signal PC 750 transmits a first noise signal to the first noise source 700A. The output signal PC 750 thus controls the first noise source 700A to output noise.

The output signal PC 750 transmits a second noise signal to the second noise source 700B. The output signal PC 750 thus controls the second noise source 700B to output noise.

On the basis of sound detected by the first reference microphone 730A, the first reference microphone 730A generates an output signal. This output signal is transmitted to the controller 1020. On the basis of this output signal, the controller 1020 transmits a control signal to the first piezoelectric speaker 10A. The controller 1020 thus controls a sound wave radiated from the first piezoelectric speaker 10A.

On the basis of sound detected by the second reference microphone 730B, the second reference microphone 730B generates an output signal. This output signal is transmitted to the controller 1020. On the basis of this output signal, the controller 1020 transmits a control signal to the second piezoelectric speaker 10B. The controller 1020 thus controls a sound wave radiated from the second piezoelectric speaker 10B.

The margins M5 to M8 relevant to the second piezoelectric speaker 10B on the back surface 980b of the partition 980 are respectively the same as the margins M1 to M4 relevant to the first piezoelectric speaker 10A on the front surface 980a of the partition 980.

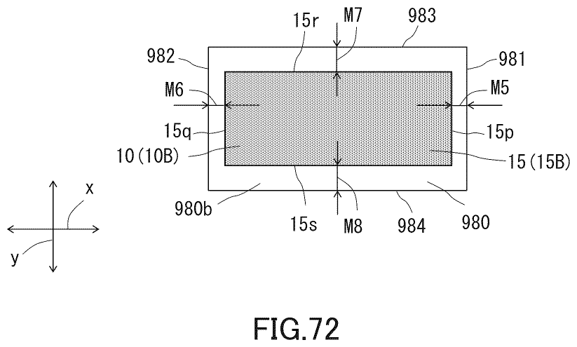

That is, as shown in FIG. 72, the second left margin M5 is 5 cm, and the second right margin M6 is 5 cm. The margins M5 and M6 are dimensions in the x direction.

The second upper margin M7 is 5 cm, and the second lower margin M8 is 5 cm. The margins M7 and M8 are dimensions in the y direction.

The first reference microphone 730A, the second reference microphone 730B, the first noise source 700A, and the second noise source 700B were disposed at a distance of 22.5 cm from the floor.

An axis extending in the z direction and passing through the respective centers of the front surface 980a and the back surface 980b of the partition 980 is defined as a symmetry axis SA. The z direction from the back surface 980b toward the front surface 980a is defined as the +z direction. The z direction from the front surface 980a toward the back surface 980b is defined as the −z direction. A point that is on the symmetry axis SA and is L cm away in the +z direction from the first radiation surface 15A of the first piezoelectric speaker 10A is defined as a first adjustment point AP1. A point that is on the symmetry axis SA and is L cm away in the −z direction from the second radiation surface 15B of the second piezoelectric speaker 10B is defined as a second adjustment point AP2.

The x direction from the right end portion 982 of the partition 980 toward the left end portion 981 of the partition 980 is defined as the +x direction. The x direction from the left end portion 981 of the partition 980 toward the right end portion 982 of the partition 980 is defined as the −x direction. The second noise source 700B was disposed 5 cm away from the first adjustment point AP1 in the +x direction. The second reference microphone 730B was disposed 5 cm away from the first adjustment point AP1 in the −x direction. The first noise source 700A was disposed 5 cm away from the second adjustment point AP2 in the +x direction. The first reference microphone 730A was disposed 5 cm away from the second adjustment point AP2 in the −x direction.

A plane that is perpendicular to an axis extending in the z direction and bisects the partition 980 is defined as a symmetry plane. As understood from the above description, in the ANC evaluation system 1000, the first piezoelectric speaker 10A and the second piezoelectric speaker 10B are symmetric with respect to the symmetry plane. The first reference microphone 730A and the second reference microphone 730B are symmetric with respect to the symmetry plane. The first noise source 700A and the second noise source 700B are symmetric with respect to the symmetry plane.

First, L cm was set to 40 cm.

In the tuning stage, the filter coefficients of the first noise control filter 1021A were determined so that the first piezoelectric speaker 10A would radiate an opposite-phase sound wave for canceling out a traveling diffracted wave that has come from the first noise source 700A and then undergone diffraction at the partition 980. Further, in the tuning stage, the filter coefficients of the second noise control filter 1021B were determined so that the second piezoelectric speaker 10B would radiate an opposite-phase sound wave for canceling out a traveling diffracted wave that has come from the second noise source 700B and then undergone diffraction at the partition 980. The controller 1020 was thus obtained in which the filter coefficients of the first noise control filter 1021A and the filter coefficients of the second noise control filter 1021B were identified.

In the control stage, the first noise source 700A and the second noise source 700B were each controlled to radiate a sine wave as noise. In this state, the controller 1020 controlled the first piezoelectric speaker 10A and the second piezoelectric speaker 10B to each radiate a sound wave for sound reduction. Measurement was made on a sound reducing effect exerted by the first piezoelectric speaker 10A and a sound reducing effect exerted by the second piezoelectric speaker 10B at that time. The sound reducing effect exerted by the first piezoelectric speaker 10A was measured by transmitting the output signal of the second reference microphone 730B to the measurement PC 760. The sound reducing effect exerted by the second piezoelectric speaker 10B was measured by transmitting the output signal of the first reference microphone 730A to the measurement PC 760.

Specifically, in the control stage, the filter coefficients of the first noise control filter 1021A identified as above were not changed but fixed. Thus, in the control stage, control was performed so that sound input to the first reference microphone 130A and sound output from the first piezoelectric speaker 10A would be in one-to-one correspondence and the correspondence would be fixed over time. Further, the filter coefficients of the second noise control filter 1021B identified as above were not changed but fixed. Thus, in the control stage, control was performed so that sound input to the second reference microphone 130B and sound output from the second piezoelectric speaker 10B would be in one-to-one correspondence and the correspondence would be fixed over time.

Further, in the control stage, without feedback compensation, the controller 1020 controlled the first piezoelectric speaker 10A and the second piezoelectric speaker 10B to each radiate a sound wave for sound reduction. “Without feedback compensation” refers to performing neither control that is for reducing an influence of a first travel-around sound on sound to be output from the first piezoelectric speaker 10A nor control that is for reducing an influence of a second travel-around sound on sound to be output from the second piezoelectric speaker 10B. The first travel-around sound refers to sound that is output from the first piezoelectric speaker 10A and travels around to the first reference microphone 730A. The second travel-around sound refers to sound that is output from the second piezoelectric speaker 10B and travels around to the second reference microphone 730B.

In the tuning stage and the control stage, noise radiated from the first noise source 700A and the second noise source 700B was generated by passing white noise through a 200 Hz to 800 Hz band-limiting filter. More specifically, the white noise that has passed through the band-limiting filter substantially equally contains frequency components of 200 Hz to 800 Hz.

Next, L cm was changed to 50 cm. The same tuning stage and control stage except for the above were performed as those in the case where L cm was 40 cm. Measurement was thus performed on the sound reducing effect exerted by the first piezoelectric speaker 10A and the sound reducing effect exerted by the second piezoelectric speaker 10B.

Next, L cm was changed to 60 cm. The same tuning stage and control stage except for the above were performed as those in the case where L cm was 40 cm. Measurement was thus performed on the sound reducing effect exerted by the first piezoelectric speaker 10A and the sound reducing effect exerted by the second piezoelectric speaker 10B.

Next, L cm was changed to 70 cm. The same tuning stage and control stage except for the above were performed as those in the case where L cm was 40 cm. Measurement was thus performed on the sound reducing effect exerted by the first piezoelectric speaker 10A and the sound reducing effect exerted by the second piezoelectric speaker 10B.

Next, L cm was changed to 80 cm. The same tuning stage and control stage except for the above were performed as those in the case where L cm was 40 cm. Measurement was thus performed on the sound reducing effect exerted by the first piezoelectric speaker 10A and the sound reducing effect exerted by the second piezoelectric speaker 10B.

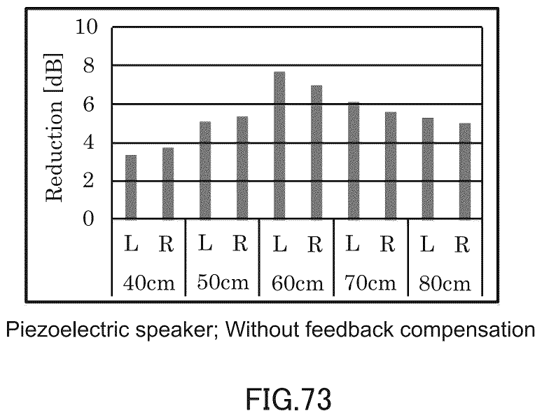

In Example 6, the measurement was performed in the above manner for each of the L cm cases of 40 cm, 50 cm, 60 cm, 70 cm, and 80 cm, on the sound reducing effect exerted by the first piezoelectric speaker 10A and the sound reducing effect exerted by the second piezoelectric speaker 10B without feedback compensation. The measurement results are shown in FIG. 73. In FIG. 73, “L” represents the sound reducing effect exerted by the first piezoelectric speaker 10A. This sound reducing effect is based on the sound detected by the second reference microphone 730B, as described above. “R” represents the sound reducing effect exerted by the second piezoelectric speaker 10B. This sound reducing effect is based on the sound detected by the first reference microphone 730A, as described above.

### Example 7: With Feedback Compensation

In the same manner as in Example 6 except for change from “without feedback compensation” to “with feedback compensation”, measurement was performed on the sound reducing effect exerted by the first piezoelectric speaker 10A and the sound reducing effect exerted by the second piezoelectric speaker 10B. “With feedback compensation” refers to performing control that is for reducing an influence of the first travel-around sound on sound to be output from the first piezoelectric speaker 10A and control that is for reducing an influence of the second travel-around sound on sound to be output from the second piezoelectric speaker 10B. The above control is known control for reducing an acoustic feedback path (AFP). Specifically, in Example 7 and Comparative Example 7 described later, feedback compensation was performed by digital processing.

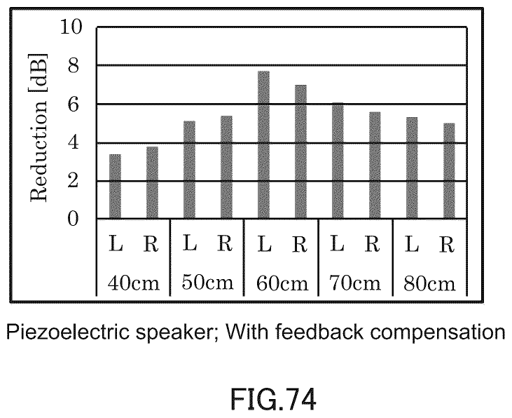

In Example 7, the measurement was performed in the above manner for each of the L cm cases of 40 cm, 50 cm, 60 cm, 70 cm, and 80 cm, on the sound reducing effect exerted by the first piezoelectric speaker 10A and the sound reducing effect exerted by the second piezoelectric speaker 10B with feedback compensation. The measurement results are shown in FIG. 74.

### Reference Example 5: Independent Left and Right Control

In measuring “L” representing the sound reducing effect exerted by the first piezoelectric speaker 10A, the second piezoelectric speaker 10B and the second noise source 700B were controlled not to output sound. Further, in measuring “R” representing the sound reducing effect exerted by the second piezoelectric speaker 10B, the first piezoelectric speaker 10A and the first noise source 700A were controlled not to output sound. In the same manner as in Example 6 except for the above, measurement was performed on the sound reducing effect exerted by the first piezoelectric speaker 10A and the sound reducing effect exerted by the second piezoelectric speaker 10B.

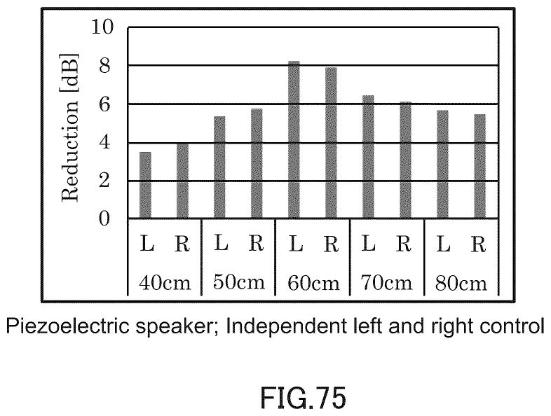

In Reference Example 5, the measurement was performed in the above manner for each of the L cm cases of 40 cm, 50 cm, 60 cm, 70 cm, and 80 cm, on the sound reducing effect exerted by the first piezoelectric speaker 10A and the sound reducing effect exerted by the second piezoelectric speaker 10B. The measurement results are shown in FIG. 75.

### Comparative Example 6: Without Feedback Compensation

The first piezoelectric speaker 10A was replaced with a first dynamic speaker 610A, and the second piezoelectric speaker 10B was replaced with a second dynamic speaker 610B. The first dynamic speaker 610A and the second dynamic speaker 610B of Comparative Example 6 are Fostex P650K manufactured by Foster Electric Company, Limited. In the same manner as in Example 5 except for the above, measurement was performed on the sound reducing effect exerted by the first piezoelectric speaker 10A and the sound reducing effect exerted by the second piezoelectric speaker 10B.

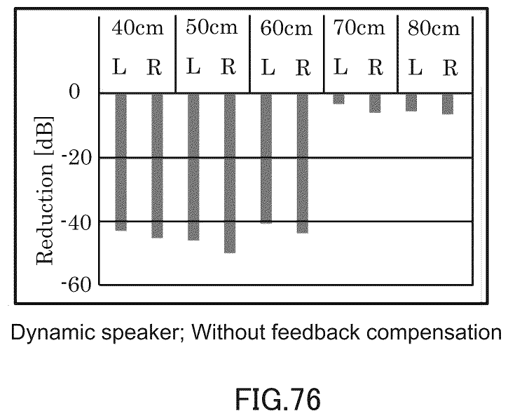

In Comparative Example 6, the measurement was performed in the above manner for each of the L cm cases of 40 cm, 50 cm, 60 cm, 70 cm, and 80 cm, on the sound reducing effect exerted by the first dynamic speaker 610A and the sound reducing effect exerted by the second dynamic speaker 610B without feedback compensation. The measurement results are shown in FIG. 76.

### Comparative Example 7: With Feedback Compensation

In the same manner as in Comparative Example 6 except for change from “without feedback compensation” to “with feedback compensation”, measurement was performed on the sound reducing effect exerted by the first dynamic speaker 610A and the sound reducing effect exerted by the second dynamic speaker 610B.

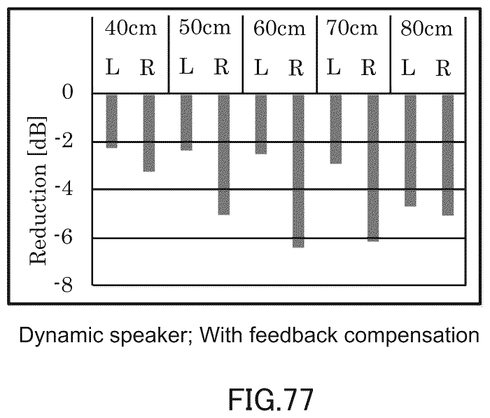

In Comparative Example 7, the measurement was performed in the above manner for each of the L cm cases of 40 cm, 50 cm, 60 cm, 70 cm, and 80 cm, on the sound reducing effect exerted by the first dynamic speaker 610A and the sound reducing effect exerted by the second dynamic speaker 610B with feedback compensation. The measurement results are shown in FIG. 77.

### Reference Example 6: Independent Left and Right Control

In measuring “L” representing the sound reducing effect exerted by the first dynamic speaker 610A, the second dynamic speaker 610B and the second noise source 700B were controlled not to output sound. Further, in measuring “R” representing the sound reducing effect exerted by the second dynamic speaker 610B, the first dynamic speaker 610A and the first noise source 700A were controlled not to output sound. In the same manner as in Comparative Example 6 except for the above, measurement was performed on the sound reducing effect exerted by the first dynamic speaker 610A and the sound reducing effect exerted by the second dynamic speaker 610B.

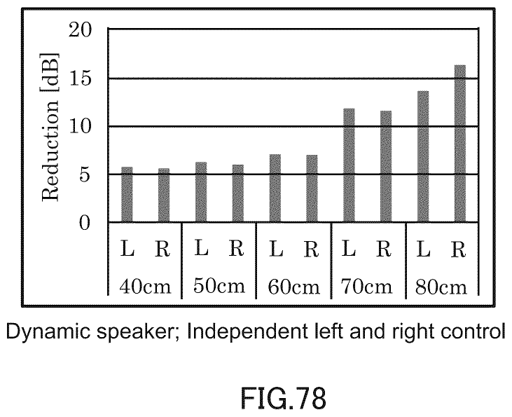

In Reference Example 6, the measurement was performed in the above manner for each of the L cm cases of 40 cm, 50 cm, 60 cm, 70 cm, and 80 cm, on the sound reducing effect exerted by the first dynamic speaker 610A and the sound reducing effect exerted by the second dynamic speaker 610B. The measurement results are shown in FIG. 78.

FIG. 76 for Comparative Example 6 and FIG. 77 for Comparative Example 7 demonstrate that, with or without feedback compensation, using a dynamic speaker cannot achieve a sufficient sound reducing effect. More specifically, it is understood from FIG. 76 and FIG. 77 that, on the contrary, the sound is amplified in Comparative Example 6 and Comparative Example 7. In contrast, it is understood from FIG. 78 that the sound reducing effect is achieved in Reference Example 6. This infers that in Comparative Example 6 and Comparative Example 7, the travel around of the sound from the dynamic speaker to the rear of the partition hindered the sound reduction.

A comparison of FIG. 73 for Example 6 with FIG. 74 for Example 7 demonstrates that, with or without feedback compensation, using a piezoelectric speaker can achieve a sufficient sound reducing effect.

### [Supporting Structure for Piezoelectric Film and Degree of Freedom of Vibration]

The following refers to an example of a supporting structure for the piezoelectric speaker according to the present invention. As understood from FIG. 12, FIG. 21, FIG. 23, and FIG. 24 and the descriptions relating to these figures, in the piezoelectric speaker 10, the entire surface of the piezoelectric film 35 is fixed to the structure 80 with the joining layers 51 and 52 and the interposed layer 40 therebetween.

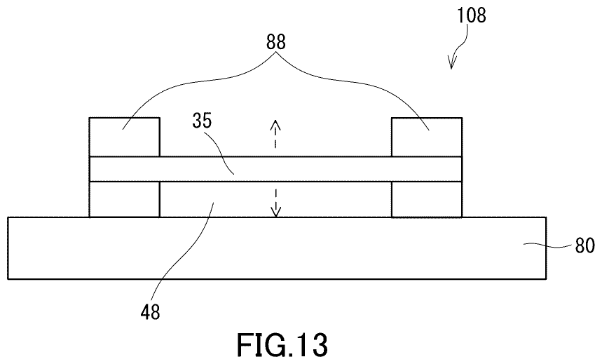

It is also conceivable that a portion of the piezoelectric film 35 is supported to be spaced away from the structure 80 in order to prevent the structure 80 from hindering the vibration of the piezoelectric film 35. An exemplary supporting structure based on this design concept is shown in FIG. 13. In a hypothetical piezoelectric speaker 108 shown in FIG. 13, a frame 88 supports a peripheral portion of the piezoelectric film 35 at a position distant from the structure 80.

It is easy to ensure a sufficient sound volume from a piezoelectric film already curved and fixed in one direction. Accordingly, it is conceivable that, for example, in the piezoelectric speaker 108, a nonuniformly thick interposed object having a convex upper surface is disposed in a space 48 surrounded by the piezoelectric film 35, the frame 88, and the structure 80 and a central portion of the piezoelectric film 35 is pushed upward. However, such an interposed object is not joined to the piezoelectric film 35 so as not to hinder the vibration of the piezoelectric film 35. Accordingly, even with the interposed object disposed in the space 48, it is only the frame 88 that supports the piezoelectric film 35 so as to determine the vibration of the piezoelectric film 35.

As described above, the piezoelectric speaker 108 shown in FIG. 13 employs the supporting structure locally supporting the piezoelectric film 35. On the other hand, the piezoelectric film 35 of the piezoelectric speaker 10 as in FIG. 12 and the like is not supported at a particular portion. Unexpectedly, the piezoelectric speaker 10 exhibits practical acoustic characteristics in spite of the fact that the entire surface of the piezoelectric film 35 is fixed to the structure 80. Specifically, in the piezoelectric speaker 10, even a peripheral portion of the piezoelectric film 35 possibly vibrates up and down. The piezoelectric film 35 can vibrate up and down as a whole. Accordingly, compared with the piezoelectric speaker 108, the piezoelectric speaker 10 has a higher degree of freedom of vibration and is relatively advantageous in achieving good sound emission characteristics.

As described with reference to FIG. 12, the high degree of freedom of vibration has the possibility of contributing to the formation of the first wave front 16a, the second wave front 16b, the fourth wave front 16d, and the fifth wave front 16e. In FIG. 12, the case where the piezoelectric speaker 10 is the piezoelectric speaker 10 shown in FIG. 21 is illustrated. In FIG. 12, the first joining layer 51 and the second joining layer 52 are not shown. A high degree of freedom of vibration can be obtained also in the case where the piezoelectric speaker 10 is the piezoelectric speaker 110 shown in FIG. 23.

According to the studies by the present inventors, the interposed layer being a porous body layer and/or a resin layer is suitable for achieving the degree of freedom of vibration. In fact, in Samples E1 to E17 in which the interposed layer is a porous body layer and/or a resin layer, practical acoustic characteristics are exhibited in spite of the fact that the entire surface of the piezoelectric film 35 is fixed to the supporting member 680. It is considered that even in the case where the first piezoelectric speaker 10A and the second piezoelectric speaker 10B in the ANC evaluation systems 800, 900, 905, and 1000 are changed from different size products of Sample E1 to different size products of Samples E2 to E17, a sound pressure distribution with a tendency similar to those in FIG. 40 to FIG. 43, FIG. 52A to FIG. 53C, FIG. 58, and FIG. 60 to FIG. 62 appears, a phase distribution with a tendency similar to those in FIG. 63A and FIG. 63B appears, and a sound reducing effect similar to those in FIG. 73 to FIG. 75 is obtained.

[Techniques, Effects, and the Like that can be Derived from the Present Invention]

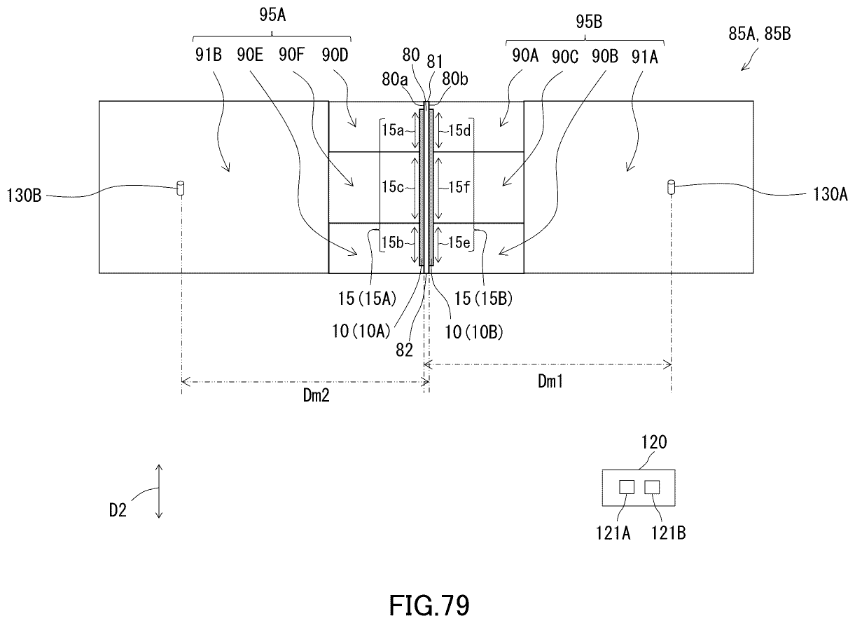

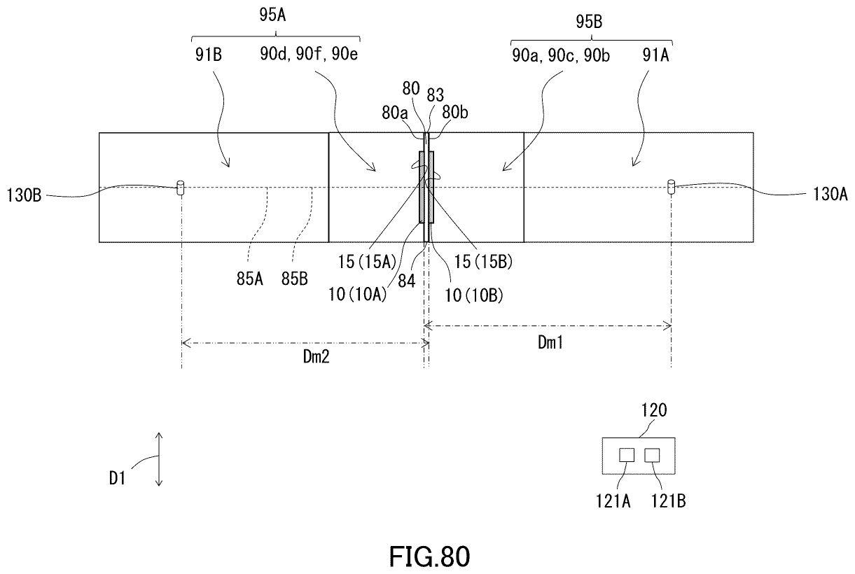

The following describes techniques, effects, and the like that can be derived from the present invention, with reference to FIG. 79 and FIG. 80. As understood from the above description, the second piezoelectric speaker 10B and other components can be omitted. The ANC system may be a dual ANC system using two piezoelectric speakers or may be a single ANC system using one piezoelectric speaker.

The ANC system includes the structure 80, the first piezoelectric speaker 10A, and the second piezoelectric speaker 10B. The structure 80 has the front surface 80a and the back surface 80b.

The first piezoelectric speaker 10A is disposed on the front surface 80a. The first piezoelectric speaker 10A radiates a sound wave for sound reduction. The ANC system according to this configuration is suitable for causing attenuation of sound derived from the speaker attached to the structure 80 to occur behind the structure as viewed from the speaker. Specifically, this configuration facilitates the attenuation of sound that has traveled around from the first piezoelectric speaker 10A to the opposite side of the structure 80.

The second piezoelectric speaker 10B is disposed on the back surface 80b. The second piezoelectric speaker 10B radiates a sound wave for sound reduction. The ANC system according to this configuration is suitable for causing attenuation of sound derived from the speaker attached to the structure 80 to occur behind the structure as viewed from the speaker. Specifically, this configuration facilitates the attenuation of sound that has traveled around from the second piezoelectric speaker 10B to the opposite side of the structure 80.

The structure 80 has the left end portion 81, the right end portion 82, the upper end portion 83, and the lower end portion 84.

In the ANC system, a front space 95A, the front surface 80a, the back surface 80b, and a back space 95B are arranged in this order. The front space 95A is a space overlapping the front surface 80a in plan view of the front surface 80a. The back space 95B is a space overlapping the back surface 80b in plan view of the back surface.

The first piezoelectric speaker 10A has the first radiation surface 15A. The first radiation surface 15A faces the front space 95A. The second piezoelectric speaker 10B has the second radiation surface 15B. The second radiation surface 15B faces the back space 95B.

The first radiation surface 15A has the first region 15a, the second region 15b, and the third region 15c. The third region 15c is positioned between the first region 15a and the second region 15b.

The second radiation surface 15B has the fourth region 15d, the fifth region 15e, and the sixth region 15f. The sixth region 15f is positioned between the fourth region 15d and the fifth region 15e.

The back space 95B has the first rear space 90A, the second rear space 90B, and the third rear space 90C. The third rear space 90C is positioned between the first rear space 90A and the second rear space 90B.

The front space 95A has a fourth rear space 90D, a fifth rear space 90E, and a sixth rear space 90F. The sixth rear space 90F is positioned between the fourth rear space 90D and the fifth rear space 90E.

In the following description, terms first reference plane 85A and second reference plane 85B are used. The first reference plane 85A and the second reference plane 85B are planes perpendicular to the up-down direction D1. In the example in FIG. 79 and FIG. 80, the first reference plane 85A and the second reference plane 85B are planes coincident with each other. However, the first reference plane 85A and the second reference plane 85B may be planes different in height from each other.

The first region 15a, the second region 15b, the third region 15c, the first rear space 90A, the second rear space 90B, and the third rear space 90C intersect the first reference plane 85A. The fourth region 15d, the fifth region 15e, the sixth region 15f, the fourth rear space 90D, the fifth rear space 90E, and the sixth rear space 90F intersect the second reference plane 85B.

A period appears during which a first requirement, a second requirement, and a third requirement are satisfied. The first requirement is a requirement that the phase of a sound wave in the first rear space 90A formed by the first piezoelectric speaker 10A should be one of positive and negative. The second requirement is a requirement that the phase of a sound wave in the second rear space 90B formed by the first piezoelectric speaker 10A should be the one of positive and negative. The third requirement is a requirement that the phase of a sound wave in the third rear space 90C formed by the first piezoelectric speaker 10A should be the other of positive and negative. Such a phase distribution formed in the back space 95B facilitates sound derived from the first piezoelectric speaker 10A to become attenuated in the back space 95B. Specifically, the sound wave in the first rear space 90A, the sound wave in the third rear space 90C, and the sound wave in the second rear space 90B propagate to the first interference space 91A, which is positioned further behind. In the first interference space 91A, these sound waves interfere with each other and cancel out each other. Consequently, in the first interference space 91A, sound derived from the first piezoelectric speaker 10A can be attenuated. The first interference space 91A is included in the back space 95B.

In a numerical example, under the control of the controller 120, a period T3 can appear during which the respective phases of sound waves derived from the first piezoelectric speaker 10A in the first rear space 90A, the third rear space 90C, and the second rear space 90B are respectively negative, positive, and negative, or are respectively positive, negative, and positive. When one period of the sound waves in the rear spaces 90A, 90C, and 90B is defined as Tr, T3/Tr is, for example, 0.01 or more and 1 or less, depending on the first noise source 200A. Further, in the case where the first noise source 200A radiates a sine wave, the period T3 can continue or can appear periodically. T3/Tr may be 0.1 or more and 1 or less, may be 0.5 or more and 1 or less, may be 0.7 or more and 1 or less, and may be 0.9 or more and 1 or less.

Specifically, a period appears during which a fourth requirement, a fifth requirement, and a sixth requirement are satisfied. The fourth requirement is a requirement that over a first travel-around path from the first region 15a to the first rear space 90A via the left end portion 81, the phase of a sound wave formed by the first piezoelectric speaker 10A should be maintained at one of positive and negative. The fifth requirement is a requirement that over a second travel-around path from the second region 15b to the second rear space 90B via the right end portion 82, the phase of a sound wave formed by the first piezoelectric speaker 10A should be maintained at the one of positive and negative. The sixth requirement is a requirement that over a third travel-around path from the third region 15c to the third rear space 90C via the upper end portion 83, the phase of a sound wave formed by the first piezoelectric speaker 10A should be maintained at the other of positive and negative. During the above period, the following requirement may be satisfied: over a travel-around path from the third region 15c to the third rear space 90C via the lower end portion 84, the phase of a sound wave formed by the first piezoelectric speaker 10A should be maintained at the other of positive and negative.

A period appears during which a seventh requirement, an eighth requirement, and a ninth requirement are satisfied. The seventh requirement is a requirement that the phase of a sound wave in the fourth rear space 90D formed by the second piezoelectric speaker 10B should be one of positive and negative. The eighth requirement is a requirement that the phase of a sound wave in the fifth rear space 90E formed by the second piezoelectric speaker 10B should be the one of positive and negative. The ninth requirement is a requirement that the phase of a sound wave in the sixth rear space 90F formed by the second piezoelectric speaker 10B should be the other of positive and negative. Such a phase distribution formed in the front space 95A facilitates sound derived from the second piezoelectric speaker 10B to become attenuated in the front space 95A. Specifically, the sound wave in the fourth rear space 90D, the sound wave in the sixth rear space 90F, and the sound wave in the fifth rear space 90E propagate to a second interference space 91B, which is positioned further behind. In the second interference space 91B, these sound waves interfere with each other and cancel out each other. Consequently, in the second interference space 91B, sound derived from the second piezoelectric speaker 10B can be attenuated. The second interference space 91B is included in the front space 95A.

In a numerical example, under the control of the controller 120, a period T4 can appear during which the respective phases of sound waves derived from the second piezoelectric speaker 10B in the fourth rear space 90D, the sixth rear space 90F, and the fifth rear space 90E are respectively negative, positive, and negative, or are respectively positive, negative, and positive. When one period of the sound waves in the rear spaces 90D, 90F, and 90E is defined as Tt, T4/Tt is, for example, 0.01 or more and 1 or less, depending on the second noise source 200B. Further, in the case where the second noise source 200B radiates a sine wave, the period T4 can continue or can appear periodically. T4/Tt may be 0.1 or more and 1 or less, may be 0.5 or more and 1 or less, may be 0.7 or more and 1 or less, and may be 0.9 or more and 1 or less.

Specifically, a period appears during which a tenth requirement, an eleventh requirement, and a twelfth requirement are satisfied. The tenth requirement is a requirement that over a fourth travel-around path from the fourth region 15d to the fourth rear space 90D via the left end portion 81, the phase of a sound wave formed by the second piezoelectric speaker 10B should be maintained at one of positive and negative. The eleventh requirement is a requirement that over a fifth travel-around path from the fifth region 15e to the fifth rear space 90E via the right end portion 82, the phase of a sound wave formed by the second piezoelectric speaker 10B should be maintained at the one of positive and negative. The twelfth requirement is a requirement that over a sixth travel-around path from the sixth region 15f to the sixth rear space 90F via the upper end portion 83, the phase of a sound wave formed by the second piezoelectric speaker 10B should be maintained at the other of positive and negative. During the above period, the following requirement may be satisfied: over a travel-around path from the sixth region 15f to the sixth rear space 90F via the lower end portion 84, the phase of a sound wave formed by the second piezoelectric speaker 10B should be maintained at the other of positive and negative.

The ANC system includes the controller 120. The controller 120 has a control mode of controlling the frequency of sound to be output from the first piezoelectric speaker 10A to a value within the first specified frequency range. The wavelength of sound having the upper limit for the first specified frequency range is defined as the first reference wavelength. Further, the controller 120 has a control mode of controlling the frequency of sound to be output from the second piezoelectric speaker 10B to a value within the second specified frequency range. The wavelength of sound having the upper limit for the second specified frequency range is defined as the second reference wavelength. The former control mode and the latter control mode may be the same control mode or may be control modes different from each other.

The absolute value of the difference between the first left margin M1 and the first upper margin M3 may be ⅛ or less of the first reference wavelength. With the margin being such a value, the period required for sound to propagate from the first region 15a of the first radiation surface 15A to the left end portion 81 of the structure 80 and the period required for sound to propagate from the third region 15c of the first radiation surface 15A to the upper end portion 83 of the structure 80 can be substantially equal to each other. Consequently, the time at which the sound derived from the first region 15a starts to travel from the left end portion 81 to the back space 95B and the time at which the sound derived from the third region 15c starts to travel from the upper end portion 83 to the back space 95B can be substantially coincident with each other. This can contribute to causing attenuation of sound that has traveled around to the back space 95B to occur in a large region of the back space 95B.

The absolute value of the difference between the first right margin M2 and the first upper margin M3 may be ⅛ or less of the first reference wavelength. With the margin being such a value, the period required for sound to propagate from the second region 15b of the first radiation surface 15A to the right end portion 82 of the structure 80 and the period required for sound to propagate from the third region 15c of the first radiation surface 15A to the upper end portion 83 of the structure 80 can be substantially equal to each other. Consequently, the time at which the sound derived from the second region 15b starts to travel from the right end portion 82 to the back space 95B and the time at which the sound derived from the third region 15c starts to travel from the upper end portion 83 to the back space 95B can be substantially coincident with each other. This can contribute to causing attenuation of sound that has traveled around to the back space 95B to occur in a large region of the back space 95B.

The absolute value of the difference between the first left margin M1 and the first lower margin M4 may be ⅛ or less of the first reference wavelength. With the margin being such a value, the period required for sound to propagate from the first region 15a of the first radiation surface 15A to the left end portion 81 of the structure 80 and the period required for sound to propagate from the third region 15c of the first radiation surface 15A to the lower end portion 84 of the structure 80 can be substantially equal to each other. Consequently, the time at which the sound derived from the first region 15a starts to travel from the left end portion 81 to the back space 95B and the time at which the sound derived from the third region 15c starts to travel from the lower end portion 84 to the back space 95B can be substantially coincident with each other. This can contribute to causing attenuation of sound that has traveled around to the back space 95B to occur in a large region of the back space 95B.

The absolute value of the difference between the first right margin M2 and the first lower margin M4 may be ⅛ or less of the first reference wavelength. With the margin being such a value, the period required for sound to propagate from the second region 15b of the first radiation surface 15A to the right end portion 82 of the structure 80 and the period required for sound to propagate from the third region 15c of the first radiation surface 15A to the lower end portion 84 of the structure 80 can be substantially equal to each other. Consequently, the time at which the sound derived from the second region 15b starts to travel from the right end portion 82 to the back space 95B and the time at which the sound derived from the third region 15c starts to travel from the lower end portion 84 to the back space 95B can be substantially coincident with each other. This can contribute to causing attenuation of sound that has traveled around to the back space 95B to occur in a large region of the back space 95B.

The absolute value of the difference between the first left margin M1 and the first upper margin M3 may be 1/16 or less of the first reference wavelength. The absolute value of the difference between the first right margin M2 and the first upper margin M3 may be 1/16 or less of the first reference wavelength. The absolute value of the difference between the first left margin M1 and the first lower margin M4 may be 1/16 or less of the first reference wavelength. The absolute value of the difference between the first right margin M2 and the first lower margin M4 may be 1/16 or less of the first reference wavelength.

In a numerical example, the absolute value of the difference between the first left margin M1 and the first upper margin M3 is 86 cm or less. The absolute value of the difference between the first right margin M2 and the first upper margin M3 is 86 cm or less. The absolute value of the difference between the first left margin M1 and the first lower margin M4 is 86 cm or less. The absolute value of the difference between the first right margin M2 and the first lower margin M4 is 86 cm or less.

The absolute value of the difference between the first left margin M1 and the first upper margin M3 may be 43 cm or less. The absolute value of the difference between the first right margin M2 and the first upper margin M3 may be 43 cm or less. The absolute value of the difference between the first left margin M1 and the first lower margin M4 may be 43 cm or less. The absolute value of the difference between the first right margin M2 and the first lower margin M4 may be 43 cm or less.

The absolute value of the difference between the geometric mean of the first left margin M1 and the first right margin M2, and the first upper margin M3, namely, |M3−(M1+M2)/2|, may be ⅛ or less of the first reference wavelength. In an example where spaces are present on the left, right, and upper sides of the structure 80, the above magnitude relation can contribute to causing attenuation of sound that has traveled around to the back space 95B to occur in a large region of the back space 95B. The absolute value of the difference above may be 1/16 or less of the first reference wavelength. The absolute value of the difference above may be 86 cm or less and may be 43 cm or less.

The absolute value of the difference between the geometric mean of the first left margin M1 and the first right margin M2 and the geometric mean of the first upper margin M3 and the first lower margin M4, namely, |(M3+M4)/2−(M1+M2)/2|, may be ⅛ or less of the first reference wavelength. In an example where spaces are present on the left, right, and upper, and lower sides of the structure 80, the above magnitude relation can contribute to causing attenuation of sound that has traveled around to the back space 95B to occur in a large region of the back space 95B. The absolute value of the difference above may be 1/16 or less of the first reference wavelength. The absolute value of the difference above may be 86 cm or less and may be 43 cm or less.

The absolute value of the difference between the second left margin M5 and the second upper margin M7 may be ⅛ or less of the second reference wavelength. With the margin being such a value, the period required for sound to propagate from fourth region 15d of the second radiation surface 15B to the left end portion 81 of the structure 80 and the period required for sound to propagate from the sixth region 15f of the second radiation surface 15B to the upper end portion 83 of the structure 80 can be substantially equal to each other. Consequently, the time at which the sound derived from the fourth region 15d starts to travel from the left end portion 81 to the front space 95A and the time at which the sound derived from the sixth region 15f starts to travel from the upper end portion 83 to the front space 95A can be substantially coincident with each other. This can contribute to causing attenuation of sound that has traveled around to the front space 95A to occur in a large region of the front space 95A.

The absolute value of the difference between the second right margin M6 and the second upper margin M7 may be ⅛ or less of the second reference wavelength. With the margin being such a value, the period required for sound to propagate from the fifth region 15e of the second radiation surface 15B to the right end portion 82 of the structure 80 and the period required for sound to propagate from the sixth region 15f of the second radiation surface 15B to the upper end portion 83 of the structure 80 can be substantially equal to each other. Consequently, the time at which the sound derived from the fifth region 15e starts to travel from the right end portion 82 to the front space 95A and the time at which the sound derived from the sixth region 15f starts to travel from the upper end portion 83 to the front space 95A can be substantially coincident with each other. This can contribute to causing attenuation of sound that has traveled around to the front space 95A to occur in a large region of the front space 95A.

The absolute value of the difference between the second left margin M5 and the second lower margin M8 may be ⅛ or less of the second reference wavelength. With the margin being such a value, the period required for sound to propagate from the fourth region 15d of the second radiation surface 15B to the left end portion 81 of the structure 80 and the period required for sound to propagate from the sixth region 15f of the second radiation surface 15B to the lower end portion 84 of the structure 80 can be substantially equal to each other. Consequently, the time at which the sound derived from the fourth region 15d starts to travel from the left end portion 81 to the front space 95A and the time at which the sound derived from the sixth region 15f starts to travel from the lower end portion 84 to the front space 95A can be substantially coincident with each other. This can contribute to causing attenuation of sound that has traveled around to the front space 95A to occur in a large region of the front space 95A.

The absolute value of the difference between the second right margin M6 and the second lower margin M8 may be ⅛ or less of the second reference wavelength. With the margin being such a value, the period required for sound to propagate from the fifth region 15e of the second radiation surface 15B to the right end portion 82 of the structure 80 and the period required for sound to propagate from the sixth region 15f of the second radiation surface 15B to the lower end portion 84 of the structure 80 can be substantially equal to each other. Consequently, the time at which the sound derived from the fifth region 15e starts to travel from the right end portion 82 to the front space 95A and the time at which the sound derived from the sixth region 15f starts to travel from the lower end portion 84 to the front space 95A can be substantially coincident with each other. This can contribute to causing attenuation of sound that has traveled around to the front space 95A to occur in a large region of the front space 95A.

The absolute value of the difference between the second left margin M5 and the second upper margin M7 may be 1/16 or less of the second reference wavelength. The absolute value of the difference between the second right margin M6 and the second upper margin M7 may be 1/16 or less of the second reference wavelength. The absolute value of the difference between the second left margin M5 and the second lower margin M8 may be 1/16 or less of the second reference wavelength. The absolute value of the difference between the second right margin M6 and the second lower margin M8 may be 1/16 or less of the second reference wavelength.

In a numerical example, the absolute value of the difference between the second left margin M5 and the second upper margin M7 is 86 cm or less. The absolute value of the difference between the second right margin M6 and the second upper margin M7 is 86 cm or less. The absolute value of the difference between the second left margin M5 and the second lower margin M8 is 86 cm or less. The absolute value of the difference between the second right margin M6 and the second lower margin M8 is 86 cm or less.

The absolute value of the difference between the second left margin M5 and the second upper margin M7 may be 43 cm or less. The absolute value of the difference between the second right margin M6 and the second upper margin M7 may be 43 cm or less. The absolute value of the difference between the second left margin M5 and the second lower margin M8 may be 43 cm or less. The absolute value of the difference between the second right margin M6 and the second lower margin M8 may be 43 cm or less.

The absolute value of the difference between the geometric mean of the second left margin M5 and the second right margin M6, and the second upper margin M7, namely, |M7−(M5+M6)/2|, may be ⅛ or less of the second reference wavelength. In an example where spaces are present on the left, right, and upper sides of the structure 80, the above magnitude relation can contribute to causing attenuation of sound that has traveled around to the front space 95A to occur in a large region of the front space 95A. The absolute value of the difference above may be 1/16 or less of the second reference wavelength. The absolute value of the difference above may be 86 cm or less and may be 43 cm or less.

The absolute value of the difference between the geometric mean of the second left margin M5 and the second right margin M6 and the geometric mean of the second upper margin M7 and the second lower margin M8, namely, |(M7+M8)/2−(M5+M6)/2|, may be ⅛ or less of the second reference wavelength. In an example where spaces are present on the left, right, and upper, and lower sides of the structure 80, the above magnitude relation can contribute to causing attenuation of sound that has traveled around to the front space 95A to occur in a large region of the front space 95A. The absolute value of the difference above may be 1/16 or less of the second reference wavelength. The absolute value of the difference above may be 86 cm or less and may be 43 cm or less.

The first upper margin M3 may be larger than the first left margin M1, may be smaller than the first left margin M1, or may be equal to the first left margin M1. The first upper margin M3 may be larger than the first right margin M2, may be smaller than the first right margin M2, or may be equal to the first right margin M2.

The first lower margin M4 may be larger than the first left margin M1, may be smaller than the first left margin M1, or may be equal to the first left margin M1. The first lower margin M4 may be larger than the first right margin M2, may be smaller than the first right margin M2, or may be equal to the first right margin M2.

The second upper margin M7 may be larger than the second left margin M5, may be smaller than the second left margin M5, or may be equal to the second left margin M5. The second upper margin M7 may be larger than the second right margin M6, may be smaller than the second right margin M6, or may be equal to the second right margin M6.

The second lower margin M8 may be larger than the second left margin M5, may be smaller than the second left margin M5, or may be equal to the second left margin M5. The second lower margin M8 may be larger than the second right margin M6, may be smaller than the second right margin M6, or may be equal to the second right margin M6.

In the following description, the terms first aspect ratio and second aspect ratio are used. The first aspect ratio refers to the ratio L2/L1 of the dimension L2 of the first radiation surface 15A in the long direction to the dimension L1 of the first radiation surface 15A in the short direction. The second aspect ratio refers to the ratio L4/L3 of the dimension L4 of the second radiation surface 15B in the long direction to the dimension L3 of the second radiation surface 15B in the short direction.

The first aspect ratio L2/L1 is 1.2 or more. This configuration can contribute to attenuating sound that has traveled around from the first piezoelectric speaker 10A to the opposite side of the structure 80. Specifically, this configuration facilitates a sufficient area of the third region 15c to be allocated. This is advantageous in terms of cancellation of sound that has traveled around from the first region 15a and the second region 15b to the opposite side of the structure 80 performed by using sound that has traveled around from the third region 15c to the opposite side of the structure 80.

The first aspect ratio L2/L1 may be 1.2 or more and 6 or less. The first aspect ratio L2/L1 may be, specifically, 1.5 or more and 4 or less.

The second aspect ratio L4/L3 is 1.2 or more. This configuration can contribute to attenuating sound that has traveled around from the second piezoelectric speaker 10B to the opposite side of the structure 80. Specifically, this configuration facilitates a sufficient area of the sixth region 15f to be allocated. This is advantageous in terms of cancellation of sound that has traveled around from the fourth region 15d and the fifth region 15e to the opposite side of the structure 80 performed by using sound that has traveled around from the sixth region 15f to the opposite side of the structure 80.

The second aspect ratio L4/L3 may be 1.2 or more and 6 or less. The second aspect ratio L4/L3 may be specifically 1.5 or more and 4 or less.

The ANC system includes the first reference microphone 130A, the second reference microphone 130B, and the controller 120. The first reference microphone 130A is disposed in the back space 95B. The second reference microphone 130B is disposed in the front space 95A.

The controller 120 controls, for sound reduction in the front space 95A, sound to be output from the first piezoelectric speaker 10A with use of the first reference microphone 130A. The controller 120 controls, for sound reduction in the back space 95B, sound to be output from the second piezoelectric speaker 10B with use of the second reference microphone 130B.

In the following description, terms first distance Dm1 and second distance Dm2 are used. The first distance Dm1 refers to the distance between the front surface 80a of the structure 80 and the first reference microphone 130A. In the illustrated example, the first distance Dm1 is specifically a distance in the thickness direction of the plate 80p of the structure 80. The second distance Dm2 refers to the distance between the back surface 80b of the structure 80 and the second reference microphone 130B. In the illustrated example, the second distance Dm2 is specifically a distance in the thickness direction of the plate 80p of the structure 80.

In a numerical example, the first distance Dm1 is 105 cm or less. According to this numerical example, in the case where sound to be output from the first piezoelectric speaker 10A has a frequency of 200 Hz or more and 800 Hz or less, the sound output from the first piezoelectric speaker 10A is less prone to be input to the first reference microphone 130A as noise in the control. This is supported by, for example, Example 1.

The first distance Dm1 is more than 0 cm. The first distance Dm1 may be 40 cm or more. The first distance Dm1 may be more than 60 cm.

In a numerical example, the second distance Dm2 is 105 cm or less. According to this numerical example, in the case where sound to be output from the second piezoelectric speaker 10B has a frequency of 200 Hz or more and 800 Hz or less, the sound output from the second piezoelectric speaker 10B is less prone to be input to the second reference microphone 130B as noise in the control. This is supported by, for example, Example 1.

The second distance Dm2 is more than 0 cm. The second distance Dm2 may be 40 cm or more. The second distance Dm2 may be more than 60 cm.

The first distance Dm1 and the second distance Dm2 may be equal to each other or may be different from each other.

The controller 120 controls, for sound reduction in the front space 95A, sound to be output from the first piezoelectric speaker 10A without use of an error microphone positioned in the front space 95A and with use of the first reference microphone 130A. Specifically, in this control, the controller 120 does not use an error microphone. According to this configuration, it is possible to perform the control simply. Specifically, as understood from the description with reference to FIG. 18 to FIG. 20, the ANC system according to the present invention is suitable for attenuating sound that has traveled around from the first piezoelectric speaker 10A to the opposite side of the structure 80. This facilitates a sound reducing effect to be exerted even without use of an error microphone. In this context, an error microphone refers to a microphone that is positioned at a point targeted for sound reduction and is provided to control performed by the ANC system for reducing noise at the point.

The phrase “without use of an error microphone positioned in the front space 95A” encompasses an embodiment in which an error microphone is not disposed in the front space 95A as shown in the figures. This phrase also encompasses an embodiment in which although an error microphone is disposed in the front space 95A, the error microphone is not used.

Specifically, the first reference microphone 130A is the only microphone that the controller 120 uses to control sound to be output from the first piezoelectric speaker 10A.

The controller 120 controls, for sound reduction in the back space 95B, sound to be output from the second piezoelectric speaker 10B without use of an error microphone positioned in the back space 95B and with use of the second reference microphone 130B. Specifically, in this control, the controller 120 does not use an error microphone. According to this configuration, it is possible to perform the control simply. Specifically, as understood from the description with reference to FIG. 18 to FIG. 20, the ANC system according to the present invention is suitable for attenuating sound that has traveled around from the second piezoelectric speaker 10B to the opposite side of the structure 80. This facilitates a sound reducing effect to be exerted even without use of an error microphone.

The phrase “without use of an error microphone positioned in the back space 95B” encompasses an embodiment in which an error microphone is not disposed in the back space 95B as shown in the figures. This phrase also encompasses an embodiment in which although an error microphone is disposed in the back space 95B, the error microphone is not used.

Specifically, the second reference microphone 130B is the only microphone that the controller 120 uses to control sound to be output from the second piezoelectric speaker 10B.

Sound output from the first piezoelectric speaker 10A and input to the first reference microphone 130A is defined as the first travel-around sound. Here, the controller 120 does not perform (that is, refrains from) feedback compensation that is for reducing an influence of the first travel-around sound on sound to be output from the first piezoelectric speaker 10A. According to this configuration, it is possible to perform the control simply. Specifically, as understood from the description with reference to FIG. 18 to FIG. 20, the ANC system according to the present invention is suitable for attenuating sound that has traveled around from the first piezoelectric speaker 10A to the opposite side of the structure 80. This facilitates a sound reducing effect to be exerted even without feedback compensation.

Sound output from the second piezoelectric speaker 10B and input to the second reference microphone 130B is defined as a second travel-around sound. Here, the controller 120 does not perform feedback compensation that is for reducing an influence of the second travel-around sound on sound to be output from the second piezoelectric speaker 10B. According to this configuration, it is possible to perform the control simply. Specifically, as understood from the description with reference to FIG. 18 to FIG. 20, the ANC system according to the present invention is suitable for attenuating sound that has traveled around from the second piezoelectric speaker 10B to the opposite side of the structure 80. This facilitates a sound reducing effect to be exerted even without feedback compensation.

The controller 120 has the first noise control filter 121A. The first noise control filter 121A is configured so that sound input to the first reference microphone 130A and sound output from the first piezoelectric speaker 10A will be in one-to-one correspondence. The first noise control filter 121A is also configured so that the above correspondence will be fixed over time. According to this configuration, it is possible to perform the control simply. Specifically, as understood from the description with reference to FIG. 18 to FIG. 20, the ANC system according to the present invention is suitable for attenuating sound that has traveled around from the first piezoelectric speaker 10A to the opposite side of the structure 80. Consequently, the sound reducing effect can be easily exerted even with the first noise control filter 121A having such a simple configuration. The fixing of the correspondence over time described above can be achieved, for example, by not updating but fixing the filter coefficients of the first noise control filter 121A. By fixing the filter coefficients, it is possible for the first noise control filter 121A to perform a fixed operation, thereby achieving sound reduction using the first piezoelectric speaker 10A through the fixed operation.

The controller 120 has the second noise control filter 121B. The second noise control filter 121B is configured so that sound input to the second reference microphone 130B and sound output from the second piezoelectric speaker 10B will be in one-to-one correspondence. The second noise control filter 121B is also configured so that the above correspondence will be fixed over time. According to this configuration, it is possible to perform control simply. Specifically, as understood from the description with reference to FIG. 18 to FIG. 20, the ANC system according to the present invention is suitable for attenuating sound that has traveled around from the second piezoelectric speaker 10B to the opposite side of the structure 80. Consequently, the sound reducing effect can be easily exerted even with the second noise control filter 121B having such a simple configuration. The fixing of the correspondence over time described above can be achieved, for example, by not updating but fixing the filter coefficients of the second noise control filter 121B. By fixing the filter coefficients, it is possible for the second noise control filter 121B to perform a fixed operation, thereby achieving sound reduction using the second piezoelectric speaker 10B through the fixed operation.

According to the present invention, as described above, it is possible to simplify the control. This can require a reduced amount of operations. For example, the ANC system can be configured by employing a small number of finite impulse response (FIR) filters. Typical FIR filters require a large amount of operations. Reducing the number of FIR filters can reduce the computational load on the controller, thereby increasing the control speed. This can lead to further practical use of the ANC system. The ANC system may be configured without a FIR filter.

According to the present invention, as described above, the ANC system can be configured by employing a small number of microphones. This enables the hardware configuration for the ANC system to be compact.

According to the present invention, as described above, it is possible to attenuate sound that has traveled around from the piezoelectric speaker to the opposite side of the structure 80. Consequently, it is also possible to configure the ANC system without a back cavity. This enables the hardware configuration for the ANC system to be compact. A back cavity is a box-like cover for avoiding sound from traveling around to the rear of the speaker.

However, the ANC system may perform feedback compensation. Designers of the ANC system can select whether to include feedback compensation in the ANC system. Further, in the ANC system, the controller may have a control mode of performing feedback compensation and a control mode of not performing feedback compensation. In this case, the controller can switch between these two modes. These descriptions can be applied to both single ANC systems and dual ANC systems.

The ANC system may also have an FIR filter. The ANC system may have an error microphone. The ANC system may have a back cavity.

Various modifications can be applied to the ANC system according to the above description. For example, the number of the piezoelectric speakers 10 to be attached to the front surface 80a of the structure 80 may be one or more than one. Similarly, the number of the piezoelectric speakers 10 to be attached to the back surface 80b of the structure 80 may be one or more than one.

### (Supplementary Description)

The present disclosure provides the following techniques.

### (Technique 1)

An active noise control system including:
a structure having a front surface and a back surface;
a first piezoelectric speaker disposed on the front surface and configured to radiate a sound wave for sound reduction; and
a second piezoelectric speaker disposed on the back surface and configured to radiate a sound wave for sound reduction.

### (Technique 2)

An active noise control system including:
a structure having a front surface and a back surface;
a first piezoelectric speaker disposed on the front surface and configured to radiate a sound wave for sound reduction;
a first reference microphone; and
a controller, wherein
a front space overlapping the front surface in plan view of the front surface, the front surface, the back surface, and a back space overlapping the back surface in plan view of the back surface are arranged in this order,
the first reference microphone is disposed in the back space, and
the controller controls, for sound reduction in the front space, sound to be output from the first piezoelectric speaker without use of an error microphone positioned in the front space and with use of the first reference microphone.

### (Technique 3)

The active noise control system according to Technique 2, wherein
the first reference microphone is an only microphone that the controller uses to control sound to be output from the first piezoelectric speaker.

### (Technique 4)

An active noise control system including:
a structure having a front surface and a back surface;
a first piezoelectric speaker disposed on the front surface and configured to radiate a sound wave for sound reduction;
a first reference microphone; and
a controller, wherein
a front space overlapping the front surface in plan view of the front surface, the front surface, the back surface, and a back space overlapping the back surface in plan view of the back surface are arranged in this order,
the first reference microphone is disposed in the back space, and
the controller controls, for sound reduction in the front space, sound to be output from the first piezoelectric speaker with use of the first reference microphone, and
when sound output from the first piezoelectric speaker and input to the first reference microphone is defined as a first travel-around sound,
the controller does not perform feedback compensation that is for reducing an influence of the first travel-around sound on sound to be output from the first piezoelectric speaker.

### (Technique 5)

The active noise control system according to any one of Techniques 1 to 4, wherein
a front space overlapping the front surface in plan view of the front surface, the front surface, the back surface, and a back space overlapping the back surface in plan view of the back surface are arranged in this order,
the first piezoelectric speaker has a first radiation surface facing the front space,
the active noise control system includes:
   a first reference microphone disposed in the back space; and
   a controller,
the controller has a first noise control filter, and
the first noise control filter is configured so that:
   sound input to the first reference microphone and sound output from the first piezoelectric speaker are in one-to-one correspondence; and
   the correspondence is fixed over time.

### (Technique 6)

The active noise control system according to any one of Techniques 1 to 5, wherein
a front space overlapping the front surface in plan view of the front surface, the front surface, the back surface, and a back space overlapping the back surface in plan view of the back surface are arranged in this order,
the first piezoelectric speaker has a first radiation surface facing the front space,
the back space has a first rear space, a second rear space, and a third rear space between the first rear space and the second rear space, and
a period appears during which:
   a phase of a sound wave in the first rear space formed by the first piezoelectric speaker is one of positive and negative;
   a phase of a sound wave in the second rear space formed by the first piezoelectric speaker is the one of positive and negative; and
   a phase of a sound wave in the third rear space formed by the first piezoelectric speaker is the other of positive and negative.

### (Technique 7)

The active noise control system according to Technique 6, wherein
the first radiation surface has a first region, a second region, and a third region between the first region and the second region,
the structure has a left end portion, a right end portion, and an upper end portion,
the first region, the second region, the third region, the first rear space, the second rear space, and the third rear space intersect a first reference plane perpendicular to an up-down direction, and
a period appears during which:
   over a first travel-around path from the first region to the first rear space via the left end portion, a phase of a sound wave formed by the first piezoelectric speaker is maintained at the one of positive and negative;
   over a second travel-around path from the second region to the second rear space via the right end portion, a phase of a sound wave formed by the first piezoelectric speaker is maintained at the one of positive and negative; and
   over a third travel-around path from the third region to the third rear space via the upper end portion, a phase of a sound wave formed by the first piezoelectric speaker is maintained at the other of positive and negative.

### (Technique 8)

The active noise control system according to any one of Techniques 1 to 7, wherein
the first piezoelectric speaker has a first radiation surface,
the active noise control system includes a controller,
the controller has a control mode of controlling a frequency of sound to be output from the first piezoelectric speaker to a value within a first specified frequency range, and
when a wavelength of sound having an upper limit for the first specified frequency range is defined as a first reference wavelength, a margin between a left end portion of the first radiation surface and a left end portion of the structure is defined as a first left margin, a margin between a right end portion of the first radiation surface and a right end portion of the structure is defined as a first right margin, and a margin between an upper end portion of the first radiation surface and an upper end portion of the structure is defined as a first upper margin,
at least one of an absolute value of a difference between the first left margin and the first upper margin and an absolute value of a difference between the first right margin and the first upper margin is ⅛ or less of the first reference wavelength.

### (Technique 9)

The active noise control system according to any one of Techniques 1 to 8, wherein
the first piezoelectric speaker has a first radiation surface, and
when a margin between a left end portion of the first radiation surface and a left end portion of the structure is defined as a first left margin, a margin between a right end portion of the first radiation surface and a right end portion of the structure is defined as a first right margin, and a margin between an upper end portion of the first radiation surface and an upper end portion of the structure is defined as a first upper margin,
at least one of an absolute value of a difference between the first left margin and the first upper margin and an absolute value of a difference between the first right margin and the first upper margin is 86 cm or less.

### (Technique 10)

The active noise control system according to any one of Techniques 1 to 9, wherein
the first piezoelectric speaker has a first radiation surface, and
when a ratio of a dimension of the first radiation surface in a long direction to a dimension of the first radiation surface in a short direction is defined as a first aspect ratio,
the first aspect ratio is 1.2 or more.

### (Technique 11)

The active noise control system according to any one of Techniques 1 to 10, wherein
a front space overlapping the front surface in plan view of the front surface, the front surface, the back surface, and a back space overlapping the back surface in plan view of the back surface are arranged in this order,
the active noise control system includes:
   a first reference microphone disposed in the back space; and
   a controller,
the controller controls, for sound reduction in the front space, sound to be output from the first piezoelectric speaker with use of the first reference microphone, and
when a distance between the front surface and the first reference microphone is defined as a first distance,
the first distance is 105 cm or less.

1. An active noise control system comprising:
a structure having a front surface and a back surface;
a first piezoelectric speaker disposed on the front surface and configured to radiate a sound wave for sound reduction; and
a second piezoelectric speaker disposed on the back surface and configured to radiate a sound wave for sound reduction.

2. An active noise control system comprising:
a structure having a front surface and a back surface;
a first piezoelectric speaker disposed on the front surface and configured to radiate a sound wave for sound reduction;
a first reference microphone; and
a controller, wherein
a front space overlapping the front surface in plan view of the front surface, the front surface, the back surface, and a back space overlapping the back surface in plan view of the back surface are arranged in this order,
the first reference microphone is disposed in the back space, and
the controller controls, for sound reduction in the front space, sound to be output from the first piezoelectric speaker without use of an error microphone positioned in the front space and with use of the first reference microphone.

3. The active noise control system according to claim 2, wherein
the first reference microphone is an only microphone that the controller uses to control sound to be output from the first piezoelectric speaker.

4. An active noise control system comprising:
a structure having a front surface and a back surface;
a first piezoelectric speaker disposed on the front surface and configured to radiate a sound wave for sound reduction;
a first reference microphone; and
a controller, wherein
a front space overlapping the front surface in plan view of the front surface, the front surface, the back surface, and a back space overlapping the back surface in plan view of the back surface are arranged in this order,
the first reference microphone is disposed in the back space, and
the controller controls, for sound reduction in the front space, sound to be output from the first piezoelectric speaker with use of the first reference microphone, and
when sound output from the first piezoelectric speaker and input to the first reference microphone is defined as a first travel-around sound,
the controller does not perform feedback compensation that is for reducing an influence of the first travel-around sound on sound to be output from the first piezoelectric speaker.

5. The active noise control system according to claim 1, wherein
a front space overlapping the front surface in plan view of the front surface, the front surface, the back surface, and a back space overlapping the back surface in plan view of the back surface are arranged in this order,
the first piezoelectric speaker has a first radiation surface facing the front space,
the active noise control system comprises:
a first reference microphone disposed in the back space; and
a controller,
the controller has a first noise control filter, and
the first noise control filter is configured so that:
sound input to the first reference microphone and sound output from the first piezoelectric speaker are in one-to-one correspondence; and
the correspondence is fixed over time.

6. The active noise control system according to claim 1, wherein
a front space overlapping the front surface in plan view of the front surface, the front surface, the back surface, and a back space overlapping the back surface in plan view of the back surface are arranged in this order,
the first piezoelectric speaker has a first radiation surface facing the front space,
the back space has a first rear space, a second rear space, and a third rear space between the first rear space and the second rear space, and
a period appears during which:
a phase of a sound wave in the first rear space formed by the first piezoelectric speaker is one of positive and negative;
a phase of a sound wave in the second rear space formed by the first piezoelectric speaker is the one of positive and negative; and
a phase of a sound wave in the third rear space formed by the first piezoelectric speaker is the other of positive and negative.

7. The active noise control system according to claim 6, wherein
the first radiation surface has a first region, a second region, and a third region between the first region and the second region,
the structure has a left end portion, a right end portion, and an upper end portion,
the first region, the second region, the third region, the first rear space, the second rear space, and the third rear space intersect a first reference plane perpendicular to an up-down direction, and
a period appears during which:
over a first travel-around path from the first region to the first rear space via the left end portion, a phase of a sound wave formed by the first piezoelectric speaker is maintained at the one of positive and negative;
over a second travel-around path from the second region to the second rear space via the right end portion, a phase of a sound wave formed by the first piezoelectric speaker is maintained at the one of positive and negative; and
over a third travel-around path from the third region to the third rear space via the upper end portion, a phase of a sound wave formed by the first piezoelectric speaker is maintained at the other of positive and negative.

8. The active noise control system according to claim 1, wherein
the first piezoelectric speaker has a first radiation surface,
the active noise control system comprises a controller,
the controller has a control mode of controlling a frequency of sound to be output from the first piezoelectric speaker to a value within a first specified frequency range, and
when a wavelength of sound having an upper limit for the first specified frequency range is defined as a first reference wavelength, a margin between a left end portion of the first radiation surface and a left end portion of the structure is defined as a first left margin, a margin between a right end portion of the first radiation surface and a right end portion of the structure is defined as a first right margin, and a margin between an upper end portion of the first radiation surface and an upper end portion of the structure is defined as a first upper margin,
at least one of an absolute value of a difference between the first left margin and the first upper margin and an absolute value of a difference between the first right margin and the first upper margin is ⅛ or less of the first reference wavelength.

9. The active noise control system according to claim 1, wherein
the first piezoelectric speaker has a first radiation surface, and
when a margin between a left end portion of the first radiation surface and a left end portion of the structure is defined as a first left margin, a margin between a right end portion of the first radiation surface and a right end portion of the structure is defined as a first right margin, and a margin between an upper end portion of the first radiation surface and an upper end portion of the structure is defined as a first upper margin,
at least one of an absolute value of a difference between the first left margin and the first upper margin and an absolute value of a difference between the first right margin and the first upper margin is 86 cm or less.

10. The active noise control system according to claim 1, wherein
the first piezoelectric speaker has a first radiation surface, and
when a ratio of a dimension of the first radiation surface in a long direction to a dimension of the first radiation surface in a short direction is defined as a first aspect ratio,
the first aspect ratio is 1.2 or more.

11. The active noise control system according to claim 1, wherein
a front space overlapping the front surface in plan view of the front surface, the front surface, the back surface, and a back space overlapping the back surface in plan view of the back surface are arranged in this order,
the active noise control system comprises:
a first reference microphone disposed in the back space; and
a controller,
the controller controls, for sound reduction in the front space, sound to be output from the first piezoelectric speaker with use of the first reference microphone, and
when a distance between the front surface and the first reference microphone is defined as a first distance,
the first distance is 105 cm or less.
